(19) United States
(12) Patent Application Publication
(10) Pub. No.: US 2023/0330585 A1
(43) Pub. Date: Oct. 19, 2023

(54) HIGH EFFICIENCY FILTER MEDIA

(71) Applicant: Hollingsworth & Vose Company, East Walpole, MA (US)

(72) Inventors: Amsarani Ramamoorthy, Blacksburg, VA (US); Siqiang Zhu, Christiansburg, VA (US); Shania Evangelista, Floyd, VA (US); Bryan Douglas Dickerson, Christiansburg, VA (US); Kevin Clark, Nashua, NH (US); Praveen Kumar Yegya Raman, Ayer, MA (US); Keith Higginson, Holden, MA (US)

(73) Assignee: Hollingsworth & Vose Company, East Walpole, MA (US)

(21) Appl. No.: 17/720,908

(22) Filed: Apr. 14, 2022

(51) Int. Cl. B01D 46/62; B01D 39/16; B01D 46/00; B01D 46/12

(52) U.S. Cl. CPC B01D 46/62; B01D 39/1623; B01D 46/0027; B01D 46/12; B01D 2279/51; B01D 2275/10; B01D 2239/025; B01D 2239/0414; B01D 2239/0464; B01D 2239/0492; B01D 2239/0622; B01D 2239/0631; B01D 2239/0618; B01D 2239/1233; B01D 2275/30

(57) ABSTRACT

Articles and methods involving filter media are generally provided. In certain embodiments, a filter media has a design and/or comprises one or more layers that enhances its efficiency and/or performance.

### TECHNICAL FIELD

High efficiency filter media are generally described.

### BACKGROUND

Filter media are articles that can be used to remove contamination in a variety of applications. Depending on the application, the filter media may be designed to have different performance characteristics. For example, filter media may be designed to have performance characteristics suitable for HEPA and/or ULPA applications. Although many types of filter media for filtering particulates from air exist, improvements in the physical and/or performance characteristics of the filter media (e.g., efficiency, thermal PAO loading capacity, mechanical HEPA efficiency) would be beneficial.

### SUMMARY

Filter media, related components, and related methods are generally described.

In some aspects, a filter media is provided. The filter media comprises a first layer comprising a plurality of fine fibers having an average diameter of less than 1 micron and a second layer disposed on the first layer. The first layer has a porosity of greater than 80%. The second layer has a normalized surface area of greater than 15 m²/m². The second layer has an efficiency metric of greater than 2.5.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic depiction of a cross-section of a filter media, according to one set of embodiments;

FIG. 2 is a schematic depiction of a cross-section of a filter media comprising two layers, according to one set of embodiments;

FIG. 3A is a schematic depiction of a cross-section of a fine fiber layer comprising an impact modifier, according to one set of embodiments;

FIG. 3B is a schematic depiction of a cross-section of a fine fiber layer lacking an impact modifier, according to one set of embodiments;

FIG. 4 is a schematic depiction of a cross-section of a filter media comprising three layers, according to one set of embodiments;

FIG. 5 is a schematic depiction of a cross-section of a filter media comprising four layers, according to one set of embodiments;

FIG. 6 is a schematic depiction of a cross-section of a filter media comprising a spacer layer, according to one set of embodiments;

FIG. 7 is a schematic depiction of a cross-section of a filter media comprising a meltblown layer, according to one set of embodiments;

FIG. 8 is a plot of air resistance as a function of time, according to one set of embodiments;

FIGS. 9-11 are plots of air resistance as a function of cycle number, according to one set of embodiments;

FIGS. 12-13 are plots of air resistance at various stages of the DOP interval loading test, according to one set of embodiments; and

FIG. 14 is a plot of penetration of DOP aerosol as a function of DOP loading time, according to one set of embodiments.

### DETAILED DESCRIPTION

Articles and methods involving filter media are generally provided. In certain embodiments, a filter media has a design and/or comprises one or more layers that enhances its efficiency and/or performance.

In some embodiments, a filter media comprises a main filter layer that has one or more advantageous features. For instance, a filter media may comprise a main filter layer that comprises a plurality of nanofibers. The nanofibers may be particularly suitable for retaining small particles and/or retaining particles with high efficiency. As another example, in some embodiments, a filter media comprises a main filter layer that comprises fine fibers comprising an impact modifier. The impact modifier may enhance the impact resistance of the fibers in the main filter layer and/or of the main filter layer as a whole. It is also possible for the impact modifier to enhance the porosity of the main filter layer, increase the efficiency of the main filter layer, increase the oil loading capacity of the main filter layer, improve one or more mechanical properties of the main filter layer (e.g., elongation at break, tensile strength, toughness, puncture strength), and/or increase the main filter's durability during pleating. In certain cases, one or more of these advantages are achieved without sacrificing filtration properties.

In some embodiments, a filter media comprises a prefilter layer having one or more beneficial properties. As an example, a filter media may comprise a prefilter layer that has one or more features that enhances its ability to repel and/or trap particles. Such features may include having a relatively high normalized surface area, being charged (e.g., hydrocharged), being oleophobic, and/or comprising an oleophobic additive.

For example, in one set of embodiments, a filter media comprises a prefilter layer having a relatively high normalized surface area. The high normalized surface area may be associated with a high basis weight, a high fiber density, and/or the presence of fibers having relatively small diameters. A high normalized surface area, in some cases, may translate into an increased amount of fiber area available for filtering particulates and/or absorbing a fluid (e.g., an oil). A prefilter layer having a relatively high normalized surface area may, in some cases, impart the prefilter layer and/or the filter media with improved initial efficiency and/or improved oil loading.

As another example, in some embodiments, a filter media comprises a prefilter layer that is charged. A charged prefilter layer may exhibit one or more advantages over a non-charged prefilter layer, all other factors being equal. For example, a charged prefilter layer may exhibit improved oil loading properties and/or improved initial efficiency. In some cases, a filter media comprises a prefilter layer that is charged in bulk, such as by hydrocharging. A prefilter layer charged in bulk may have a relatively high total charge, charge density, and/or relatively uniform charge distribution. This may enhance the oil loading capability and/or initial efficiency of the prefilter layer.

As a third example, in some embodiments, a filter media comprises a prefilter layer that comprises an oleophobic additive. The presence of an oleophobic additive may result in a low pressure drop at a high oil loading, a high gamma at a high oil loading, and/or a low penetration at a high oil loading. Such properties may be beneficial in applications where the filter media is positioned in an environment with a moderate or high ambient oil level. For example, filter media used in clean rooms (e.g., pharmaceutical clean rooms, electronic clean rooms, clean rooms for integrated circuit manufacturing), in gas turbines (e.g., off shore gas turbines), in room air cleaners, in face masks, in vacuum cleaners, in paint spray booths, and/or to filter oily aerosols.

The filter media described herein may further comprise other layers in addition to main filter layers and prefilter layers. Such layers, too, may have one or more advantageous properties. As one example, in some embodiments, a filter media comprises an oleophobic spacer layer that enhances the oleophobicity of the filter media as a whole, thereby improving filtration efficiency. As another example, in some embodiments, a filter media comprises one or more layers that enhance the loading capacity and/or lifetime of the filter media. Such layers may include wetlaid layers and/or coarse meltblown layers. In some embodiments, such layers have the capacity to trap a relatively high number of particles. Such layers may also further serve as support layers and/or backer layers for one or more other layers present in the filter media (e.g., a main filter layer, a prefilter layer). Additionally or alternatively, such layers (e.g., coarse meltblown layers) may be oleophobic and/or may be charged via one of more methods described elsewhere herein.

In some embodiments, a filter media described herein has a particular combination and/or ordering of layers that results in desirable filter media properties. In some embodiments, a filter media described herein exhibits increased efficiency, increased oil loading capacity, and/or increased mechanical HEPA efficiency.

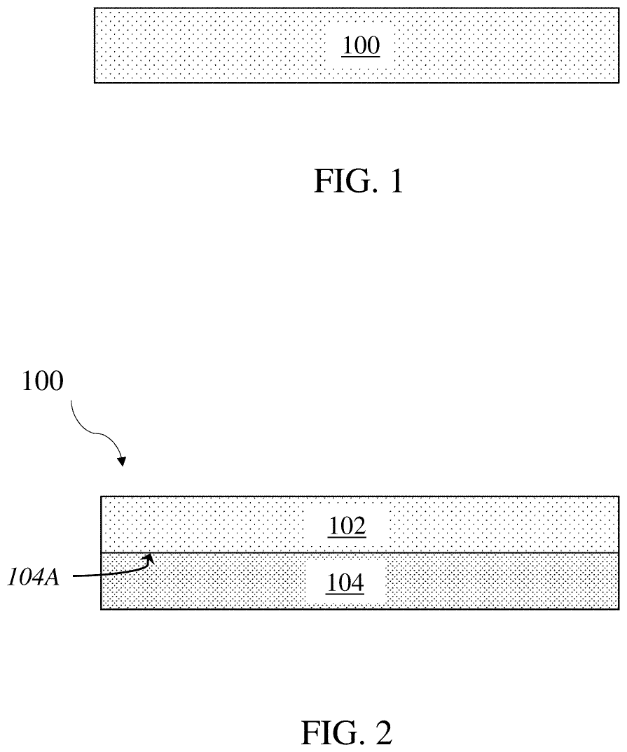

FIG. 1 shows one non-limiting embodiment of a filter media 100. In some embodiments, a filter media comprises two or more layers. For instance, a filter media may comprise a first layer and a second layer. FIG. 2A shows one non-limiting embodiment of a filter media (e.g., a filter media like the filter media 100 shown in FIG. 1) comprising a first layer and a second layer. For example, in FIG. 2, the filter media 100 comprises a first layer 102 and a second layer 104 positioned adjacent the first layer 102.

In some embodiments, and as described in more detail below, one of the layers in a filter media comprising two or more layers (e.g., a first layer) is a main filter layer. The main filter layer may, for example, have a higher efficiency than one or more other layer(s) of the media. In some embodiments, a main filter layer has a relatively small average fiber diameter and/or comprises fibers having relatively small average fiber diameters (e.g., fine fibers). For instance, in some embodiments, the main filter layer is a fine fiber layer.

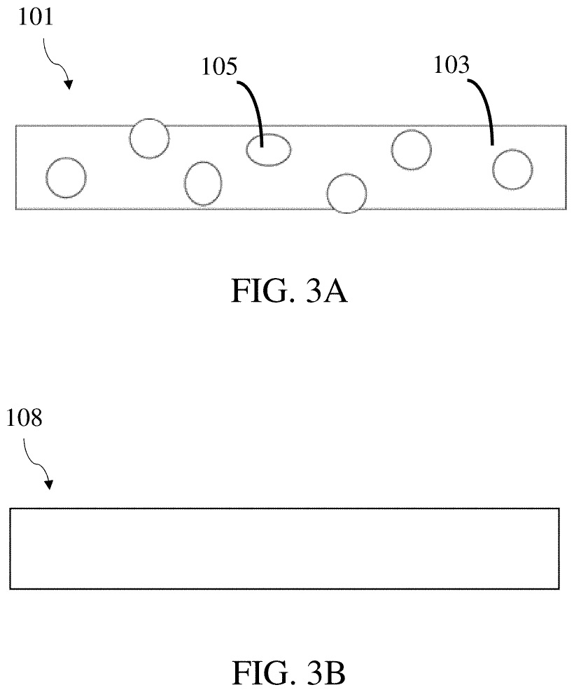

When a filter media comprises a main filter layer that is a fine fiber layer and/or comprises fine fibers, the fine fibers may comprise one or more components. Examples of suitable components include matrix polymers, impact modifiers, and salts. One example of a fine fiber is shown schematically in FIG. 3A. As shown in FIG. 3A, in some cases, a fine fiber 101 comprises a matrix polymer 103 and a plurality of impact modifier domains 105. The impact modifier domains present in fine fibers may have a morphology and/or distribution in fine fibers like that shown in FIG. 3A, or may differ from that shown in FIG. 3A. As an example, some fine fibers may comprise impact modifier microdomains that do not have a uniform shape or uniform distribution. It is also possible for a fine fiber to be formed from a continuous phase that does not include any impact modifiers microdomains dispersed in a matrix polymer. One example of such a fine fiber is shown in FIG. 3B.

In some embodiments, a filter media comprises a prefilter layer (e.g., a second layer that is a prefilter layer). The prefilter layer may, for example, serve to filter out larger particles from a fluid prior to exposure of the fine fiber layer to the fluid. This may prevent penetration and/or reduce the extent of penetration of a species to be filtered (e.g., oil) into the main filter layer. It is also possible for this filtration to protect (e.g., mechanically) the main filter layer, which may be desirable when the main filter layer is a relatively delicate fine fiber layer. Prefilters suitable for use in the filter media described herein may have a variety of suitable designs. In some embodiments, a filter media comprises a prefilter layer that is a meltblown layer. In some cases, the prefilter layer comprises an oleophobic additive (e.g., a fluorocarbon additive). In some embodiments, the prefilter layer is charged. In such embodiments, charge may be induced on the prefilter layer by a charging process (e.g., an electrostatic charging process, a triboelectric charging process, or a hydrocharging process).

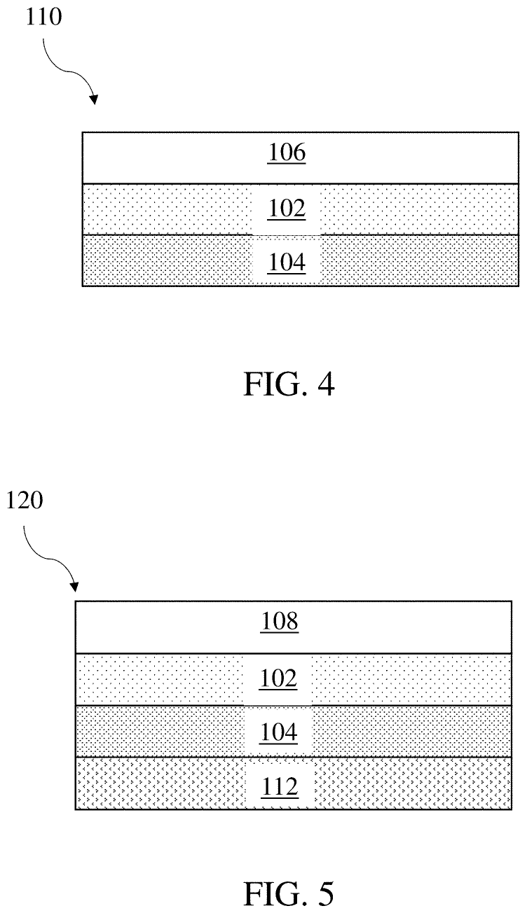

In some embodiments, a filter media may comprise one or more additional layers. It should be noted that the one or more additional layers may be disposed in any suitable location in the filter media (e.g., filter media 100 in FIG. 2). In some instances, the filter media may comprise two or more layers, three or more layers, four or more layers, or even more layers, e.g., as shown in FIGS. 4-7.

FIG. 4 shows one non-limiting embodiment of a filter media 110 comprising three layers. For example, in FIG. 4, the filter media 110 comprises a first layer 102, a second layer 104, and a third layer 106. The third layer 106 shown in FIG. 4 is positioned adjacent the first layer 102 at a side opposite the second layer 104. The first layer and the second layer in FIG. 4 may be the same as the first layer and the second layer in the filter media 100 shown in FIG. 2 or may be different. In some embodiments, and as described in more detail below, a filter media may comprise a third layer that is a backer or a support layer. In some embodiments, a filter media comprises a backer or support layer that is positioned on a side of the main filter layer opposite a prefilter layer. In some instances, the backer or support layer may be a wetlaid non-woven fiber web.

In some embodiments, a filter media comprises four layers. For example, as shown in FIG. 5, the filter media 120 comprises a first layer 102, a second layer 104, a third layer 108 positioned adjacent the first layer 102 at a side opposite the second layer 104, and a fourth layer 112 positioned adjacent the second layer 104 at a side opposite the first layer 102. The first layer and the second layer in the filter media 120 in FIG. 5 may be the same as the first layer and the second layer in the filter media 110 shown in FIG. 2 or may be different. In some embodiments, a filter media comprising four layers comprises backer or support layers that are the outermost layers (e.g., with respect to FIG. 5, a filter media may comprise third and fourth layers that are backer or support layers, a first layer that is a main filter layer, and a second layer that is a prefilter layer). In some embodiments in which a filter media comprises two or more support layers, each of (or at least one of) the two or more support layers is a wetlaid non-woven fiber web. In embodiments comprising two or more support layers, the two or more support layers may differ from each other in one or more ways (even if both support layers are wetlaid non-woven fiber webs). In some embodiments, a support layer positioned adjacent a prefilter layer may have a higher efficiency than a support layer positioned adjacent a main filter layer. Properties of various support layers are described in further detail below.

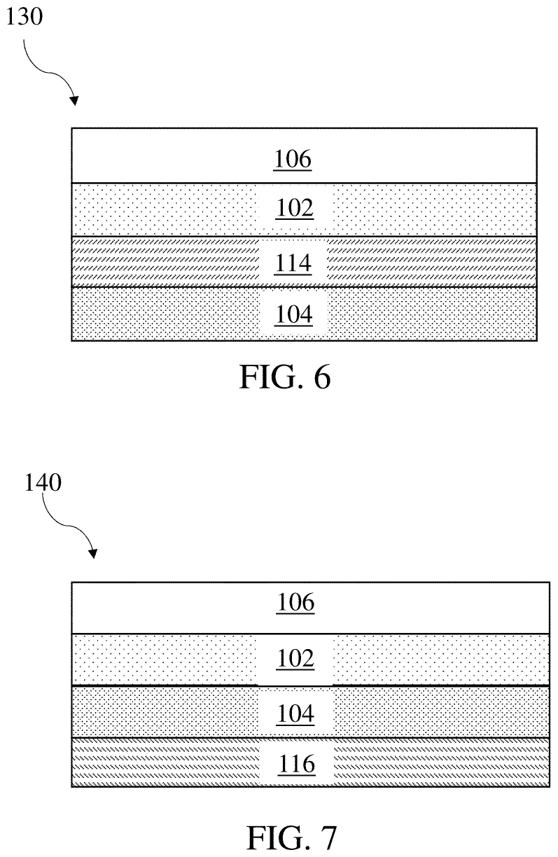

In some embodiments, a filter media may comprise one or more supplemental layers. FIG. 6 shows one non-limiting embodiment of a filter media 130 comprising a supplemental layer. As shown in FIG. 6, the filter media 130 may comprise a first layer 102, a second layer 104, a third layer 106, and a supplemental layer 114 positioned between the first layer 102 and the second layer 104. The first layer, the second layer, and the third layer in the filter media 130 in FIG. 6 may be the same as the first layer, the second layer, and the third layer in the filter media 110 shown in FIG. 4 or may differ in one or more ways. In some embodiments, a supplemental layer is positioned between a main filter layer and a prefilter layer and/or downstream from a prefilter layer.

It is also possible for a filter media to comprise a supplemental layer positioned in a different location than that shown in FIG. 6. As one example, FIG. 7 shows one non-limiting embodiment of a filter media comprising a supplemental layer positioned on an outermost surface of a filter media. As shown therein, the filter media 140 comprises a first layer 102, a second layer 104, a third layer 106, and a supplemental layer 116 positioned upstream of the second layer 104 at a side opposite the first layer 102. The first layer, the second layer, and the third layer in the filter media 140 shown in FIG. 7 may be the same as the first layer, the second layer, and the third layer in the filter media 110 shown in FIG. 4 or may differ in one or more ways. It is also possible for a filter media to comprise a supplemental layer in a location other than those shown in FIGS. 6-7. As an example, in some embodiments, a filter media comprises a supplemental layer between a support layer and main filter layer.

One example of a supplemental layer is an oleophobic spacer layer. Oleophobic spacer layers may be positioned between main filter layers and prefilter layers. In some embodiments, an oleophobic spacer layer is oleophobic, comprises an oleophobic additive, comprises an oleophobic coating, and/or has an oil rank greater than or equal to 1. The presence of an oleophobic spacer layer be beneficial in applications where the filter media is positioned in an environment with a moderate or high ambient oil level. For example, the presence of an oleophobic spacer layer may prevent oil migration into adjacent layers (e.g., into a main filter layer) and/or improve the lifetime of the filter media. Non-limiting examples of suitable types of oleophobic spacer layers include membrane layers, scrim layers, and meltblown layers. In some instances, more than one oleophobic spacer layers may be present in a filter media.

Another example of a supplemental layer is a coarse meltblown layer. Coarse meltblown layers may be positioned upstream from a prefilter layer and/or at an outermost surface of a filter media. Coarse meltblown layers, as described in more detail below, may have one or more properties that differ from one or more other meltblown layers (e.g., a meltblown prefilter layer) also positioned in the filter media. As two examples, a coarse meltblown layer, in some cases, may have a larger average fiber diameter, a higher porosity, and/or a larger average pore size than another meltblown layer also positioned in the filter media. In some embodiments, a coarse meltblown layer may serve as an additional protective layer for the adjacent layers (e.g., the prefilter layer, the main layer) and/or further increase the oil loading capacity of the filter media. It is also possible for a coarse meltblown to be coated with an oleophobic additive.

In some embodiments, a filter media comprises one or more supplemental layers (e.g., an oleophobic layer, a coarse meltblown layer) that is charged. Charge may be induced on a supplemental layer by a charging process (e.g., an electrostatic charging process, a triboelectric charging process, or a hydrocharging process).

In some embodiments, an adhesive resin is present between two or more layers in a filter media. As an example, in some embodiments, an adhesive resin is present between a main filter layer and a prefilter layer, a main filter layer and a support layer, a main filter layer and a backer, a main filter layer and a supplemental layer, a prefilter layer and a support layer, a prefilter layer and a backer, a prefilter layer and a supplemental layer, a support layer and a backer, a support layer and a supplemental layer, and/or a backer and a supplemental layer. When present, an adhesive resin may serve to bond two layers between which it is positioned to each other.

As used herein, when a layer is referred to as being “on” or “adjacent” another layer, it can be directly on or adjacent the layer, or an intervening layer also may be present. A layer that is “directly on”, “directly adjacent” or “in contact with” another layer means that no intervening layer is present.

Additionally, it should be understood that, although the discussion herein may refer to layers as a “first layer,” “second layer,” “third layer,” and/or “fourth layer,” such references are merely for convenience and the layers described herein may be claimed as any appropriately-numbered layer and claimed numbered layers may have properties described elsewhere herein for one or more of the types of layers that may be present in a filter media. For instance, a claimed “first layer” may be a prefilter layer, a main filter layer, a support layer, a backer, and/or a supplemental layer. Similarly, a “first layer” may have one or more of the properties described elsewhere herein for a prefilter layer, a main filter layer, a support layer, a backer, and/or a supplemental layer. Similarly, a claimed “second layer” may be any of the above-described types of layers and/or comprise one or more properties described elsewhere herein for any of the above-described types of layers. The same is true for claimed “third layers,” “fourth layers,” “fifth layers,” and further layers.

In some embodiments, one or more of the layers of a filter media may be a main filter layer (i.e., an efficiency layer). For example, in some embodiments, a filter media comprises a first layer that is a main filter layer. In some embodiments, a filter media comprises a main filter layer that is a fine fiber layer. Properties of a fine fiber layer will be described in further detail herein.

The fine fiber layer described herein may comprise fine fibers having any of a variety of suitable average fiber diameters. In some embodiments, a fine fiber layer comprises fine fibers having an average fiber diameter of greater than or equal to 10 nm, greater than or equal to 25 nm, greater than or equal to 50 nm, greater than or equal to 75 nm, greater than or equal to 100 nm, greater than or equal to 150 nm, greater than or equal to 200 nm, greater than or equal to 250 nm, greater than or equal to 300 nm, greater than or equal to 400 nm, greater than or equal to 500 nm, greater than or equal to 750 nm, greater than or equal to 1 micron, greater than or equal to 2 microns, greater than or equal to 3 microns, greater than or equal to 4 microns, or greater than or equal to 5 microns. In certain embodiments, a fine fiber layer comprises fine fibers having an average fiber diameter of less than or equal to 6 microns, less than or equal to 5 microns, less than or equal to 4 microns, less than or equal to 3 microns, less than or equal to 2 microns, less than or equal to 1 micron, less than or equal to 750 nm, less than or equal to 500 nm, less than or equal to 400 nm, less than or equal to 300 nm, less than or equal to 250 nm, less than or equal to 200 nm, less than or equal to 150 nm, or less than or equal to 100 nm. Combinations of these ranges are also possible (e.g., greater than or equal to 10 nm and less than or equal to 6 microns, greater than or equal to 25 nm and less than or equal to 1 micron, or greater than or equal to 50 nm and less than or equal to 300 nm). In certain embodiments, the fine fibers comprise nanofibers. As used herein, nanofibers are fibers having an average fiber diameter of less than or equal to 1 micron (e.g., any of the diameters, or combinations thereof, described above that are less than or equal to 1 micron).

When a fine fiber layer comprises two or more types of fine fibers, each type of fine fiber may independently have an average fiber diameter in one or more of the ranges described above and/or all of the fine fibers in a fine fiber layer may together have an average fiber diameter in one or more of the ranges described above. When a filter media comprises two or more fine fiber layers, each fine fiber layer may independently comprise fine fibers having an average fiber diameter in one or more of the ranges described above. In embodiments in which a filter media comprises two or more fine fiber layers, the average fiber diameters of the two or more fine fiber layers may be the same or different.

In some instances, a fine fiber layer comprises fine fibers that are continuous fibers (e.g., electrospun fibers, meltblown fibers, solvent-spun fibers, and/or centrifugal spun fibers). Continuous fibers are made by a “continuous” fiber-forming process, such as a meltblown, a meltspun, a melt electrospinning, a solvent electrospinning, a centrifugal spinning, or a spunbond process, and typically have longer lengths than non-continuous fibers. In some embodiments, a fine fiber layer comprises a non-woven fiber web comprising continuous fibers.

The fine fiber layer described herein may comprise fine fibers having any of a variety of suitable average fiber lengths. For instance, in some cases, the fine fibers have an average fiber length of greater than or equal to 100 mm, greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the fine fibers have an average fiber length of less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 100 mm and less than or equal to 1 km, greater than or equal to 125 mm and less than or equal to 25 m, or greater than or equal to 125 mm and less than or equal to 2 m). Other ranges are also possible.

When a fine fiber layer comprises two or more types of fine fibers, each type of fine fiber may independently have an average fiber length in one or more of the ranges described above and/or all of the fine fibers in a fine fiber layer may together have an average fiber length in one or more of the ranges described above. When a filter media comprises two or more fine fiber layers, each fine fiber layer may independently comprise fine fibers having an average fiber length in one or more of the ranges described above. In embodiments in which a filter media comprises two or more fine fiber layers, the average fiber lengths of the two or more fine fiber layers may be the same or different.

When present, fine fibers may have any suitable shape. In some embodiments, a fine fiber layer comprises fine fibers that are cylindrical. In certain embodiments, a fine fiber layer comprises fine fibers that are non-cylindrical (e.g., ribbon, flat, and/or fibrils). In some cases, a fine fiber layer comprises fine fibers that comprise core-sheath fibers (e.g., concentric core/sheath fibers and/or non-concentric core-sheath fibers), segmented pie fibers, side-by-side fibers, tip-trilobal fibers, split fibers, and “island in the sea” fibers.

According to some embodiments, a fine fiber layer comprises fine fibers that comprise a matrix polymer. For example, as shown in FIG. 3A, in certain cases, a fine fiber comprises a matrix polymer (indicated by reference sign 103 in FIG. 3A). A matrix polymer may be a polymer in which a different component (e.g., an impact modifier) is dispersed. For example, and as also shown in FIG. 3A, in some instances, a component (e.g., the impact modifier 105 shown in FIG. 3A) is dispersed in a matrix polymer. When present, the matrix polymer may form a continuous phase.

In some embodiments, a matrix polymer comprises a homopolymer. Without wishing to be bound by theory, it is believed that having a matrix polymer that comprises a homopolymer increases the compatibility with the impact modifier. In certain cases, one or more homopolymers make up greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 97 wt. %, greater than or equal to 98 wt. %, or greater than or equal to 99 wt. % of a matrix polymer. In certain embodiments, one or more homopolymers make up less than or equal to 100 wt. %, less than or equal to 99 wt. %, less than or equal to 98 wt. %, less than or equal to 97 wt. %, less than or equal to 95 wt. %, less than or equal to 90 wt. %, less than or equal to 85 wt. %, less than or equal to 80 wt. %, less than or equal to 75 wt. %, less than or equal to 70 wt. %, less than or equal to 65 wt. %, or less than or equal to 60 wt. % of a matrix polymer. Combinations of the above-referenced ranges are also possible (e.g., greater than or equal to 50 wt. % and less than or equal to 100 wt. %, greater than or equal to 80 wt. % and less than or equal to 100 wt. %, or greater than or equal to 90 wt. % and less than or equal to 100 wt. %). Other ranges are also possible. In some embodiments, one or more homopolymers make up 100 wt. % of a matrix polymer.

When a matrix polymer comprises two or more types of homopolymers, each type of homopolymer may independently make up an amount of the matrix polymer in one or more of the ranges described above and/or all of homopolymers in a matrix polymer may together make up an amount of the matrix polymer in one or more of the ranges described above.

Homopolymers may comprise a relatively high percentage of repeat units that are the same. In some embodiments, at least 90% (e.g., at least 93%, at least 95%, at least 97%, at least 99%, or 100%) of the repeat units (e.g., monomers) in a homopolymer are the same.

In some embodiments, a matrix polymer is a type of polymer other than a thermoset. A thermoset polymer may undergo one or more reactions when heated (e.g., one or more cross-linking reactions). Thermoset polymers typically do not flow upon the application of heat, but instead become less viscous. Thermoset polymers may include one or more types of polymers (e.g., a pair of polymers) and/or one or more chemicals (e.g., a pair of chemicals).

In certain embodiments, a matrix polymer comprises a thermoplastic polymer. Without wishing to be bound by theory, it is believed a matrix polymer that comprises a thermoplastic polymer displays increased solubility in organic solvents and/or increased viscoelastic behavior. This is believed to allow for fine fibers to be formed more readily. In certain cases, one or more thermoplastic polymers make up greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 97 wt. %, greater than or equal to 98 wt. %, or greater than or equal to 99 wt. % of a matrix polymer. In certain embodiments, one or more thermoplastic polymers make up less than or equal to 100 wt. %, less than or equal to 99 wt. %, less than or equal to 98 wt. %, less than or equal to 97 wt. %, less than or equal to 95 wt. %, less than or equal to 90 wt. %, less than or equal to 85 wt. %, less than or equal to 80 wt. %, less than or equal to 75 wt. %, less than or equal to 70 wt. %, less than or equal to 65 wt. %, or less than or equal to 60 wt. % of a thermoplastic polymer. Combinations of the above-referenced ranges are also possible (e.g., greater than or equal to 50 wt. % and less than or equal to 100 wt. %, greater than or equal to 80 wt. % and less than or equal to 100 wt. %, or greater than or equal to 90 wt. % and less than or equal to 100 wt. %). Other ranges are also possible. In some embodiments, a thermoplastic polymer makes up 100 wt. % of a matrix polymer.

When a matrix polymer comprises two or more types of thermoplastic polymers, each type of thermoplastic polymer may independently make up an amount of the matrix polymer in one or more of the ranges described above and/or all of thermoplastic polymers in a matrix polymer may together make up an amount of the matrix polymer in one or more of the ranges described above.

In certain embodiments, a matrix polymer comprises a linear polymer. Without wishing to be bound by theory, it is believed that a matrix polymer that comprises a linear polymer displays increased solubility in organic solvents and/or increased viscoelastic behavior. This is believed to allow for fine fibers to be formed more readily. In certain cases, a linear polymer makes up greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 97 wt. %, greater than or equal to 98 wt. %, or greater than or equal to 99 wt. % of a matrix polymer. In certain embodiments, a linear polymer makes up less than or equal to 100 wt. %, less than or equal to 99 wt. %, less than or equal to 98 wt. %, less than or equal to 97 wt. %, less than or equal to 95 wt. %, less than or equal to 90 wt. %, less than or equal to 85 wt. %, less than or equal to 80 wt. %, less than or equal to 75 wt. %, less than or equal to 70 wt. %, less than or equal to 65 wt. %, or less than or equal to 60 wt. % of a matrix polymer. Combinations of the above-referenced ranges are also possible (e.g., greater than or equal to 50 wt. % and less than or equal to 100 wt. %, greater than or equal to 80 wt. % and less than or equal to 100 wt. %, or greater than or equal to 90 wt. % and less than or equal to 100 wt. %). Other ranges are also possible. In some embodiments, a linear polymer makes up 100 wt. % of a matrix polymer.

When a matrix polymer comprises two or more types of linear polymers, each type of linear polymer may independently make up an amount of the matrix polymer in one or more of the ranges described above and/or all of linear polymers in a matrix polymer may together make up an amount of the matrix polymer in one or more of the ranges described above.

Examples of suitable matrix polymers may include synthetic polymers, such as polyamides (e.g., Nylons, such as Nylon 6 (also known as polyamide 6)), polyesters (e.g., poly(caprolactone), poly(butylene terephthalate)), polyurethanes, polyureas, acrylics, polymers comprising a side chain comprising a carbonyl functional group (e.g., poly(vinyl acetate), poly(acrylamide)), poly(ether sulfone), polyacrylics (e.g., poly(acrylonitrile), poly(acrylic acid)), polystyrene, polycarbonates, polyvinyl chloride, polysulfone, poly(amic acid), fluorinated polymers (e.g., poly(vinylidene difluoride)), polyols (e.g., poly(vinyl alcohol)), polyethers (e.g., poly(ethylene oxide)), poly(vinyl pyrrolidone), poly(allylamine), butyl rubber, polyethylene, polymers comprising a silane functional group, polymers comprising a thiol functional group, polymers comprising a methylol functional group (e.g., phenolic polymers, melamine polymers, melamine-formaldehyde polymers, cross-linkable polymers comprising pendant methylol groups), and/or combinations thereof. In some embodiments, a matrix polymer comprises a copolymer of two or more of the polymers listed above and/or a blend of two or more of the polymers listed above (e.g., a blend of a polyamide and a polyester). In certain embodiments, a matrix polymer is a glassy polymer and/or a semicrystalline polymer.

In some embodiments, a matrix polymer comprises a homopolymer. Examples of suitable homopolymers include synthetic polymers, such as those described in the preceding paragraph that comprise a relatively high percentage of repeat units that are the same.

In some embodiments, a matrix polymer comprises a thermoplastic polymer. Examples of suitable thermoplastic polymers include synthetic polymers described above that lack functional groups that react upon the application of heat.

In some embodiments, a matrix polymer comprises a linear polymer. Examples of suitable linear polymers include synthetic polymers described above that have a linear architecture. Such polymers may lack branches and/or crosslinks, or may include branches and/or cross-links in relatively low amounts.

In embodiments where the fine fibers comprise a matrix polymer, the matrix polymer may have any suitable average molecular weight (e.g., number average molecular weight (Mₙ) and/or weight average molecular weight (M_{w})). In some embodiments, a matrix polymer has an average molecular weight (e.g., Mₙ and/or M_{w}) of greater than 3 kDa, greater than or equal to 5 kDa, greater than or equal to 7 kDa, greater than or equal to 10 kDa, greater than or equal to 15 kDa, greater than or equal to 20 kDa, greater than or equal to 25 kDa, greater than or equal to 30 kDa, greater than or equal to 35 kDa, greater than or equal to 40 kDa, greater than or equal to 45 kDa, or greater than or equal to 50 kDa. In certain embodiments, a matrix polymer has an average molecular weight (e.g., Mₙ and/or M_{w}) of less than or equal to 100 kDa, less than or equal to 90 kDa, less than or equal to 80 kDa, less than or equal to 70 kDa, less than or equal to 60 kDa, less than or equal to 50 kDa, less than or equal to 45 kDa, less than or equal to 40 kDa, less than or equal to 35 kDa, less than or equal to 30 kDa, or less than or equal to 25 kDa. Combinations of the above-referenced ranges are also possible (e.g., greater than 3 kDa and less than or equal to 100 kDa, greater than or equal to 7 kDa and less than or equal to 100 kDa, or greater than or equal to 15 kDa and less than or equal to 50 kDa). Other ranges are also possible. Molecular weight (e.g., average molecular weight) may be determined using gel permeation chromatography (GPC), and may be determined using the equations disclosed elsewhere herein.

When a matrix polymer comprises two or more types of polymers, each type of polymer may independently have a molecular weight in one or more of the ranges described above and/or all of polymers in a matrix polymer may together have a molecular weight in one or more of the ranges described above.

In embodiments where fine fibers comprise a matrix polymer (and/or a matrix polymer and an impact modifier), the matrix polymer may comprise only polymers of a certain molecular weight. That is, in certain embodiments, fine fibers comprise a matrix polymer that comprises only polymers of a certain molecular weight and does not include any other polymers or components. For example, in some embodiments, a matrix polymer comprises only polymers having a molecular weight of greater than 3 kDa, greater than or equal to 5 kDa, greater than or equal to 7 kDa, greater than or equal to 10 kDa, greater than or equal to 15 kDa, greater than or equal to 20 kDa, greater than or equal to 25 kDa, greater than or equal to 30 kDa, greater than or equal to 35 kDa, greater than or equal to 40 kDa, greater than or equal to 45 kDa, or greater than or equal to 50 kDa. In certain embodiments, a matrix polymer comprises only polymers having a molecular weight of less than or equal to 100 kDa, less than or equal to 90 kDa, less than or equal to 80 kDa, less than or equal to 70 kDa, less than or equal to 60 kDa, less than or equal to 50 kDa, less than or equal to 45 kDa, less than or equal to 40 kDa, less than or equal to 35 kDa, less than or equal to 30 kDa, or less than or equal to 25 kDa. Combinations of the above-referenced ranges are also possible (e.g., greater than 3 kDa and less than or equal to 100 kDa, greater than or equal to 7 kDa and less than or equal to 100 kDa, or greater than or equal to 15 kDa and less than or equal to 50 kDa). Other ranges are also possible.

The matrix polymers described herein may have any suitable glass transition temperature. For example, in some embodiments, a matrix polymer has a glass transition temperature of greater than or equal to 20° C., greater than or equal to 25° C., greater than or equal to 30° C., greater than or equal to 40° C., greater than or equal to 45° C., greater than or equal to 50° C., greater than or equal to 60° C., greater than or equal to 70° C., greater than or equal to 80° C., greater than or equal to 90° C., greater than or equal to 100° C., greater than or equal to 125° C., greater than or equal to 150° C., greater than or equal to 175° C., or greater than or equal to 200° C. In certain embodiments, a matrix polymer has a glass transition temperature of less than or equal to 250° C., less than or equal to 225° C., less than or equal to 200° C., less than or equal to 175° C., less than or equal to 150° C., less than or equal to 125° C., less than or equal to 100° C., less than or equal to 90° C., less than or equal to 80° C., less than or equal to 70° C., less than or equal to 60° C., less than or equal to 50° C., less than or equal to 40° C., less than or equal to 30° C., or less than or equal to 25° C. Combinations of the above-referenced ranges are possible (e.g., greater than or equal to 20° C. and less than or equal to 250° C. or greater than or equal to 45° C. and less than or equal to 225° C.). Other ranges are also possible. The value of the glass transition temperature may be measured by differential scanning calorimetry (DSC).

When a matrix polymer comprises two or more types of polymers, each type of polymer may independently have a glass transition temperature in one or more of the ranges described above and/or all of polymers in a matrix polymer may together have a glass transition temperature in one or more of the ranges described above.

In embodiments where fine fibers comprise a matrix polymer (and/or a matrix polymer and an impact modifier), the fine fibers (and/or the combination of matrix polymer and impact modifier in the fine fibers) may comprise any suitable amount of matrix polymer. In certain embodiments, the matrix polymer makes up greater than or equal to 75 wt. %, greater than or equal to 80 wt. %, greater than or equal to 85 wt. %, greater than or equal to 90 wt. %, greater than or equal to 95 wt. %, or greater than or equal to 97 wt. % of the fine fibers (and/or the combination of matrix polymer and impact modifier in the fine fibers). In some embodiments, the matrix polymer makes up less than or equal to 99 wt. %, less than or equal to 97 wt. %, less than or equal to 95 wt. %, less than or equal to 90 wt. %, less than or equal to 85 wt. %, or less than or equal to 80 wt. % of the fine fibers (and/or the combination of matrix polymer and impact modifier in the fine fibers). Combinations of the above-referenced ranges are also possible (e.g., greater than or equal to 75 wt. % and less than or equal to 99 wt. %, greater than or equal to 80 wt. % and less than or equal to 97 wt. %, or greater than or equal to 85 wt. % and less than or equal to 95 wt. %). Other ranges are also possible.

When fine fibers comprise two or more types of matrix polymers, each type of matrix polymer may independently make up an amount of the fine fibers in one or more of the ranges described above and/or all of the matrix polymers in the fine fibers may together make up an amount of the fine fibers in one or more of the ranges described above.

According to some embodiments, a fine fiber layer may comprise a plurality of fine fibers comprising an impact modifier dispersed within a matrix polymer. As described above, this is shown schematically in FIG. 3B, which depicts a fine fiber 101 comprising an impact modifier 105 dispersed in a matrix polymer 103 in the form of microdomains. When present, the impact modifier may have any of a variety of properties, which are described in further detail below.

In embodiments where fine fibers comprise an impact modifier (and/or a matrix polymer and an impact modifier), the fine fibers (and/or the combination of matrix polymer and impact modifier in the fine fibers) may comprise any suitable amount of an impact modifier. In certain embodiments, an impact modifier makes up greater than or equal to 1 wt. %, greater than or equal to 3 wt. %, greater than or equal to 5 wt. %, greater than or equal to 10 wt. %, greater than or equal to 15 wt. %, or greater than or equal to 20 wt. % of the fine fibers (and/or the combination of matrix polymer and impact modifier in the fine fibers). In some embodiments, an impact modifier makes up less than or equal to 25 wt. %, less than or equal to 20 wt. %, less than or equal to 15 wt. %, less than or equal to 10 wt. %, less than or equal to 5 wt. %, or less than or equal to 3 wt. % of the fine fibers (and/or the combination of matrix polymer and impact modifier in the fine fibers). Combinations of the above-referenced ranges are also possible (e.g., greater than or equal to 1 wt. % and less than or equal to 25 wt. %, greater than or equal to 3 wt. % and less than or equal to 20 wt. %, or greater than or equal to 5 wt. % and less than or equal to 15 wt. %). Other ranges are also possible.

When fine fibers comprise two or more types of impact modifiers, each type of impact modifier may independently make up an amount of the fine fibers in one or more of the ranges described above and/or all of the impact modifiers in the fine fibers may together make up an amount of the fine fibers in one or more of the ranges described above.

In some embodiments, an impact modifier may make a brittle material (e.g., matrix polymers) more impact resistant. Without wishing to be bound by any theory, it is believed that, in some cases, an impact modifier makes brittle materials more impact resistant by: (1) stopping a crack from spreading in the brittle material by widening the crack tip, such that mechanical energy is distributed across a larger radius of curvature, and/or (2) creating zones where strain can occur without creating cracks, such as zones in which the impact modifier expands and/or cavitates.

In certain embodiments, an impact modifier comprises a copolymer comprising at least two different types of repeat units. One type of repeat unit may have affinity to the matrix polymer and another type of repeat unit may not have affinity to the matrix polymer.

In certain embodiments, an impact modifier that is a copolymer comprises greater than or equal to 2, greater than or equal to 3, greater than or equal to 4, or greater than or equal to 5 different types of repeat units. According to some embodiments, an impact modifier that is a copolymer comprises less than or equal to 6, less than or equal to 5, less than or equal to 4, less than or equal to 3, or less than or equal to 2 different types of repeat units. Combinations of the above-referenced ranges are also possible (e.g., greater than or equal to 2 and less than or equal to 6, greater than or equal to 2 and less than or equal to 5, or greater than or equal to 2 and less than or equal to 4). Other ranges are also possible. In some instances, a copolymer comprises a terpolymer. In certain cases, a copolymer comprises a random copolymer, a block copolymer, and/or a graft copolymer.

When fine fibers comprise two or more types of impact modifiers, each type of impact modifier may independently include an amount of types of repeat units in one or more of the ranges described above and/or have one or more of the structures described above.

A repeat unit that has an affinity to a matrix polymer may be the same type of repeat unit as a repeat unit in the matrix polymer, may be miscible with the matrix polymer, may comprise one or more reactive sites that are capable of covalently bonding with the matrix polymer and/or configured to covalently bond with the matrix polymer, may be capable of having and/or configured to have an ionic interaction with the matrix polymer, and/or may have a total solubility parameter of that is similar to that of a repeat unit of the matrix polymer. Whether covalent bonds are formed and whether ionic interactions are present may be determined by spectroscopy techniques, such as FTIR.

Two repeat units may have similar total solubility parameters when the Flory-Huggins parameter (χ) is less than or equal to 0.75 (e.g., less than or equal to 0.6, less than or equal to 0.5, less than or equal to 0.4, less than or equal to 0.3, less than or equal to 0.2, or less than or equal to 0.1). The total solubility parameter of each monomer may be known or may be determined using the Hansen solubility parameters. For example, the Hansen solubility parameters for dipole-dipole interactions, dispersion forces, and hydrogen bonding for exemplary repeat units are shown in Table 1 below. These may be converted to the total solubility parameter by the following equation:

δ_{T}=\sqrt{δ_{dispersion}²+δ_{dipole-dipole}²+δ_{H bond}²} (Equation 1).

The Flory-Huggins parameter (λ) may be determined from the total solubility parameters using the following equation:

$$χ = \frac{{V}_{2}}{RT} {( {δ}_{2} - {δ}_{1} )}^{2} , \qquad ( Equation 2 )$$

where δ₂ is the total solubility parameter of the repeat unit of the matrix polymer, δ₁ is the total solubility parameter of the repeat unit of the impact modifier, V₂ is the molar volume of the repeat unit of the matrix polymer (which may be determined by dividing the density of the repeat unit by the molecular weight of the repeat unit), R is the gas constant (equivalent to 8.31 J/mol/K), and T is the absolute temperature in Kelvin.

TABLE 1
Examples of solubility parameters for exemplary repeat units.

| Polymer | | | | |
|---|---|---|---|---|
| Comprising the | | | | |
| Repeat Unit | δ_{dispersion(J/cm}_{³}₎ | δ_{dipole-dipole(J/cm}_{³}₎ | δ_{H bond(J/cm}_{³}₎ | δ_{T (√(J/cm}_{³}₎ |
| Polyamide | 17.4 | 9.6 | 12 | 29.7 |
| Polystyrene | 21.8 | 5.75 | 4.3 | 20.3 |
| Polypropylene | 17.9 | 0 | 0 | 23.2 |
| Polycarbonate | 19.35 | 6.43 | 5.8 | 23.0 |
| Polyethylene | 14.48 | −3.88 | 2.76 | 17.9 |
| Polyethylene | 16.5 | 5.9 | 4.1 | 21.2 |
| (LDPE) | | | | |
| Poly(maleic | 20.6 | 28.5 | 0 | 15.2 |
| anhydride) | | | | |
| Poly(butyl | 17.1175 | 12.3205 | 0 | 18.0 |
| acrylate) | | | | |
| PET | 19.44 | 3.48 | 8.59 | 27.8 |

For example, the Flory-Huggins parameters obtained by employing the total solubility parameters (δ_{T}) to solve Equation 2 for combinations of various repeat units are shown in Table 2 below, where the X (along the diagonal) indicates that the Flory-Huggins parameter is 0.

TABLE 2
Examples of Flory-Huggins parameters for various combinations of repeat units

| | | | | | | Poly- | | | |
|---|---|---|---|---|---|---|---|---|---|
| | | Poly- | Poly- | Poly- | Poly- | ethylene | | Poly(butyl | |
| | Polyamide | styrene | propylene | carbonate | ethylene | (LDPE) | | acrylate) | PET |
| | (Nylon 6) | repeat | repeat | repeat | repeat | repeat | Maleic | repeat | repeat |
| χ | repeat unit | unit | unit | unit | unit | unit | anhydride | unit | unit |
| Polyamide (Nylon | | 0.003 | 0.553 | 0.342 | 0.839 | 0.359 | 0.557 | 0.215 | 0.163 |
| 6) repeat unit | | | | | | | | | |
| Polystyrene | 0.003 | | 0.500 | 0.259 | 0.784 | 0.324 | 0.622 | 0.165 | 0.116 |
| repeat unit | | | | | | | | | |
| Polypropylene | 0.553 | 0.500 | | 0.917 | 0.093 | 0.000 | 2.595 | 0.485 | 0.764 |
| repeat unit | | | | | | | | | |
| Polycarbonate | 0.342 | 0.259 | 0.917 | | 0.468 | 0.135 | 1.153 | 0.001 | 0.007 |
| repeat unit | | | | | | | | | |
| Polyethylene | 0.839 | 0.784 | 0.093 | 0.468 | | 0.100 | 4.175 | 1.628 | 2.288 |
| repeat unit | | | | | | | | | |
| Polyethylene | 0.359 | 0.324 | 0.000 | 0.135 | 0.100 | | 2.544 | 0.456 | 0.724 |
| (LDPE) repeat | | | | | | | | | |
| unit | | | | | | | | | |
| Maleic anhydride | 0.557 | 0.622 | 2.595 | 1.153 | 4.175 | 2.544 | | 2.144 | 2.266 |
| Poly | 0.215 | 0.165 | 0.485 | 0.001 | 1.628 | 0.456 | 2.144 | | 0.011 |
| (butylacrylate) | | | | | | | | | |
| repeat unit | | | | | | | | | |
| PET repeat unit | 0.163 | 0.116 | 0.764 | 0.007 | 2.288 | 0.724 | 2.266 | 0.011 | |

As an example of a repeat unit in an impact modifier that has affinity to a matrix polymer, a repeat unit in an impact modifier that is of the same type as a repeat unit present in a matrix polymer would have affinity to the matrix polymer. This pair of repeat units would have a Flory-Huggins parameter of 0.

As another example, a repeat unit in an impact modifier may have affinity to a matrix polymer if it is miscible with the matrix polymer. Miscibility may occur when a homopolymer comprising the relevant repeat unit forms a homogeneous solution with the matrix polymer in the solid, glassy phase. This can be determined, for example, by DSC, where the homogeneous solution would show a single glass transition. For each sample, two cycles of heating and cooling may be performed and the miscibility may be determined during the second heating. The heating and cooling may be performed at a ramp rate of 5° C. per minute. Each sample may be heated to an upper bound temperature that is greater than the melting temperature of the polymer as observed by DSC and cooled to −60° C.

In certain embodiments, a repeat unit present in an impact modifier does not have affinity to the matrix polymer. In such embodiments, it may be of a different type from all of the repeat units present in the matrix polymer, may be immiscible with the matrix polymer, may lack reactive sites that are configured to covalently bond with the matrix polymer and/or capable of covalently bonding with the matrix polymer, may be incapable of having and/or not configured to have ionic interactions with the matrix polymer, and/or it may have a total solubility parameter dissimilar from that of any repeat unit present in the matrix polymer (e.g., it may have a Flory-Huggins parameter of greater than 0.75 with respect to each repeat unit present in the matrix polymer).

According to some embodiments, an impact modifier and/or a repeat unit thereof comprises a polyamide (e.g., polyamide 6, polyamide 11, and/or polyamide 6,6), a polystyrene, a polyether, a polypropylene, a polycarbonate, a polyethylene, a polyester, ABS (acrylonitrile butadiene styrene), and/or PVC (polyvinyl chloride). Examples of suitable impact modifiers include the impact modifiers in Table 3.

TABLE 3
Non-limiting examples of suitable impact modifiers,
matrix polymers, and combinations thereof

| | | Monomers/Repeat | | |
|---|---|---|---|---|
| | | units (the impact | | Types of |
| | | modifier may | | interaction with |
| | | comprise some or all | | matrix polymer |
| | | of the types of repeat | | (the impact |
| | | units below and/or be | | modifier may |
| | | formed from some or | | undergo some |
| Type of | Type of | all of the types of | Suitable | or all of the |
| impact | co- | monomers listed | matrix | interactions |
| modifier | polymer | below) | polymers | below) |
| Styrenic | Block | 1. Styrene | Poly- | Like |
| | | 2. Monomers from | styrene | monomers |
| | | which olefin rubber | Poly- | |
| | | is formed (e.g., | propylene | |
| | | isoprene, butadiene, | | |
| | | hydrogenated | | |
| | | isoprene, | | |
| | | hydrogenated | | |
| | | butylene) | | |
| Maleated | Random | 1. Maleic | Polyamide | Polar |
| | and/or | anhydride | Poly- | interaction |
| | graft | 2. Ethylene | carbonate | Chemical |
| | | | | reaction |
| Ethylene- | Random | 1. Ethylene, | Poly- | Like |
| acrylate | | propylene | ethylene | monomers |
| terpolymer | | 2. Acrylic (e.g., | Poly- | Miscibility |
| | | butyl acrylate, ethyl | propylene | Polar |
| | | acrylate, methyl | Polyester | interaction |
| | | acrylate) | Polyamide | Reaction |
| | | 3. Glycidyl | ABS | |
| | | methacrylate | | |
| Polyamide | Random | 1. Amide | Polyamide | Like |
| terpolymer | | monomers (e.g., | | monomers |
| | | mixtures of amide | | |
| | | monomers | | |
| PEBA | Block | 1. Amides | Polyamide | Like |
| | | 2. Ether | | monomers |
| Ionomers | Random | 1. Ethylene | Polyamide | Polar |
| | | 2. Acrylic acid salt | | interaction |
| | | | | Chemical |
| | | | | reaction |
| Chlorinated | Random | 1. Vinyl chloride | PVC | Like |
| polyethylene | and/or | 2. Ethylene | | monomers |
| | graft | | | |

Impact modifiers may have any suitable average molecular weight (e.g., Mₙ and/or M_{w}). For example, in some cases, an impact modifier has an average molecular weight (e.g., Mₙ and/or M_{w}) of greater than or equal to 1 kDa, greater than or equal to 3 kDa, greater than or equal to 5 kDa, greater than or equal to 7 kDa, greater than or equal to 10 kDa, greater than or equal to kDa, greater than or equal to 20 kDa, greater than or equal to 25 kDa, greater than or equal to kDa, greater than or equal to 35 kDa, greater than or equal to 40 kDa, greater than or equal to kDa, greater than or equal to 50 kDa, greater than or equal to 55 kDa, or greater than or equal to 60 kDa. In certain embodiments, an impact modifier has an average molecular weight (e.g., Mₙ and/or M_{w}) of less than or equal to 100 kDa, less than or equal to 90 kDa, less than or equal to 80 kDa, less than or equal to 70 kDa, less than or equal to 60 kDa, less than or equal to 50 kDa, less than or equal to 45 kDa, less than or equal to 40 kDa, less than or equal to 35 kDa, less than or equal to 30 kDa, or less than or equal to 25 kDa. Combinations of the above-referenced ranges are also possible (e.g., greater than or equal to 1 kDa and less than or equal to 100 kDa, greater than or equal to 3 kDa and less than or equal to 100 kDa, greater than or equal to 7 kDa and less than or equal to 100 kDa, greater than or equal to 20 kDa and less than or equal to 70 kDa). Other ranges are also possible. Average molecular weight may be determined using gel permeation chromatography (GPC), and may be determined using the equations disclosed elsewhere herein.

When fine fibers comprise two or more types of impact modifiers, each type of impact modifier may independently have a molecular weight in one or more of the ranges described above and/or all of the impact modifiers together may have a molecular weight in one or more of the ranges described above.

The ratio of the average molecular weight of an impact modifier to the average molecular weight of a matrix polymer present in the same fine fiber may have any suitable value. For example, in certain embodiments, the ratio of the average molecular weight of the impact modifier to the average molecular weight of the matrix polymer is greater than or equal to 1:30, greater than or equal to 1:20, greater than or equal to 1:10, greater than or equal to 2:10, greater than or equal to 3:10, greater than or equal to 4:10, greater than or equal to 5:10, greater than or equal to 6:10, greater than or equal to 7:10, greater than or equal to 8:10, greater than or equal to 9:10, greater than or equal to 1:1, greater than or equal to 1.25:1, greater than or equal to 1.5:1, or greater than or equal to 1.75:1. In some instances, the ratio of the average molecular weight of the impact modifier to the average molecular weight of the matrix polymer is less than or equal to 2:1, less than or equal to 1.9:1, less than or equal to 1.8:1, less than or equal to 1.7:1, less than or equal to 1.6:1, less than or equal to 1.5:1, less than or equal to 1.4:1, less than or equal to 1.3:1, less than or equal to 1.2:1, less than or equal to 1.1:1, less than or equal to 1:1, less than or equal to 8:10, less than or equal to 6:10, less than or equal to 4:10, less than or equal to 2:10, or less than or equal to 1:10. Combinations of the above-referenced ranges are also possible (e.g., greater than or equal to 1:30 and less than or equal to 2:1 or greater than or equal to 1:10 and less than or equal to 2:1). Other ranges are also possible.

When fine fibers comprise two or more types of impact modifiers and/or matrix polymers, the ratio of the average molecular weight of each type of impact modifier to each type of matrix polymer may be in one or more of the ranges described above. In some embodiments, the ratio of the average molecular weight of all of the impact modifiers together to all of the matrix polymers together is in one or more of the ranges described above.

The impact modifiers described herein may have any suitable polydispersity index (PDI). For example, in some cases, an impact modifier has a PDI of less than or equal to 3, less than or equal to 2.75, less than or equal to 2.5, less than or equal to 2.25, or less than or equal to 2. In certain instances, an impact modifier has a PDI of greater than or equal to 1, greater than or equal to 1.25, greater than or equal to 1.5, greater than or equal to 1.75, greater than or equal to 2, greater than or equal to 2.25, or greater than or equal to 2.5. Combinations of the above-referenced ranges are also possible (e.g., greater than or equal to 1 and less than or equal to 3 or greater than or equal to 1 and less than or equal to 2). Other ranges are also possible.

When fine fibers comprise two or more types of impact modifiers, each type of impact modifier may independently have a PDI in one or more of the ranges described above and/or all of the impact modifiers together may have a PDI in one or more of the ranges described above.

PDI may be determined according to the following equation:

PDI=M_{w}/Mₙ (Equation 3),

where M_{w} is the weight average molecular weight and Mₙ is the number average molecular weight and M_{w} and Mₙ may be calculated from parameters measured using gel permeation chromatography according to ASTM D 3536 (1991).
M_{w} may be determined according to the following equations, or measured:

$$\overline{{M}_{w}} = \frac{{\sum }_{i = 1}^{N} {w}_{i} {M}_{i}}{{\sum }_{i = 1}^{N} {w}_{i}} = \frac{{\sum }_{i = 1}^{N} {N}_{i} {M}_{i}^{2}}{{\sum }_{i = 1}^{N} {N}_{i} {M}_{i}} , \qquad ( Equation 4 )$$

where wᵢ is the total weight (mass) of polymer chains with a specific length or molecular weight, Mᵢ is the molecular weight of the individual polymer chain with a specific length or molecular weight, Nᵢ is the number of polymer chains having approximately the same specific length or molecular weight, and N is the number of unique specific lengths or molecular weights of polymer chains within a sample. M_{w} may be used to determine the values of other variables (e.g., wᵢ and Mᵢ) from the same equation.

Mₙ may be determined according to the following equation:

$$\overline{{M}_{n}} = \frac{{\sum }_{i = 1}^{N} {N}_{i} {M}_{i}}{{\sum }_{i = 1}^{N} {N}_{i}} , \qquad ( Equation 5 )$$

where Mᵢ, Nᵢ, and N are as described above.

In some embodiments, a fine fiber comprises an impact modifier that does not substantially chemically react with a matrix polymer also present in the fine fiber. For example, in some cases, less than or equal to 10% (e.g., less than or equal to 5%, less than or equal to 3%, less than or equal to 1%, or none) of the repeat units present in an impact modifier have functional groups that are capable of reacting and/or configured to react with the matrix polymer. This may be determined from chemical analysis utilizing FTIR (Fourier transform infrared) spectroscopy, NMR (nuclear magnetic resonance) spectroscopy, and/or titration. As another example, in certain instances, there is no observable heat flow (e.g., due to chemical reaction) in a fine fiber comprising an impact modifier and a matrix polymer during a calorimetry process.

According to some embodiments, a fine fiber comprises an impact modifier and a matrix polymer, and the impact modifier does not substantially affect one or more thermal transitions of the matrix polymer. For example, in certain cases, the glass transition temperature of the matrix polymer is not substantially affected by the addition of the impact modifier (e.g., it may stay within 25%, within 20%, within 15%, within 10%, or within 5% of the glass transition temperature it would have without the presence of the impact modifier and/or may have the same glass transition temperature as it does without the presence of the impact modifier). As another example, in some instances, one or more thermal transitions (e.g., melting and/or crystallization) of the matrix polymer are reversible even when in the presence of the impact modifier. Thermal transitions, and reversibility thereof, may be determined by DSC.

In certain embodiments, an impact modifier exhibits independent thermal transitions from the matrix polymer even when both are present in the same fine fiber, as determined by DSC.

In some embodiments, an impact modifier may be capable of being separated from a matrix polymer with which it is present in a fine fiber by physical means (e.g., extraction).

In some instances, an impact modifier is dispersed in a matrix polymer. For example, in certain cases, an impact modifier is uniformly dispersed throughout a matrix polymer. In certain embodiments, an impact modifier is present in microdomains in a continuous phase (e.g., a continuous phase that is and/or comprises the matrix polymer). Whether the impact modifier is dispersed in the matrix polymer and morphological features of the dispersion (if present) may be determined by transmission electron microscopy (TEM) using staining for contrast.

According to certain embodiments, a fine fiber comprises one or more impact modifiers that take the form of discrete microdomains. The impact modifier discrete microdomains may have any suitable average largest cross-sectional diameter. For example, in some cases, the impact modifier discrete microdomains have an average largest cross-sectional diameter of greater than or equal to 1/100, greater than or equal to 1/90, greater than or equal to 1/80, greater than or equal to 1/70, greater than or equal to 1/60, greater than or equal to 1/50, greater than or equal to 1/40, greater than or equal to 1/30, greater than or equal to 1/20, greater than or equal to 1/10, greater than or equal to 1/7, greater than or equal to ⅕, greater than or equal to ¼, greater than or equal to ⅓, or greater than or equal to ½ of the average diameter of the fine fibers. In certain embodiments, the impact modifier discrete microdomains have an average largest cross-sectional diameter of less than or equal to ¾, less than or equal to ⅔, less than or equal to ½, less than or equal to ⅓, less than or equal to ¼, less than or equal to ⅕, less than or equal to 1/7, less than or equal to 1/10, less than or equal to 1/20, less than or equal to 1/30, less than or equal to 1/40, less than or equal to 1/50, less than or equal to 1/60, less than or equal to 1/70, less than or equal to 1/80, or less than or equal to 1/90 of the average largest cross-sectional diameter of the fine fibers. Combinations of the above-referenced ranges are also possible (e.g., greater than or equal to 1/100 and less than or equal to ¾ or greater than or equal to 1/100 and less than or equal to ¼). Other ranges are also possible.

When fine fibers comprise two or more types of impact modifier discrete microdomains, each type of impact modifier discrete microdomain may independently have an average largest cross-sectional diameter in one or more of the ranges described above and/or all of the impact modifier discrete microdomains together may have an average largest cross-sectional diameter in one or more of the ranges described above.

In some embodiments, a fine fiber comprises impact modifier discrete microdomains, and the average diameter of the impact modifier discrete microdomains is greater than or equal to 10 nm, greater than or equal to 25 nm, greater than or equal to 50 nm, greater than or equal to 75 nm, greater than or equal to 100 nm, greater than or equal to 150 nm, greater than or equal to 200 nm, greater than or equal to 250 nm, greater than or equal to 300 nm, greater than or equal to 350 nm, greater than or equal to 400 nm, or greater than or equal to 450 nm. In certain embodiments, the average diameter of the impact modifier discrete microdomains is less than or equal to 500 nm, less than or equal to 450 nm, less than or equal to 400 nm, less than or equal to 350 nm, less than or equal to 300 nm, less than or equal to 250 nm, less than or equal to 200 nm, less than or equal to 150 nm, less than or equal to 100 nm, less than or equal to 75 nm, less than or equal to 50 nm, or less than or equal to 25 nm. Combinations of the above-referenced ranges are also possible (e.g., greater than or equal to 10 nm and less than or equal to 500 nm). Other ranges are also possible. The average diameter of the impact modifier discrete microdomains may be determined by transmission electron microscopy (TEM).

When fine fibers comprise two or more types of impact modifier discrete microdomains, each type of impact modifier discrete microdomain may independently have an average largest cross-sectional diameter in one or more of the ranges described above and/or all of the impact modifier discrete microdomains together may have an average largest cross-sectional diameter in one or more of the ranges described above.

Impact modifiers may have any suitable glass transition temperature relative to the temperature at which the filter media would be used. For example, in some embodiments, the glass transition temperature of an impact modifier is lower than (e.g., at least 1° C., at least 3° C., at least 5° C., at least 10° C., at least 15° C., or at least 20° C. lower than) the temperature at which the filter media would be used (e.g., a use temperature of greater than or equal to 20° C., greater than or equal to 40° C., greater than or equal to 60° C., or greater than or equal to 80° C.; less than or equal to 100° C., less than or equal to 80° C., less than or equal to 60° C., or less than or equal to 40° C.; combinations of the above-referenced ranges are also possible, such as greater than or equal to 20° C. and less than or equal to 100° C. or greater than or equal to 20° C. and less than or equal to 60° C.). Without wishing to be bound by any theory, it is believed that using an impact modifier with a glass transition temperature lower than the use temperature (e.g., by a range specified herein) allows the impact modifier to absorb energy at approximately the velocity/frequency of crack propagation in the matrix polymer.

The impact modifiers described herein may have any suitable absolute glass transition temperature. Without wishing to be bound by theory, it is believed that a low glass transition temperature imparts a rubbery nature to the impact modifier, which may allow it to make brittle materials more impact resistant. In certain cases, an impact modifier has a glass transition temperature of greater than or equal to −50° C., greater than or equal to −40° C., greater than or equal to −30° C., greater than or equal to −20° C., greater than or equal to −10° C., greater than or equal to 0° C., or greater than or equal to 10° C. In some instances, an impact modifier has a glass transition temperature of less than or equal to 15° C., less than or equal to 10° C., less than or equal to 5° C., less than or equal to 0° C., less than or equal to −10° C., less than or equal to −20° C., less than or equal to −30° C., or less than or equal to −40° C. Combinations of the above-referenced ranges are also possible (e.g., greater than or equal to −50° C. and less than or equal to 15° C.). Other ranges are also possible. The value of the glass transition temperature may be measured by DSC.

When fine fibers comprise two or more types of impact modifiers, each type of impact modifier may independently have a glass transition temperature in one or more of the ranges described above and/or all of the impact modifiers together may have a glass transition temperature in one or more of the ranges described above.

In certain embodiments, fine fibers present in a fine fiber layer comprise a salt. Examples of suitable salts include ammonium salts (e.g., tetraethylammonium bromide (TEAB)), sulfonium salts, organic salts (e.g., pyridine), and/or inorganic salts.

In embodiments where fine fibers comprise a salt, the fine fibers may comprise any suitable amount of salt. For example, in some cases, the amount of salt in the fine fibers in a fine fiber layer is less than or equal to 5 wt. %, less than or equal to 4 wt. %, less than or equal to 3 wt. %, less than or equal to 2 wt. % or less than or equal to 1 wt. %. In certain instances, the amount of salt in the fine fibers in a fine fiber layer is greater than or equal to 0.1 wt. %, greater than or equal to 0.5 wt. %, greater than or equal to 1 wt. %, greater than or equal to 2 wt. %, greater than or equal to 3 wt. %, or greater than or equal to 4 wt. %. Combinations of the above-referenced ranges are also possible (e.g., greater than or equal to 0.1 wt. % and less than or equal to 5 wt. % or greater than or equal to 1 wt. % and less than or equal to 5 wt. %). Other ranges are also possible.

In some embodiments, a filter media comprises a fine fiber layer in which at least some (or all) of the fine fibers do not include an impact modifier. One example of such a fine fiber layer is shown schematically in FIG. 3B. For example, in one set of embodiments, a fine fiber layer described herein does not include fine fibers comprising an impact modifier dispersed within the matrix polymer.

In embodiments in which the fine fiber layer does not include impact modifiers dispersed in a matrix polymer, the fine fibers may comprise any of a variety of suitable materials, such as those described elsewhere herein as being suitable for use as a matrix polymer.

The fine fiber layers described herein may have any of a variety of suitable porosities (i.e., void volumes). In some embodiments, a fine fiber layer has a porosity of greater than or equal to 65%, greater than or equal to 70%, greater than or equal to 75%, greater than 80%, greater than or equal to 80%, greater than or equal to 85%, greater than or equal to 90%, greater than or equal to 95%, or greater than or equal to 97%. In some embodiments, a fine fiber layer has a porosity of less than or equal to 99%, less than or equal to 98%, less than or equal to 97%, less than or equal to 95%, less than or equal to 90%, less than or equal to 85%, less than or equal to 80%, less than 80%, or less than or equal to 75%. Combinations of the above-referenced ranges are also possible (e.g., greater than or equal to 65% and less than or equal to 99%, greater than or equal to 70% and less than or equal to 97%, greater than or equal to 80% and less than or equal to 97%, or greater than 80% and less than or equal to 99%). Other ranges are also possible.

When a filter media comprises two or more fine fiber layers, each fine fiber layer may independently have a porosity in one or more of the above-referenced ranges. In embodiments in which a filter media comprises two or more fine fiber layers, the porosities of the two or more fine fiber layers may be the same or different.

The porosity of a layer is equivalent to 100%−[solidity of the layer]. The solidity of a layer is equivalent to the percentage of the interior of the layer occupied by solid material. One non-limiting way of determining solidity of a layer is described in this paragraph, but other methods are also possible. The method described in this paragraph includes determining the basis weight and thickness of the layer and then applying the following formula: solidity=[basis weight of the layer/(density of the components forming the layer·thickness of the layer)]·100%. The density of the components forming the layer is equivalent to the average density of the material or material(s) forming the components of the layer (e.g., the fibers therein, any other components therein), which is typically specified by the manufacturer of each material. The average density of the materials forming the components of the layer may be determined by: (1) determining the total volume of all of the components in the layer; and (2) dividing the total mass of all of the components in the layer by the total volume of all of the components in the layer of the first type. If the mass and density of each component of the layer are known, the volume of all the components in the layer may be determined by: (1) for each type of component, dividing the total mass of the component in the layer of the first type by the density of the component; and (2) summing the volumes of each component. If the mass and density of each component of the layer are not known, the volume of all the components in the layer may be determined in accordance with Archimedes' principle.

The fine fiber layers described herein may have any of a variety of suitable average pore sizes. In some embodiments, a fine fiber layer has an average pore size of greater than or equal to 0.001 microns, greater than or equal to 0.01 microns, greater than or equal to 0.05 microns, greater than or equal to 0.1 microns, greater than or equal to 0.2 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. In some embodiments, a fine fiber layer has an average pore size of less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, less than or equal to 0.5 microns, less than or equal to 0.2 microns, less than or equal to 0.1 microns, less than or equal to 0.05 microns, or less than or equal to 0.01 microns. Combinations of the above-referenced ranges are also possible (e.g., greater than or equal to 0.001 microns and less than or equal to 10 microns, greater than or equal to 0.01 microns and less than or equal to 8 microns, or greater than or equal to 0.01 microns and less than or equal to 5 microns). Other ranges are also possible.

When a filter media comprises two or more fine fiber layers, each fine fiber layer may independently have an average pore size in one or more of the above-referenced ranges. In embodiments in which a filter media comprises two or more fine fiber layers, the porosities of the two or more fine fiber layers may be the same or different.

The average pore size may be measured using ASTM F316 (2003).

The fine fiber layers described herein may have any suitable maximum pore diameter. In some embodiments, a fine fiber layer has a maximum pore diameter of greater than or equal to 0.1 microns, greater than or equal to 0.2 microns, greater than or equal to 0.3 microns, greater than or equal to 0.4 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, or greater than or equal to 12 microns. In some embodiments, a fine fiber layer has a maximum pore diameter of less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1 micron. Combinations of the above-referenced ranges are also possible (e.g., greater than or equal to 0.1 microns and less than or equal to 15 microns, greater than or equal to 0.3 microns and less than or equal to 12 microns, or greater than or equal to 0.3 microns and less than or equal to 12 microns). Other ranges are also possible.

When a filter media comprises two or more fine fiber layers, each fine fiber layer may independently have a maximum pore diameter in one or more of the above-referenced ranges. In embodiments in which a filter media comprises two or more fine fiber layers, the maximum pore diameters of the two or more fine fiber layers may be the same or different.

The maximum pore size may be measured using ASTM F316 (2003).

The fine fiber layers described herein may have any of a variety of suitable thicknesses. For example, in some embodiments, a fine fiber layer has a thickness greater than the average fiber diameter of the fine fibers in the layer. For example, in some embodiments, a fine fiber layer has a thickness of greater than or equal to 10 nm, greater than or equal to 20 nm, greater than or equal to 30 nm, greater than or equal to 40 nm, greater than or equal to 50 nm, greater than or equal to 100 nm, greater than or equal to 500 nm, greater than or equal to 1 micron, greater than or equal to 10 microns, greater than or equal to 0.1 mm, greater than or equal to 1 mm, greater than or equal to 3 mm, or greater than or equal to 4 mm. In some embodiments, a fine fiber layer has a thickness of less than or equal to 5 mm, less than or equal to 4 mm, less than or equal to 3 mm, less than or equal to 2 mm, less than or equal to 1 mm, less than or equal to 0.5 mm, less than or equal to 0.2 mm, less than or equal to 0.1 mm, less than or equal to 10 microns, less than or equal to 1 micron, less than or equal to 500 nm, or less than or equal to 100 nm. Combinations of the above-referenced ranges are also possible (e.g., greater than or equal to nm and less than or equal to 5 mm, greater than or equal to 20 nm and less than or equal to 1 mm, or greater than or equal to 50 nm and less than or equal to 0.2 mm). Other ranges are also possible.

When a filter media comprises two or more fine fiber layers, each fine fiber layer may independently have a thickness in one or more of the above-referenced ranges. In embodiments in which a filter media comprises two or more fine fiber layers, the thicknesses of the two or more fine fiber layers may be the same or different.

Thickness may be determined using Scanning Electron Microscopy (SEM) to image a cross-section of the fine fiber layer.

The fine fiber layers described herein may have any of a variety of suitable basis weights. For example, in some embodiments, a fine fiber layer has a basis weight of greater than or equal to 0.001 g/m² (gsm), greater than or equal to 0.01 gsm, greater than or equal to 0.1 gsm, greater than or equal to 1 gsm, greater than or equal to 2 gsm, greater than or equal to 3 gsm, greater than or equal to 4 gsm, greater than or equal to 5 gsm, greater than or equal to 7 gsm, greater than or equal to 10 gsm, greater than or equal to 12 gsm, greater than or equal to 15 gsm, or greater than or equal to 18 gsm. In some embodiments, a fine fiber layer has a basis weight of less than or equal to 20 gsm, less than or equal to 18 gsm, less than or equal to 15 gsm, less than or equal to 13 gsm, less than or equal to 10 gsm, less than or equal to 8 gsm, less than or equal to gsm, less than or equal to 4 gsm, less than or equal to 3 gsm, less than or equal to 2 gsm, or less than or equal to 1 gsm. Combinations of the above-referenced ranges are also possible (e.g., greater than or equal to 0.001 gsm and less than or equal to 20 gsm, greater than or equal to 0.01 gsm and less than or equal to 10 gsm, or greater than or equal to 0.1 gsm and less than or equal to gsm). Other ranges are also possible.

When a filter media comprises two or more fine fiber layers, each fine fiber layer may independently have a basis weight in one or more of the above-referenced ranges. In embodiments in which a filter media comprises two or more fine fiber layers, basis weights of the two or more fine fiber layers may be the same or different.

Basis weight may be measured according to ASTM D3776-20 (2020).

The fine fiber layers described herein may have any of a variety of suitable air permeabilities. For example, in some embodiments, a fine fiber layer has an air permeability of greater than 0 ft³/(min·ft²) (CFM), greater than or equal to 0.1 CFM, greater than or equal to 0.5 CFM, greater than or equal to 1 CFM, greater than or equal to 2 CFM, greater than or equal to 5 CFM, greater than or equal to 7 CFM, greater than or equal to 10 CFM, greater than or equal to 12 CFM, greater than or equal to 15 CFM, greater than or equal to 20 CFM, greater than or equal to 25 CFM, greater than or equal to 30 CFM, greater than or equal to 40 CFM, greater than or equal to 50 CFM, greater than or equal to 60 CFM, greater than or equal to 70 CFM, greater than or equal to 80 CFM, or greater than or equal to 90 CFM. In some cases, a fine fiber layer has an air permeability of less than or equal to 100 CFM, less than or equal to 90 CFM, less than or equal to 80 CFM, less than or equal to 70 CFM, less than or equal to 60 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12 CFM, less than or equal to 10 CFM, less than or equal to 7 CFM, or less than or equal to 5 CFM. Combinations of the above-referenced ranges are also possible (e.g., greater than 0 CFM and less than or equal to 100 CFM, greater than or equal to 0.1 CFM and less than or equal to 50 CFM, or greater than or equal to 0.5 CFM and less than or equal to 30 CFM). Other ranges are also possible.

When a filter media comprises two or more fine fiber layers, each fine fiber layer may independently have an air permeability in one or more of the above-referenced ranges. In embodiments in which a filter media comprises two or more fine fiber layers, the air permeabilities of the two or more fine fiber layers may be the same or different.

Air permeability may be measured according to ASTM D737-04 (2016) at a pressure of 125 Pa.

The fine fiber layers described herein may have any suitable elongation at break. In some embodiments, a fine fiber layer has an elongation at break of greater than or equal to 5%, greater than or equal to 10%, greater than or equal to 15%, greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 100%, greater than or equal to 125%, greater than or equal to 150%, greater than or equal to 175%, or greater than or equal to 200%. In some embodiments, a fine fiber layer has an elongation at break of less than or equal to 300%, less than or equal to 275%, less than or equal to 250%, less than or equal to 225%, less than or equal to 200%, less than or equal to 175%, less than or equal to 150%, less than or equal to 125%, less than or equal to 100%, less than or equal to 90%, less than or equal to 80%, less than or equal to 70%, less than or equal to 60%, or less than or equal to 50%. Combinations of the above-referenced ranges are also possible (e.g., greater than or equal to 5% and less than or equal to 300%, greater than or equal to 20% and less than or equal to 300%, greater than or equal to 40% and less than or equal to 300%, greater than or equal to 30% and less than or equal to 200%, or greater than or equal to 40% and less than or equal to 80%). Other ranges are also possible.

When a filter media comprises two or more fine fiber layers, each fine fiber layer may independently have an elongation at break in one or more of the above-referenced ranges. In embodiments in which a filter media comprises two or more fine fiber layers, the elongations at break of the two or more fine fiber layers may be the same or different.

The elongation at break may be determined in accordance with the standard T494 om-96 (1996) test using a test span of 3.5 inches and a jaw separation speed of 12 in/min.

The fine fiber layers described herein may have any suitable tensile strength. In some embodiments, a fine fiber layer has a tensile strength (normalized by basis weight) of greater than or equal to 15 gf/gsm, greater than or equal to 30 gf/gsm, greater than or equal to 50 gf/gsm, greater than or equal to 60 gf/gsm, greater than or equal to 70 gf/gsm, greater than or equal to 75 gf/gsm, greater than or equal to 80 gf/gsm, greater than or equal to 100 gf/gsm, greater than or equal to 125 gf/gsm, greater than or equal to 150 gf/gsm, greater than or equal to 200 gf/gsm, greater than or equal to 250 gf/gsm, greater than or equal to 300 gf/gsm, greater than or equal to 400 gf/gsm, greater than or equal to 500 gf/gsm, greater than or equal to 600 gf/gsm, greater than or equal to 700 gf/gsm, greater than or equal to 800 gf/gsm, or greater than or equal to 900 gf/gsm. In certain embodiments, a fine fiber layer has a tensile strength (normalized by basis weight) of less than or equal to 1000 gf/gsm, less than or equal to 900 gf/gsm, less than or equal to 800 gf/gsm, less than or equal to 700 gf/gsm, less than or equal to 600 gf/gsm, less than or equal to 500 gf/gsm, less than or equal to 400 gf/gsm, less than or equal to 300 gf/gsm, less than or equal to 250 gf/gsm, less than or equal to 200 gf/gsm, less than or equal to 150 gf/gsm, less than or equal to 125 gf/gsm, less than or equal to 100 gf/gsm, less than or equal to 80 gf/gsm, less than or equal to 70 gf/gsm, or less than or equal to 60 gf/gsm. Combinations of the above-referenced ranges are also possible (e.g., greater than or equal to 15 gf/gsm and less than or equal to 1000 gf/gsm, greater than or equal to 30 gf/gsm and less than or equal to 1000 gf/gsm, greater than or equal to 50 gf/gsm and less than or equal to 1000 gf/gsm, greater than or equal to 75 gf/gsm and less than or equal to 1000 gf/gsm, or greater than or equal to 80 gf/gsm and less than or equal to 150 gf/gsm). Other ranges are also possible.

When a filter media comprises two or more fine fiber layers, each fine fiber layer may independently have a tensile strength in one or more of the above-referenced ranges. In embodiments in which a filter media comprises two or more fine fiber layers, the tensile strengths of the two or more fine fiber layers may be the same or different.

The tensile strength of a fine fiber layer may be determined according to the procedure that follows. First, fine fibers may be deposited onto wax paper to form a fine fiber layer having a basis weight of 5 gsm. The fine fiber layer can then be removed from the wax paper and cut to form free-standing specimens having dimensions of 1 inch×7 inch. The tensile strength of these specimens may be determined on a Thwing-Albert tensile tester equipped with 20 N load cell. The gap between the jaws on the machine may be set at 3.5 inches, and the rate of extension employed may be 12 in/min. The tensile test data obtained under these conditions may then translated into stress-strain curves (e.g., using Winwedge-12-software). Average tensile strength may be calculated from the stress-strain curves from measurements performed on at least 10 different specimens.

The fine fiber layers described herein may have any suitable toughness (i.e., the amount of tensile energy absorbed by the fine fiber layer prior to breaking). In some embodiments, a fine fiber layer has a toughness of greater than or equal to 20 gsm, greater than or equal to 25 gsm, greater than or equal to 30 gsm, greater than or equal to 35 gsm, greater than or equal to 40 gsm, greater than or equal to 50 gsm, greater than or equal to 60 gsm, greater than or equal to 70 gsm, greater than or equal to 80 gsm, greater than or equal to 90 gsm, or greater than or equal to 100 gsm. In some embodiments, a fine fiber layer has a toughness of less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, or less than or equal to 35 gsm. Combinations of the above-referenced ranges are also possible (e.g., greater than or equal to 20 gsm and less than or equal to 120 gsm, greater than or equal to 25 gsm and less than or equal to 110 gsm, or greater than or equal to 40 gsm and less than or equal to 100 gsm). Other ranges are also possible.

When a filter media comprises two or more fine fiber layers, each fine fiber layer may independently have a toughness in one or more of the above-referenced ranges. In embodiments in which a filter media comprises two or more fine fiber layers, the toughnesses of the two or more fine fiber layers may be the same or different.

Toughness may be measured according to T494 om-96, wherein the toughness is the total area under the stress-strain curve.

In some embodiments, a fine fiber layer comprises fine fibers that are electrospun fibers. In such embodiments, the fine fibers may be electrospun from a solution comprising any suitable solvent (e.g., in a solution further comprising one or more polymers disclosed herein). Suitable solvents may include formic acid (FA), acetic acid, trifluoroacetic acid (TFAA), dichloromethane (DCM), 1,1,1,3,3,3-Hexafluoro-2-propanol (HFP), pentafluoropentanoic acid (PFPA), tetrahydrofuran (THF), dimethylacetamide, dimethylformamide, dioxolane, acetone, ethyl acetate, water, and/or an alcohol (e.g., ethanol, propanol, and/or isopropanol).

A solution from which a fine fiber layer is electrospun (e.g., comprising at least a solvent and a polymer from which the electrospun fibers are formed) may have any suitable conductivity. For example, in some cases, the polymeric solution has a conductivity of greater than or equal to 10 μS, greater than or equal to 25 μS, greater than or equal to 50 μS, greater than or equal to 75 μS, greater than or equal to 100 μS, greater than or equal to 120 μS, greater than or equal to 150 μS, greater than or equal to 200 μS, greater than or equal to 250 μS, greater than or equal to 300 μS, greater than or equal to 400 μS, greater than or equal to 500 μS, greater than or equal to 750 μS, greater than or equal to 1,000 μS, greater than or equal to 2,000 μS, greater than or equal to 3,000 μS, greater than or equal to 4,000 μS, or greater than or equal to 5,000 μS. In certain embodiments, the polymeric solution has a conductivity of less than or equal to 15,000 μS, less than or equal to 14,000 μS, less than or equal to 13,000 μS, less than or equal to 12,000 μS, less than or equal to 11,000 μS, less than or equal to 10,000 μS, less than or equal to 9,000 μS, less than or equal to 8,000 μS, less than or equal to 7,000 μS, less than or equal to 6,000 μS, less than or equal to 5,000 μS, less than or equal to 4,000 μS, less than or equal to 3,000 μS, less than or equal to 2,000 μS, less than or equal to 1,000 μS, less than or equal to 750 μS, less than or equal to 500 μS, less than or equal to 400 μS, less than or equal to 300 μS, less than or equal to 250 μS, less than or equal to 200 μS, less than or equal to 150 μS, less than or equal to 120 μS, or less than or equal to 100 μS. Combinations of the above-referenced ranges are also possible (e.g., greater than or equal to 10 μS and less than or equal to 10,000 μS, greater than or equal to 100 μS and less than or equal to 500 μS, or greater than or equal to 120 μS and less than or equal to 300 μS). The conductivity may be determined using a conductivity meter.

When the polymer or polymers are added to the solvent for electrospinning, the polymeric solution may have any suitable viscosity. For example, in some cases, the polymeric solution has a viscosity of greater than or equal to 10 millipascal-seconds, greater than or equal to 25 millipascal-seconds, greater than or equal to 50 millipascal-seconds, greater than or equal to 75 millipascal-seconds, greater than or equal to 100 millipascal-seconds, greater than or equal to 125 millipascal-seconds, greater than or equal to 150 millipascal-seconds, greater than or equal to 200 millipascal-seconds, greater than or equal to 250 millipascal-seconds, greater than or equal to 300 millipascal-seconds, greater than or equal to 400 millipascal-seconds, greater than or equal to 500 millipascal-seconds, greater than or equal to 750 millipascal-seconds, greater than or equal to 1000 millipascal-seconds, greater than or equal to 1250 millipascal-seconds, greater than or equal to 1500 millipascal-seconds, greater than or equal to 1750 millipascal-seconds, or greater than or equal to 2000 millipascal-seconds. In certain instances, the polymeric solution has a viscosity of less than or equal to 2500 millipascal-seconds, less than or equal to 2250 millipascal-seconds, less than or equal to 2000 millipascal-seconds, less than or equal to 1750 millipascal-seconds, less than or equal to 1500 millipascal-seconds, less than or equal to 1250 millipascal-seconds, less than or equal to 1000 millipascal-seconds, less than or equal to 750 millipascal-seconds, less than or equal to 500 millipascal-seconds, less than or equal to 400 millipascal-seconds, less than or equal to 300 millipascal-seconds, less than or equal to 250 millipascal-seconds, less than or equal to 200 millipascal-seconds, less than or equal to 150 millipascal-seconds, less than or equal to 125 millipascal-seconds, or less than or equal to 100 millipascal-seconds. Combinations of the above-referenced ranges are also possible (e.g., greater than or equal to 10 millipascal-seconds and less than or equal to 2500 millipascal-seconds, greater than or equal to 75 millipascal-seconds and less than or equal to 500 millipascal-seconds, or greater than or equal to 100 millipascal-seconds and less than or equal to 300 millipascal-seconds). Other ranges are also possible.

The viscosity of a polymeric solution may be determined by use of a rotational viscometer at a shear rate of 1.7 s⁻¹ and a temperature of 20° C. The viscosity may be determined from the rotational viscometer once the value displayed thereon has stabilized. One example of a suitable rotational viscometer is a Brookfield LVT viscometer having a No. 62 spindle.

In some embodiments, one or more of the layers in a filter media may be a prefilter layer. In some embodiments, a filter media comprises a prefilter layer that is a non-woven fiber web, such as a meltblown layer. That is, in some embodiments, a filter media comprises a prefilter layer formed by a meltblown process. It is also possible for a filter media to comprise a prefilter layer that is a non-meltblown layer. That is, in some embodiments, the prefilter layer may be formed by a process other than meltblowing process (e.g., electrospinning, solvent spinning, centrifugal spinning, etc.). Properties of pre-filter layers will be described in further detail below.

The prefilter layers described herein may comprise fibers having a variety of suitable average fiber diameters. In some embodiments, the average fiber diameter of the fibers in a prefilter layer is greater than or equal to 0.5 microns, greater than or equal to 0.6 microns, greater than or equal to 0.8 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 2.75 microns, greater than or equal to 3 microns, greater than or equal to 3.25 microns, greater than or equal to 3.5 microns, or greater than or equal to 3.75 microns. In some embodiments, the average fiber diameter of the fibers in a prefilter layer is less than or equal to 4 microns, less than or equal to 3.75 microns, less than or equal to 3.5 microns, less than or equal to 3.25 microns, less than or equal to 3 microns, less than or equal to 2.75 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, less than or equal to 0.8 microns, or less than or equal to 0.6 microns. Combinations of the above-referenced ranges are also possible (e.g., greater than or equal to 0.5 microns and less than or equal to 4 microns, greater than or equal to 1 micron and less than or equal to 3 microns, or greater than or equal to 1 micron and less than or equal to 2.5 microns). Other ranges are also possible.

When a prefilter layer comprises two or more types of fibers, each type of fiber may independently have an average fiber diameter in one or more of the ranges described above and/or all of the fibers in a prefilter layer may together have an average fiber diameter in one or more of the ranges described above. When a filter media comprises two or more prefilter layers, the preceding sentence may independently be true for each prefilter layer. In embodiments in which a filter media comprises two or more prefilter layers, the average fiber diameters of the two or more prefilter layers may be the same or different.

In some embodiments, a prefilter layer comprises synthetic fibers. For example, synthetic fibers may make up greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 92 wt. %, greater than or equal to 95 wt. %, greater than or equal to 98 wt. %, greater than or equal to 98.5 wt. %, greater than or equal to 99 wt. %, or greater than or equal to 99.5 wt. % of a prefilter layer. In some embodiments, synthetic fibers may make up less than or equal to 100 wt. %, less than or equal to 99.5 wt. %, less than or equal to 99 wt. %, less than or equal to 98.5 wt. %, less than or equal to 98 wt. %, less than or equal to 95 wt. %, less than or equal to 92 wt. %, less than or equal to 90 wt. %, less than or equal to 85 wt. %, less than or equal to 80 wt. %, less than or equal to 75 wt. %, less than or equal to 70 wt. %, or less than or equal to 65 wt. % of a prefilter layer. Combinations of the above-referenced ranges are also possible (e.g., greater than or equal to 60 wt. % and less than or equal to 100 wt. %, greater than or equal to 70 wt. % and less than or equal to 99 wt. %, or greater than or equal to 80 wt. % and less than or equal to 98 wt. %). Other ranges are also possible. In some embodiments, synthetic fibers make up 100 wt. % of all fibers within the prefilter layer (e.g., in a meltblown prefilter layer).

When a prefilter layer comprises two or more types of synthetic fibers, each type of synthetic fiber may independently make up an amount of the prefilter in one or more of the ranges described above and/or all of the synthetic fibers in a prefilter layer may together make up an amount in the prefilter layer in one or more of the ranges described above. When a filter media comprises two or more prefilter layers, the preceding sentence may independently be true for each prefilter layer. In embodiments in which a filter media comprises two or more prefilter layers, the amounts of synthetic fibers present in the two or more prefilter layers may be the same or different.

Synthetic fibers present in a prefilter layer may have any of variety of suitable average fiber diameters. In some embodiments, the average fiber diameter of the synthetic fibers in a prefilter layer is greater than or equal to 0.5 microns, greater than or equal to 0.6 microns, greater than or equal to 0.8 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 2.75 microns, greater than or equal to 3 microns, greater than or equal to 3.25 microns, greater than or equal to 3.5 microns, or greater than or equal to 3.75 microns. In some embodiments, the average fiber diameter of the synthetic fibers in a prefilter layer is less than or equal to 4 microns, less than or equal to 3.75 microns, less than or equal to 3.5 microns, less than or equal to 3.25 microns, less than or equal to 3 microns, less than or equal to 2.75 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, less than or equal to 0.8 microns, or less than or equal to 0.6 microns. Combinations of the above-referenced ranges are also possible (e.g., greater than or equal to 0.5 microns and less than or equal to 4 microns, greater than or equal to 1 micron and less than or equal to 3 microns, or greater than or equal to 1 micron and less than or equal to 2.5 microns). Other ranges are also possible.

When a prefilter layer comprises two or more types of synthetic fibers, each type of synthetic fiber may independently have an average fiber diameter in one or more of the ranges described above and/or all of the synthetic fibers in a prefilter layer may together have an average fiber diameter in one or more of the ranges described above. When a filter media comprises two or more prefilter layers, the preceding sentence may independently be true for each prefilter layer. In embodiments in which a filter media comprises two or more prefilter layers, the average fiber diameters of the synthetic fibers in the two or more prefilter layers may be the same or different.

In some instances, the synthetic fibers present in a prefilter layer may be continuous fibers, such as the types of continuous fibers described elsewhere herein as being suitable for inclusion in a fine fiber layer.

Non-limiting examples of suitable synthetic fibers include fibers comprising one or more of the following materials: poly(olefin)s (e.g., poly(propylene)), poly(ester)s (e.g., poly(butylene terephthalate), poly(ethylene terephthalate)), Nylons, poly(aramid)s (para and/or meta), poly(vinyl alcohol), poly(ether sulfone), poly(acrylic)s (e.g., poly(acrylonitrile)), fluorinated polymers (e.g., poly(vinylidene difluoride)), cellulose acetate, acrylics (dry-spun acrylic, mod-acrylic, wet-spun acrylic), polyvinyl chloride, polytetrafluoroethylene, polystyrene, polysulfone, polycarbonate, polyamide, polyurethane, phenolic polymers, polyvinylidene fluoride, polyethylene, polyimide, Kevlar, Nomex, halogenated polymers, polyphenylene oxide, polyphenylene sulfide, polymethyl pentene, polyether ether ketones, PET, liquid crystal polymers (e.g., poly p-phenylene-2,6-bezobisoxazole (PBO), polyester-based liquid crystal polymers such as polyesters produced by the polycondensation of 4-hydroxybenzoic acid and 6-hydroxynaphthalene-2-carboxylic acid), and combinations thereof.

Synthetic fibers may comprise monocomponent and/or multicomponent fibers (i.e., fibers having multiple compositions such as bicomponent fibers). In some cases, synthetic fibers may include meltblown, meltspun, electrospun (e.g., melt, solvent), or centrifugal spun fibers. It is also possible for synthetic fibers to comprise staple fibers.

In some embodiments, a prefilter layer comprises glass fibers (e.g., microglass fibers, chopped strand fibers, and/or combination thereof). Glass fibers (if present) may be present in a prefilter layer (e.g., a non-meltblown prefilter layer) in any suitable amount. In some embodiments, the wt. % of glass fibers in a prefilter layer may be greater than or equal to 0 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, or greater than or equal to 95 wt. %. In some embodiments, the wt. % of glass fibers in a prefilter layer may be less than or equal to 100 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, or less than or equal to 10 wt. %. Combinations of the above-referenced ranges are also possible (e.g., greater than or equal to 0 wt. % and less than or equal to 100 wt. %, or greater than or equal to 0 wt. % and less than or equal to 95 wt. %). Other ranges are also possible. In some embodiments in which the prefilter layer is a meltblown layer, the prefilter layer does not include glass fibers (e.g., glass fibers make up 0 wt. % of prefilter layer).

When a prefilter layer comprises two or more types of glass fibers, each type of glass fiber may independently make up an amount of the prefilter layer in one or more of the ranges described above and/or all of the glass fibers in a prefilter layer may together make up an amount of the prefilter layer in one or more of the ranges described above. When a filter media comprises two or more prefilter layers, the preceding sentence may independently be true for each prefilter layer.

In some embodiments, a prefilter layer comprises glass fibers having an average diameter of greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, or greater than or equal to 12.5 microns. In some embodiments, a prefilter layer comprises glass fibers having an average diameter of less than or equal to 40 microns, less than or equal to 35 microns, less than or equal to 30 microns, less than or equal to 25 microns, less than or equal to microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, or less than or equal to 0.2 microns. Combinations of the above-referenced ranges are also possible (e.g., greater than or equal to 0.1 microns and less than or equal to 40 microns, greater than or equal to 0.4 microns and less than or equal to 20 microns, greater than or equal to 0.15 microns and less than or equal to 15 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible.

When a prefilter layer comprises two or more types of glass fibers, each type of glass fiber may independently have an average diameter in one or more of the ranges described above and/or all of the glass fibers in a prefilter layer may have an average diameter in one or more of the ranges described above. In embodiments in which a filter media comprises two or more prefilter layers, the average fiber diameters of the glass fibers in the two or more prefilter layers may be the same or different.

In some embodiments, a prefilter comprises an additive, such as a charge-stabilizing additive. One example of a suitable class of charge-stabilizing additives is hindered amine light stabilizers. Without wishing to be bound by any particular theory, it is believed that hindered amine light stabilizers are capable accepting and stabilizing charged species (e.g., a positively charged species, such as a proton from water; a negatively charged species) thereon. One example of a suitable hindered amine light stabilizer is CHIMASSORB 944 FL. Further non-limiting examples of suitable charge-stabilizing additives include fused aromatic thioureas, organic triazines, UV stabilizers, phosphites, additives comprising two or more amide groups (e.g., bisamides, trisamides), stearates (e.g., magnesium stearate, calcium stearate), and stearamides (e.g., ethylene bis-stearamide). Charge-stabilizing additives may be incorporated into fibers and/or may be incorporated into the prefilter in another manner (e.g., as particles, as a coating on the fibers). One example of a manner in which charge-stabilizing additives may be incorporated into fibers is by forming a continuous fiber from a composition comprising the charge-stabilizing additive.

In some embodiments, a surface of a prefilter layer may be modified using additives (e.g., oleophobic additives). In some embodiments, a prefilter layer comprises an additive or additives (e.g., oleophobic additive(s)). For example, in some embodiments, a prefilter layer may be subjected to one or more surface treatments. For instance, chemical vapor deposition (CVD) (e.g., plasma enhanced CVD, audio frequency and/or radio frequency plasma enhanced CVD, microwave discharge CVD, atmospheric plasma discharge CVD, DC plasma discharge CVD) may be used to functionalize a surface thereof. As one example, a prefilter layer may be exposed to an oxygen plasma. This treatment may cause surface oxidation of the prefilter layer, may create functional groups such as alcohols and carboxylic acids at the surface of the prefilter layer, and/or may increase the hydrophilicity of the prefilter layer. As another example, one or more monomers (e.g., acrylic acid monomers such as hydroxyethylmethacrylate, fluorocarbon additives (e.g., fluorinated and/or perfluorinated monomers such as hexafluorobutanoic acid, CF₄, CHF₃, C₂F₆, C₃F₈, C₄F₈, C₂F₄, C₃F₆, C₄F₁₀, C₅F₁₀, C₅F₁₂, C₆F₁₂, C₆F₁₄, perfluorohexyl ethyl acrylate (C₉H₇F₁₃O₂), perfluorohexyl ethyl methacrylate (C₁₂H₉F₁₃O₂), allylpentafluorobenzene (C₉H₅F₅), pentafluorostyrene (C₈H₃F₅), and the like)) may be deposited onto the prefilter layer using CVD. In some embodiments, the monomers may be deposited in the presence of a carrier gas (e.g., an inert gas such as helium or argon). Depositing these monomers may affect the hydrophobicity of the surface of the prefilter layer (e.g., acrylic acid monomers may cause the surface to become more hydrophilic, fluorinated monomers may cause the surface to become more hydrophobic). In some embodiments, a CVD treatment may comprise exposing the prefilter layer to ammonia optionally accompanied by one or more inert gases (e.g., helium, argon). Other surface treatments (e.g., other CVD treatments) are also possible.

A prefilter layer described herein may have any suitable normalized surface area. In some embodiments, a prefilter layer has a normalized surface area of greater than or equal to 7 m²/m², greater than or equal to 8 m²/m², greater than or equal to 9 m²/m², greater than or equal to m²/m², greater than or equal to 12 m²/m², greater than or equal to 14 m²/m², greater than or equal to 15 m²/m², greater than or equal to 16 m²/m², greater than or equal to 18 m²/m², greater than or equal to 20 m²/m², greater than or equal to 22 m²/m², greater than or equal to 25 m²/m², greater than or equal to 30 m²/m², greater than or equal to 35 m²/m², greater than or equal to 40 m²/m², greater than or equal to 45 m²/m², greater than or equal to 50 m²/m², greater than or equal to 55 m²/m², greater than or equal to 60 m²/m², greater than or equal to 65 m²/m², greater than or equal to 70 m²/m², greater than or equal to 80 m²/m², greater than or equal to 90 m²/m², or greater than or equal to 100 m²/m². In some embodiments, a prefilter layer has a normalized surface area of less than or equal to 130 m²/m², less than or equal to 100 m²/m², less than or equal to 90 m²/m², less than or equal to 80 m²/m², less than or equal to 70 m²/m², less than or equal to 65 m²/m², less than or equal to 60 m²/m², less than or equal to 55 m²/m², less than or equal to 50 m²/m², less than or equal to 45 m²/m², less than or equal to 40 m²/m², less than or equal to 35 m²/m², less than or equal to 30 m²/m², less than or equal to 25 m²/m², less than or equal to 22 m²/m², less than or equal to 20 m²/m², less than or equal to 18 m²/m², less than or equal to 16 m²/m², less than or equal to 15 m²/m², less than or equal to 14 m²/m², less than or equal to 12 m²/m², less than or equal to 10 m²/m², less than or equal to 9 m²/m², or less than or equal to 8 m²/m². Combinations of the above-referenced ranges are also possible (e.g., greater than or equal to 7 m²/m² and less than or equal to 130 m²/m², greater than or equal to 10 m²/m² and less than or equal to 100 m²/m², greater than 10 m²/m² and less than or equal to 100 m²/m², greater than or equal to 15 m²/m² and less than or equal to 70 m²/m², greater than 15 m²/m² and less than or equal to 70 m²/m², or greater than or equal to 20 m²/m² and less than or equal to 60 m²/m²). Other ranges are also possible.

When a filter media comprises two or more prefilter layers, each prefilter layer may independently have a normalized surface area in one or more of the above-referenced ranges. In embodiments in which a filter media comprises two or more prefilter layers, the normalized surface areas of the two or more prefilter layers may be the same or different.

Normalized surface area, as used herein, refers to a ratio of the total fiber surface area associated with the plurality of fibers within a layer to a surface area of the layer (i.e., the area that the layer would spatially cover of a substrate positioned therebeneath if disposed on such a substrate). The total fiber surface area associated with the plurality of fibers includes fiber surface area internal to the layer, such as the surface area of fibers that are present in the interior of the layer. FIG. 2 can be used to illustrate the concept of a normalized surface area. For example, as shown in FIG. 2, a second layer 104 may comprise a plurality of fibers disposed therein and a surface 104A. A normalized surface area of the second layer 104 may correspond to the ratio of the total fiber surface area associated with the plurality of fibers within the second layer 104 to the surface area that the layer surface 104A physically covers on the first layer 102.

The normalized surface area of a layer may be determined by determining the average fiber diameter, determining the density of the materials forming the fibers in the layer, determining the basis weight of the layer, and then applying the following formula: normalized surface area=[basis weight/(polymer density·fiber diameter·π/4)]. The density of the materials forming the fibers in the layer may be determined as described elsewhere herein with respect to the method of determining the porosity of a layer. The basis weight may be measured according to ASTM D3776M-20 (2020). It should be noted that the method described above is one non-limiting example of a method for determining the normalized surface area of a layer, and that other methods may also be employed to determine the normalized surface area of a layer.

The prefilter layers described herein may have any of a variety of suitable porosities (i.e., void volumes). In some embodiments, a prefilter layer has a porosity of greater than or equal to 80%, greater than or equal to 82%, greater than or equal to 84%, greater than or equal to 85%, greater than or equal to 86%, greater than or equal to 88%, greater than or equal to 90%, greater than or equal to 92%, greater than or equal to 94%, greater than or equal to 95%, or greater than or equal to 96%. In some embodiments, a prefilter layer has a porosity of less than or equal to 99%, less than or equal to 96%, less than or equal to 95%, less than or equal to 94%, less than or equal to 92%, less than or equal to 90%, less than or equal to 88%, less than or equal to 86%, less than or equal to 85%, less than or equal to 84%, or less than or equal to 82%. Combinations of the above-referenced ranges are also possible (e.g., greater than or equal to 80% and less than or equal to 99%, greater than or equal to 85% and less than or equal to 96%, or greater than or equal to 90% and less than or equal to 95%). Other ranges are also possible.

When a filter media comprises two or more prefilter layers, each prefilter layer may independently have a porosity in one or more of the above-referenced ranges. In embodiments in which a filter media comprises two or more prefilter layers, the porosities of the two or more prefilter layers may be the same or different.

The porosity of a prefilter layer may be determined as described elsewhere herein with respect to the determination of the porosity of a main filter layer (e.g., a fine fiber layer).

The prefilter layers described herein may have any of a variety of suitable average pore sizes. In some embodiments, a prefilter layer has an average pore size of greater than or equal to 1 micron, greater than or equal to 2 microns, greater than or equal to 3 microns, greater than or equal to 5 microns, greater than or equal to 7 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, a prefilter layer has an average pore size of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7 microns, less than or equal to 5 microns, less than or equal to 3 microns, or less than or equal to 2 microns. Combinations of the above-referenced ranges are also possible (e.g., greater than or equal to 1 micron and less than or equal to 50 microns, greater than or equal to 2 microns and less than or equal to 30 microns, or greater than or equal to 5 microns and less than or equal to 20 microns). Other ranges are also possible.

When a filter media comprises two or more prefilter layers, each prefilter layer may independently have an average pore size in one or more of the above-referenced ranges. In embodiments in which a filter media comprises two or more prefilter layers, the average pore sizes of the two or more prefilter layers may be the same or different.

The average pore size may be measured using ASTM F316 (2003).

The prefilter layers described herein may have any of a variety of suitable thicknesses. In some embodiments, a prefilter layer has a thickness of greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.8 mm, greater than or equal to 1 mm, greater than or equal to 1.2 mm, greater than or equal to 1.4 mm, greater than or equal to 1.6 mm, or greater than or equal to 1.8 mm. In some embodiments, a prefilter layer has a thickness of less than or equal to 2 mm, less than or equal to 1.8 mm, less than or equal to 1.6 mm, less than or equal to 1.4 mm, less than or equal to 1.2 mm, less than or equal to 1 mm, less than or equal to 0.8 mm, less than or equal to 0.6 mm, less than or equal to 0.5 mm, less than or equal to 0.4 mm, less than or equal to 0.3 mm, or less than or equal to 0.2 mm. Combinations of the above-referenced ranges are also possible (e.g., greater than or equal to 0.1 mm and less than or equal to 2 mm, greater than or equal to 0.3 mm and less than or equal to 1.6 mm, or greater than or equal to 0.5 mm and less than or equal to 1.4 mm). Other ranges are also possible.

When a filter media comprises two or more prefilter layers, each prefilter layer may independently have a thickness in one or more of the above-referenced ranges. In embodiments in which a filter media comprises two or more prefilter layers, the thicknesses of the two or more prefilter layers may be the same or different.

The thickness of a prefilter layer may be determined in accordance with ASTM D1777 (2015) under an applied pressure of 0.8 kPa.

The prefilter layer described herein may have any of a variety of suitable basis weights. For example, in some embodiments, a prefilter layer has a basis weight of greater than or equal to 5 gsm, greater than or equal to 7.5 gsm, greater than or equal to 10 gsm, greater than or equal to 12.5 gsm, greater than or equal to 15 gsm, greater than or equal to 17.5 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, or greater than or equal to 90 gsm. In some embodiments, a prefilter layer has a basis weight of less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, less than or equal to 17.5 gsm, less than or equal to 15 gsm, less than or equal to 12.5 gsm, less than or equal to 10 gsm, or less than or equal to 7.5 gsm. Combinations of the above-referenced ranges are also possible (e.g., greater than or equal to 5 gsm and less than or equal to 100 gsm, greater than or equal to 15 gsm and less than or equal to 80 gsm, or greater than or equal to 20 gsm and less than or equal to 70 gsm). Other ranges are also possible.

When a filter media comprises two or more prefilter layers, each prefilter layer may independently have a basis weight in one or more of the above-referenced ranges. In embodiments in which a filter media comprises two or more prefilter layers, the basis weights of the two or more prefilter layers may be the same or different.

Basis weight may be measured according to ASTM D3776M-20 (2020).

The prefilter layers described herein may have any of a variety of suitable air permeabilities. In some embodiments, a prefilter layer has an air permeability of greater than or equal to 5 CFM, greater than or equal to 7 CFM, greater than or equal to 10 CFM, greater than or equal to 12 CFM, greater than or equal to 15 CFM, greater than or equal to 20 CFM, greater than or equal to 25 CFM, greater than or equal to 30 CFM, greater than or equal to 35 CFM, greater than or equal to 40 CFM, greater than or equal to 45 CFM, greater than or equal to 50 CFM, greater than or equal to 55 CFM, greater than or equal to 60 CFM, or greater than or equal to 65 CFM. In some embodiments, a prefilter layer has an air permeability of less than or equal to 70 CFM, less than or equal to 65 CFM, less than or equal to 60 CFM, less than or equal to 55 CFM, less than or equal to 50 CFM, less than or equal to 45 CFM, less than or equal to 40 CFM, less than or equal to 35 CFM, less than or equal to 30 CFM, less than or equal to 25 CFM, less than or equal to 20 CFM, less than or equal to 15 CFM, less than or equal to 12 CFM, less than or equal to 10 CFM, or less than or equal to 7 CFM. Combinations of the above-referenced ranges are also possible (e.g., greater than or equal to 5 CFM and less than or equal to 70 CFM, greater than or equal to 5 CFM and less than or equal to 50 CFM, or greater than or equal to 10 CFM and less than or equal to 40 CFM). Other ranges are also possible.

When a filter media comprises two or more prefilter layers, each prefilter layer may independently have an air permeability in one or more of the above-referenced ranges. In embodiments in which a filter media comprises two or more prefilter layers, the air permeabilities of the two or more prefilter layers may be the same or different.

Air permeability may be measured according to ASTM D737-04 (2016) at a pressure of 125 Pa.

The prefilter layers described herein may have any suitable efficiency (e.g., efficiency prior to isopropyl alcohol (IPA) vapor exposure). In some embodiments, a prefilter layer has an efficiency (e.g., efficiency prior to IPA vapor exposure) of greater than or equal to 95%, greater than or equal to 96%, greater than or equal to 97%, greater than or equal to 98%, greater than or equal to 98.5%, greater than or equal to 99%, greater than or equal to 99.5%, greater than or equal to 99.7%, greater than or equal to 99.9%, greater than or equal to 99.95%, greater than or equal to 99.99%, greater than or equal to 99.995%, greater than or equal to 99.999%, greater than or equal to 99.9995%, greater than or equal to 99.9999%, or great than or equal to 99.99995%. In some embodiments, a prefilter layer has an efficiency (e.g., efficiency prior to IPA vapor exposure) of less than 100%, less than or equal to 99.99995%, less than or equal to 99.9999%, less than or equal to 99.9995%, less than or equal to 99.999%, less than or equal to 99.995%, less than or equal to 99.99%, less than or equal to 99.95%, less than or equal to 99.9%, less than or equal to 99.7%, less than or equal to 99.5%, less than or equal to 99%, less than or equal to 98.5%, less than or equal to 98%, less than or equal to 97%, or less than or equal to 96%. Combinations of the above-referenced ranges are also possible (e.g., greater than or equal to 95% and less than 99.99995%, greater than or equal to 98% and less than or equal to 99.9995%, or greater than or equal to 99% and less than or equal to 99.995%). Other ranges are also possible.

When a filter media comprises two or more prefilter layers, each prefilter layer may independently have an efficiency (e.g., efficiency prior to IPA vapor exposure) in one or more of the above-referenced ranges. In embodiments in which a filter media comprises two or more prefilter layers, the efficiencies of the two or more prefilter layers may be the same or different. In some embodiments, the efficiencies described in the preceding paragraph are efficiencies at the most penetrating particle size (MPPS). Efficiency at the MPPS is the value of efficiency measured for the particle with the highest penetration. In some embodiments, the efficiencies described in the preceding paragraph are efficiencies at 0.09 microns. Efficiency at 0.09 microns is the value of efficiency measured for particles having an average diameter of 0.09 microns. In some embodiments, the efficiencies in the preceding paragraph are efficiencies at 0.3 microns. Efficiency at 0.3 microns is the value of efficiency measured for particles having an average diameter of 0.3 microns.

Efficiency of a layer may be determined by the following equation: Efficiency (%)=100−penetration (%). Penetration of a layer may be determined as follows: % Penetration=C/C₀*100, where C is the concentration of particles measured after passage through the layer and C₀ is the concentration of particles measured before passage through the layer. Penetration may be measured at the relevant particle size for the type of efficiency described (e.g., MPPS, 0.09 microns, or 0.3 microns). Penetration can be measured for any particle size using the EN1822:2009 standard for air filtration, which is described below.

Penetration may be measured by blowing dioctyl phthalate (DOP) particles through a layer and measuring the percentage of particles that penetrate through and the pressure drop as the particles are blown through the layer.

This may be accomplished by use of a TSI 3160 automated filter testing unit from TSI, Inc. equipped with a dioctyl phthalate generator for DOP aerosol testing based on the EN1822:2009 standard for MPPS DOP particles. When determining efficiency at the MPPS, the TSI 3160 automated filter testing unit is employed to sequentially blow populations of DOP particles with varying average particle diameters at a 100 cm² face area of the upstream face of the layer. The populations of particles are blown at the upstream face of the layer (or filter media) in order of increasing average diameter, where each population of particles has a geometric standard deviation of less than 1.3, and the populations of particles have the following set of average diameters: 0.04 microns, 0.08 microns, 0.12 microns, 0.16 microns, 0.2 microns, 0.26 microns, and 0.3 microns. The penetration may be measured continuously and separately for each population of particles over the period of time during which that population of particles is blown at the upstream face of the layer.

When determining efficiency at 0.09 microns, the TSI 3160 automated filter testing unit is employed to blow DOP particles having a 0.09 micron particle diameter through a 100 cm² face area of the upstream face of the layer.

During both types of penetration measurements, the upstream and downstream particle concentrations may be measured by use of condensation particle counters. During both types of penetration measurements, the 100 cm² face area of the upstream face of the layer may be subjected to a continuous loading of DOP particles at an airflow of 12 L/min, giving a media face velocity of 2 cm/s. Each population of particles may be blown at the upstream face of the layer for up to 480 s or until at least 1000 particles are counted downstream of the layer, whichever is shorter.

Efficiency at 0.3 microns may be determined in the same manner as efficiency at the MPPS and at 0.09 microns, except that it may be performed at a face velocity of 5.3 cm/s and a TSI 8130 may be employed to make the measurement.

The prefilter layers described herein may have any suitable efficiency metric (e.g., efficiency metric prior to IPA vapor exposure). In some embodiments, a prefilter layer has an efficiency metric (e.g., efficiency metric prior to IPA vapor exposure) of greater than or equal to 2.5, greater than or equal to 2.6, greater than or equal to 2.8, greater than or equal to 3, greater than or equal to 3.2, greater than or equal to 3.4, greater than or equal to 3.5, greater than or equal to 3.6, greater than or equal to 3.8, greater than or equal to 4, greater than or equal to 4.2, greater than or equal to 4.5, greater than or equal to 4.7, greater than or equal to 5, greater than or equal to 5.2, greater than or equal to 5.5, or greater than or equal to 5.7. In some embodiments, a prefilter layer has an efficiency metric (e.g., efficiency metric prior to IPA vapor exposure) of less than or equal to 6, less than or equal to 5.7, less than or equal to 5.5, less than or equal to 5.2, less than or equal to 5, less than or equal to 4.7, less than or equal to 4.5, less than or equal to 4.2, less than or equal to 4, less than or equal to 3.8, less than or equal to 3.6, less than or equal to 3.5, less than or equal to 3.4, less than or equal to 3.2, less than or equal to 3, less than or equal to 2.8, or less than or equal to 2.6. Combinations of the above-referenced ranges are also possible (e.g., greater than or equal to 2.5 and less than or equal to 6, greater than 2.5 and less than or equal to 6, greater than or equal to 3 and less than or equal to 5.5, or greater than or equal to 3.5 and less than or equal to 5). Other ranges are also possible.

When a filter media comprises two or more prefilter layers, each prefilter layer may independently have an efficiency metric (e.g., efficiency metric prior to IPA vapor exposure) in one or more of the above-referenced ranges. In embodiments in which a filter media comprises two or more prefilter layers, the efficiency metrics of the two or more prefilter layers may be the same or different.

An efficiency metric (e.g., efficiency metric prior to IPA vapor exposure) may be determined by the following equation: efficiency metric (EM)=−log (% penetration(DOP)/100). Penetration (%) may be determined as described elsewhere herein with respect to the determination of efficiency of the prefilter layer using DOP particles having an average diameter of 0.09 microns. The penetration may be determined prior to IPA vapor exposure.

The prefilter layers described herein may have any suitable pressure drop (e.g., average pressure drop). In some cases, the prefilter layer described herein may have a relatively low pressure drop. In some embodiments, a prefilter layer has a pressure drop of greater than or equal to 0.001 kPa, greater than or equal to 0.002 kPa, greater than or equal to 0.003 kPa, greater than or equal to 0.005 kPa, greater than or equal to 0.007 kPa, greater than or equal to 0.01 kPa, greater than or equal to 0.02 kPa, greater than or equal to 0.03 kPa, greater than or equal to 0.035 kPa, greater than or equal to 0.04 kPa, greater than or equal to 0.05 kPa, greater than or equal to 0.06 kPa, or greater than or equal to 0.07 kPa. In some embodiments, a prefilter layer has a pressure drop of less than or equal to 0.08 kPa, less than or equal to 0.07 kPa, less than or equal to 0.06 kPa, less than or equal to 0.05 kPa, less than or equal to 0.04 kPa, less than or equal to 0.035 kPa, less than or equal to 0.03 kPa, less than or equal to 0.02 kPa, less than or equal to 0.01 kPa, less than or equal to 0.007 kPa, less than or equal to 0.005 kPa, less than or equal to 0.003 kPa, or less than or equal to 0.002 kPa. Combinations of the above-referenced ranges are also possible (e.g., greater than or equal to 0.001 kPa and less than or equal to 0.08 kPa, greater than or equal to 0.005 kPa and less than or equal to 0.04 kPa, or greater than or equal to 0.01 kPa and less than or equal to 0.03 kPa). Other ranges are also possible.

When a filter media comprises two or more prefilter layers, each prefilter layer may independently have a pressure drop in one or more of the above-referenced ranges. In embodiments in which a filter media comprises two or more prefilter layers, the pressure drops of the two or more prefilter layers may be the same or different.

The pressure drop of a prefilter layer may be determined concurrently with the efficiency of a prefilter layer using DOP particles having an average diameter of 0.09 microns by the method for determining the efficiency of a prefilter layer described elsewhere herein. In some embodiments, the pressure drop is an average pressure drop measured over the same period of time as the efficiency of a prefilter layer using DOP particles having an average diameter of 0.09 microns described elsewhere herein. Specifically, when determining pressure drop at 0.09 microns, a TSI 3160 automated filter testing unit is employed to blow DOP particles having a 0.09 micron particle diameter through a 100 cm² face area of the upstream face of the layer. The particles may be blown at the upstream face of the layer for up to 480 s or until at least 1000 particles are counted downstream of the layer, whichever is shorter. Pressure drop may be measured continuously for the population of particles over the period of time during which the population of particles is blown across the prefilter layer and an average of the pressure drop over the period of time may be calculated.

The prefilter layers described herein may have any suitable ratio of initial efficiency metric (prior to IPA vapor exposure) to mechanical (discharged) efficiency metric. In some embodiments, a prefilter layer has a ratio of initial efficiency metric to mechanical (discharged) efficiency metric of greater than or equal to 2, greater than or equal to 2.2, greater than or equal to 2.4, greater than or equal to 2.6, greater than or equal to 2.8, greater than or equal to 3, greater than or equal to 3.2, greater than or equal to 3.5, greater than or equal to 3.7, greater than or equal to 4, greater than or equal to 4.2, greater than or equal to 4.5, or greater than or equal to 4.7. In some embodiments, a prefilter layer has a ratio of initial efficiency metric to mechanical (discharged) efficiency metric of less than or equal to 5, less than or equal to 4.7, less than or equal to 4.5, less than or equal to 4.2, less than or equal to 4, less than or equal to 3.7, less than or equal to 3.5, less than or equal to 3.2, less than or equal to 3, less than or equal to 2.8, less than or equal to 2.6, less than or equal to 2.4, or less than or equal to 2.2. Combinations of the above-referenced ranges are also possible (e.g., greater than or equal to 2 and less than or equal to 5, greater than or equal to 2 and less than or equal to 4, or greater than or equal to 2 and less than or equal to 3). Other ranges are also possible.

When a filter media comprises two or more prefilter layers, each prefilter layer may independently have a ratio of initial efficiency metric to mechanical (discharged) efficiency metric in one or more of the above-referenced ranges. In embodiments in which a filter media comprises two or more prefilter layers, the ratios of initial efficiency metric to mechanical (discharged) efficiency metric of the two or more prefilter layers may be the same or different.

The efficiency metric (e.g., initial efficiency metric) of a prefilter layer may be determined as described elsewhere herein. The mechanical (discharged) efficiency metric may be characterized as an efficiency metric (EM) measured after subjecting a layer to an IPA vapor discharge process. This efficiency metric may be determined by the same equation described elsewhere herein for determining the efficiency of a prefilter layer (i.e., −log (% penetration(DOP)/100), where the penetration is determined as described elsewhere herein with respect to the determination of efficiency of the prefilter layer using DOP particles having an average diameter of 0.09 microns).

A prefilter layer may be exposed to isopropyl alcohol vapor in accordance with the ISO 16890-4 (2016) standard on a 6 in by 6 in sample. A layer to be tested may be cut into a 6 in by 6 in square and placed on a shelf of a metal rack. Then, the metal rack and the layer may be placed over a container comprising at least 250 mL of 99.9 wt. % isopropyl alcohol. After this step, the metal rack, layer, and container may be placed inside a 24 in by 18 in by 11 in chamber. A second container comprising 250 mL of 99.9 wt. % isopropyl alcohol may then be placed in the container over the top shelf of the metal rack, and the lid of the chamber may be closed and tightly sealed. This setup may be maintained at 70° F. and 50% relative humidity for at least 14 hours, after which the layer may be removed and allowed to dry for one hour at room temperature. Then, the layer properties characterized as being those after undergoing an isopropyl alcohol vapor discharge process, including the layer's efficiency metric (EM), may be measured as described elsewhere herein.

As noted above, in some embodiments, a surface of a prefilter layer may be modified using additives (e.g., oleophobic additives, fluorocarbon additives) described elsewhere herein. Such prefilter layers may be oleophobic and/or may have an oil rank of greater than or equal to 1. In some embodiments, a prefilter layer has an oil rank of greater than or equal to 1, greater than 1, greater than or equal to 1.5, greater than or equal to 2, greater than or equal to 3, greater than or equal to 4, greater than or equal to 4.5, greater than or equal to 5, greater than or equal to 5.5, greater than or equal to 6, greater than or equal to 6.5, greater than or equal to 7, or greater than or equal to 7.5. In some embodiments, a prefilter layer has an oil rank of less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3, less than or equal to 2, or less than or equal to 1.5. Combinations of the above-referenced ranges are also possible (e.g., greater than or equal to 1 and less than or equal to 8, greater than 1 and less than or equal to 8, greater than or equal to 1 and less than or equal to 5, or greater than or equal to 1 and less than or equal to 4). Other ranges are also possible.

When a filter media comprises two or more prefilter layers, each prefilter layer may independently have an oil rank in one or more of the above-referenced ranges. In embodiments in which a filter media comprises two or more prefilter layers, the oil ranks of the two or more prefilter layers may be the same or different.

The oil rank of a layer may be determined according to AATCC TM 118 (2020) measured at 23° C. and 50% relative humidity (RH). Briefly, 5 drops of each test oil (having an average droplet diameter of about 2 mm) may be placed on five different locations on the surface of the layer. The test oil with the greatest oil surface tension that does not wet the surface of the layer (e.g., has a contact angle greater than or equal to 90° with the surface) after 30 seconds of contact with the layer at 23° C. and 50% RH, corresponds to the oil rank (listed in Table 4). For example, if a test oil with a surface tension of 26.6 mN/m does not wet the surface of the layer (i.e., has a contact angle of greater than or equal to 90 degrees with the surface) after 30 seconds, but a test oil with a surface tension of 25.4 mN/m wets the surface of the layer within thirty seconds, the layer has an oil rank of 4. By way of another example, if a test oil with a surface tension of 25.4 mN/m does not wet the surface of the layer after 30 seconds, but a test oil with a surface tension of 23.8 mN/m wets the surface of the layer within thirty seconds, the layer has an oil rank of 5. By way of yet another example, if a test oil with a surface tension of 23.8 mN/m does not wet the surface of the layer after 30 seconds, but a test oil with a surface tension of 21.6 mN/m wets the surface of the layer within thirty seconds, the layer has an oil rank of 6. In some embodiments, if three of more of the five drops partially wet the surface (e.g., forms a droplet, but not a well-rounded drop on the surface) in a given test, then the oil rank is expressed to the nearest 0.5 value determined by subtracting 0.5 from the number of the test liquid. By way of example, if a test oil with a surface tension of 25.4 mN/m does not wet the surface of the layer after 30 seconds, but a test oil with a surface tension of 23.8 mN/m only partially wets the surface of the layer after 30 seconds (e.g., three or more of the test droplets form droplets on the surface of the layer that are not well-rounded droplets) within thirty seconds, the layer has an oil rank of 5.5.

TABLE 4

| | | Surface |
|---|---|---|
| Oil | | Tension |
| Rank | Test Oil | (mN/m) |
| 1 | Kaydol | 31 |
| | (mineral oil) | |
| 2 | 65/35 Kaydol/ | 28 |
| | n-hexadecane | |
| 3 | n-hexadecane | 27.5 |
| 4 | n-tetradecane | 26.6 |
| 5 | n-dodecane | 25.4 |
| 6 | n-decane | 23.8 |
| 7 | n-octane | 21.6 |
| 8 | n-heptane | 20.1 |

In some embodiments, the filter media described herein comprises a charged prefilter layer. In some embodiments, the charged prefilter layer may be a charged meltblown layer. When present, a charged meltblown layer may comprise synthetic fibers, such as synthetic fibers having an average fiber diameter in one or more of the ranges described elsewhere herein for such fibers (e.g., greater than or equal to 0.5 microns and less than or equal to 4 microns, greater than or equal to 1 micron and less than or equal to 3 microns, or greater than or equal to 1 micron and less than or equal to 2.5 microns). A charged prefilter layer may be formed via any of a variety of suitable methods and/or steps described herein, such as electrostatic charging, triboelectric charging, and/or hydrocharging.

In some such embodiments, one or more charge additives may be present in the prefilter layer when the prefilter layer undergoes the charging process. The presence of a charge additive(s) during a charging process may be beneficial. As one example, the presence of such charge additives during a hydrocharging process may advantageously facilitate hydroentanglement of fibers and/or lead to a more efficient hydrocharging process. In some embodiments, hydroentanglement of fibers may advantageously impart a prefilter layer with a relatively low pressure drop.

In some embodiments, a prefilter layer may be subjected to one or more surface treatments prior to being charged. Any of a variety of surface treatments process (e.g., chemical vapor deposition) may be employed and/or any of a variety of surface-modifiers (e.g., fluorinated monomers, fluorocarbon additives) may be introduced to the prefilter layer prior to charging. For example, in one set of embodiments, a prefilter may be treated with a fluorocarbon coating. Such a fluorocarbon coating may advantageously impart the prefilter layer an oil rank of greater than 1 and/or cause the prefilter layer to be oleophobic.

In some embodiments, a prefilter layer is charged by a hydrocharging process. A hydrocharging process may comprise impinging jets and/or streams of water droplets onto an initially uncharged layer to cause it to become charged electrostatically. At the conclusion of the hydrocharging process, the layer may have an electret charge. The jets and/or streams of water droplets may impinge on the layer at a variety of suitable pressures, such as a pressure of between 10 to 1000 psi, and may be provided by a variety of suitable sources, such as a sprayer.

In some embodiments, a pressure of greater than or equal to 10 psi, greater than or equal to 50 psi, greater than or equal to 100 psi, greater than or equal to 200 psi, greater than or equal to 300 psi, greater than or equal to 400 psi, greater than or equal to 500 psi, greater than or equal to 600 psi, greater than or equal to 700 psi, greater than or equal to 800 psi, or greater than or equal to 900 psi may be employed during a hydrocharging process. In some embodiments, a pressure of less than or equal to 1000 psi, less than or equal to 900 psi, less than or equal to 800 psi, less than or equal to 700 psi, less than or equal to 600 psi, less than or equal to 500 psi, less than or equal to 400 psi, less than or equal to 300 psi, less than or equal to 200 psi, less than or equal to 100 psi, or less than or equal to 50 psi may be employed during a hydrocharging process. Combinations of the above-referenced ranges are also possible (e.g., greater than or equal to 10 psi and less than or equal to 1000 psi, greater than or equal to 100 psi and less than or equal to 500 psi, or greater than or equal to 200 psi and less than or equal to 400 psi). Other ranges are also possible.

In some embodiments, a layer is hydrocharged by using an apparatus that may be employed for the hydroentanglement of fibers which is operated at a lower pressure than is typical for the hydroentangling process. The water impinging on the layer may be relatively pure; for instance, it may be distilled water and/or deionized water. After electrostatic charging in this manner, the layer may be dried, such as with air dryer.

In some embodiments, a layer is hydrocharged while being moved laterally. The layer may be transported on a porous belt, such as a screen or mesh-type conveyor belt. As it is being transported on the porous belt, it may be exposed to a spray and/or jets of water pressurized by a pump. The water jets and/or spray may impinge on the layer and/or penetrate therein. In some embodiments, a vacuum is provided beneath the porous transport belt, which may aid the passage of water through the layer and/or reduce the amount of time and energy necessary for drying the layer at the conclusion of the hydrocharging process.

In some embodiments, a hydrocharging apparatus may include a plurality of nozzles configured to spray jets of pressurized water at a layer described herein. The nozzles may be present in any suitable number density in the apparatus and/or have any suitable diameter. In some embodiments, the nozzles may be present in a hydrocharging apparatus in a nozzle number density of greater than or equal to 10 nozzles per inch, greater than or equal to 15 nozzles per inch, greater than or equal to 20 nozzles per inch, greater than or equal to 25 nozzles per inch, greater than or equal to 30 nozzles per inch, greater than or equal to 35 nozzles per inch, greater than or equal to 40 nozzles per inch, greater than or equal to 45 nozzles per inch, greater than or equal to 50 nozzles per inch, greater than or equal to 55 nozzles per inch, greater than or equal to 60 nozzles per inch, greater than or equal to 70 nozzles per inch, greater than or equal to 80 nozzles per inch, greater than or equal to 90 nozzles per inch, greater than or equal to 100 nozzles per inch, greater than or equal to 110 nozzles per inch, greater than or equal to 120 nozzles per inch, greater than or equal to 130 nozzles per inch, greater than or equal to 140 nozzles per inch, greater than or equal to 150 nozzles per inch, greater than or equal to 160 nozzles per inch, greater than or equal to 170 nozzles per inch, greater than or equal to 180 nozzles per inch, or greater than or equal to 190 nozzles per inch. In some embodiments, the nozzles may be present in a hydrocharging apparatus in a nozzle number density of less than or equal to 200 nozzles per inch, less than or equal to 190 nozzles per inch, less than or equal to 180 nozzles per inch, less than or equal to 170 nozzles per inch, less than or equal to 160 nozzles per inch, less than or equal to 150 nozzles per inch, less than or equal to 140 nozzles per inch, less than or equal to 130 nozzles per inch, less than or equal to 120 nozzles per inch, less than or equal to 110 nozzles per inch, less than or equal to 100 nozzles per inch, less than or equal to 90 nozzles per inch, less than or equal to 80 nozzles per inch, less than or equal to 70 nozzles per inch, less than or equal to 60 nozzles per inch, less than or equal to 55 nozzles per inch, less than or equal to 50 nozzles per inch, less than or equal to 45 nozzles per inch, less than or equal to 40 nozzles per inch, less than or equal to 35 nozzles per inch, less than or equal to 30 nozzles per inch, less than or equal to 25 nozzles per inch, less than or equal to 20 nozzles per inch, or less than or equal to 15 nozzles per inch. Combinations of the above-referenced ranges are also possible (e.g., greater than or equal to 10 nozzles per inch and less than or equal to 200 nozzles per inch). Other ranges are also possible.

In some embodiments, a nozzle may have a nozzle diameter of greater than or equal to 50 microns, greater than or equal to 60 microns, greater than or equal to 70 microns, greater than or equal to 80 microns, greater than or equal to 90 microns, greater than or equal to 100 microns, greater than or equal to 120 microns, greater than or equal to 140 microns, greater than or equal to 160 microns, greater than or equal to 180 microns, greater than or equal to 200 microns, greater than or equal to 220 microns, greater than or equal to 240 microns, greater than or equal to 260 microns, or greater than or equal to 280 microns. In some embodiments, a nozzle may have a nozzle diameter of less than or equal to 300 microns, less than or equal to 280 microns, less than or equal to 260 microns, less than or equal to 240 microns, less than or equal to 220 microns, less than or equal to 200 microns, less than or equal to 180 microns, less than or equal to 160 microns, less than or equal to 140 microns, less than or equal to 120 microns, less than or equal to 100 microns, less than or equal to 90 microns, less than or equal to 80 microns, less than or equal to 70 microns, or less than or equal to 60 microns. Combinations of the above-referenced ranges are also possible (e.g., greater than or equal to 50 microns and less than or equal to 300 microns). Other ranges are also possible.

In some embodiments, each of the plurality of nozzles in the hydrocharging apparatus may independently have a diameter in one or more ranges described above. In some embodiments, the diameters of two or more of the plurality of nozzles may be the same or different.

In some embodiments, a prefilter layer is charged via a triboelectric charging process. A triboelectric charging process may comprise bringing into contact and then separating two surfaces, at least one of which is a surface at which fibers to be charged are positioned. This process may cause the transfer of charge between the two surfaces and the associated buildup of charge on the two surfaces. The surfaces may be selected such that they have sufficiently different positions in the triboelectric series to result in a desirable level of charge transfer therebetween upon contact.

As described above, in some embodiments, one or more of the layers of the filter media described herein may be support layers. A support layer may be used to support one or more other layers of the filter media, such as a main filter layer and/or a prefilter layer. In some cases, a support layer may be used to protect and/or cover one or more other layers of the media, such as a main filter layer and/or a prefilter layer. As described above, in some embodiments, a filter media may comprise a single support layer (e.g., a single support layer adjacent to a main filter layer on a side opposite a prefilter layer). In some embodiments, a filter media may comprise more than one support layer, such as a first support layer and a second support layer. One such support layer may be positioned adjacent to a main filter layer on a side opposite a prefilter layer and another such support layer may be positioned adjacent to a prefilter layer on a side opposite the main filter layer. Properties of support layers will be described in further detail below.

References herein to a support layer or layers should be understood to refer to each support layer in the filter media independently (if any support layers are present at all). That is, each support layer that is present may independently have some, all, or none of the properties described below. In some embodiments, two or more support layers in the filter media may have similar compositions and/or properties. In other embodiments, each support layer in the filter media may have different compositions and/or properties.

In some embodiments, the support layer or layers described herein may be a non-woven fiber web or webs, such as a wetlaid layer or layers. Wetlaid layers may be formed by a wetlaid process. For example, in embodiments in which a filter media comprises a single support layer, the support layer may be a wetlaid non-woven fiber web. In embodiments in which a filter media comprises two or more support layers, each of the two or more support layers may independently be a wetlaid non-woven fiber web. In some embodiments, a filter media comprises one or more support layer(s) that are non-wetlaid layers. That is, in some embodiments a filter media comprises one or more support layer(s) formed by a non-wet laid process (e.g., an air laid process, a carding process, a spinning process (e.g., a spunbond process)). In some embodiments, a filter media comprises one or more support layer(s) that are spunbond layers, or layers formed by a spunbond process.

In some embodiments, one or more support layers comprise synthetic fibers. In some embodiments, synthetic fibers make up greater than or equal to 0 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 75 wt. %, greater than or equal to 80 wt. %, greater than or equal to 85 wt. %, greater than or equal to 90 wt. %, greater than or equal to 92 wt. %, greater than or equal to 95 wt. %, or greater than or equal to 98 wt. % of a support layer. In some embodiments, synthetic fibers may make up less than or equal to 100 wt. %, less than or equal to 98 wt. %, less than or equal to 95 wt. %, less than or equal to 92 wt. %, less than or equal to 90 wt. %, less than or equal to 85 wt. %, less than or equal to 80 wt. %, less than or equal to 75 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, or less than or equal to 10 wt. % of a support layer. Combinations of the above-referenced ranges are also possible (e.g., greater than or equal to 0 wt. % and less than or equal to 100 wt. %, greater than or equal to 40 wt. % and less than or equal to 95 wt. %, greater than or equal to 75 wt. % and less than or equal to 95 wt. %, or greater than or equal to 75 wt. % and less than or equal to 90 wt. %). Other ranges are also possible.

When a support layer comprises two or more types of synthetic fibers, each type of synthetic fiber may independently make up an amount of the support layer in one or more of the ranges described above and/or all of the synthetic fibers in a support layer may together make up an amount of the support layer in one or more of the ranges described above. Similarly, when a filter media comprises two or more support layers, each layer may independently comprise an amount of any particular type of synthetic fiber in one or more of the ranges described above and/or may comprise a total amount of synthetic fibers in one or more of the ranges described above. In embodiments in which a filter media comprises two or more support layers, the amounts of synthetic fibers in the two or more support layers may be the same or different.

The one or more support layers described herein may include any of a variety of suitable synthetic fibers as described elsewhere herein with respect to the prefilter layer. The synthetic fibers may have any of a variety of suitable average fiber diameters described below with respect to the average fiber diameter of fibers within a support layer.

In some embodiments, a support layer comprises glass fibers (e.g., microglass fibers, chopped stand glass fibers, or a combination thereof). In some embodiments, glass fibers make up greater than or equal to 5 wt. %, greater than or equal to 10 wt. %, greater than or equal to 15 wt. %, greater than or equal to 20 wt. %, greater than or equal to 25 wt. %, greater than or equal to 30 wt. %, greater than or equal to 35 wt. %, greater than or equal to 40 wt. %, or greater than or equal to 45 wt. % of a support layer. In some embodiments, glass fibers make up less than or equal to 50 wt. %, less than or equal to 45 wt. %, less than or equal to 40 wt. %, less than or equal to 35 wt. %, less than or equal to 30 wt. %, less than or equal to 25 wt. %, less than or equal to 20 wt. %, less than or equal to 15 wt. %, or less than or equal to 10 wt. % of a support layer. Combinations of the above-referenced ranges are also possible (e.g., greater than or equal to 1 wt. % and less than or equal to 50 wt. %, or greater than or equal to 5 wt. % and less than or equal to 25 wt. %). Other ranges are also possible.

The average diameter of glass fibers (if present) may be, for example, less than or equal to 20 microns, less than or equal to 15 microns, less than or equal to 12 microns, less than or equal to 10 microns, less than or equal to 9 microns, less than or equal to 7 microns, less than or equal to 5 microns, less than or equal to 3 microns, less than or equal to 1 micron, less than or equal to 0.5 microns, or less than or equal to 0.3 microns. In some instances, the glass fibers may have an average fiber diameter of greater than or equal to 0.1 microns, greater than or equal to 0.3 microns, greater than or equal to 0.5 microns, greater than or equal to 1 micron, greater than or equal to 3 microns, greater than equal to 7 microns, greater than or equal to 9 microns, greater than or equal to 11 microns, or greater than or equal to 20 microns. Combinations of the above-referenced ranges are also possible (e.g., greater than or equal to 0.1 microns and less than or equal to 20 microns, greater than or equal to 0.1 microns and less than or equal to 10 microns, or greater than or equal to 5 microns and less than or equal to 15 microns). Other ranges are also possible.

In embodiments in which a support layer comprises microglass fibers, the microglass fibers may have an average diameter in one or more of the above-referenced ranges for glass fibers (e.g., greater than or equal to 0.1 microns and less than or equal to 10 microns). In some embodiments, the average length of microglass fibers (if present) may be less than or equal to 100 mm, less than or equal to 80 mm, less than or equal to 60 mm, less than or equal to 50 mm, less than or equal to 40 mm, less than or equal to 30 mm, less than or equal to 20 mm, less than or equal to 10 mm, less than or equal to 5 mm, less than or equal to 3 mm, less than or equal to 2 mm, less than or equal to 1 mm, less than or equal to 0.5 mm, less than or equal to 0.25 mm, less than or equal to 0.1 mm, less than or equal to 0.05 mm, or less than or equal to 0.025 mm. In certain embodiments, the average length of microglass fibers may be greater than or equal to 0.01 mm, greater than or equal to 0.025 mm, greater than or equal to 0.05 mm, greater than or equal to 0.1 mm, greater than or equal to 0.25 mm, greater than or equal to 0.5 mm, greater than or equal to 1 mm, greater than or equal to 2 mm, greater than or equal to 3 mm, greater than or equal to 5 mm, greater than or equal to 10 mm, greater than or equal to 20 mm, greater than or equal to 30 mm, greater than or equal to 40 mm, greater than or equal to 50 mm, greater than equal to 60 mm, or greater than or equal to 80 mm. Combinations of the above referenced ranges are also possible (e.g., greater than or equal to 0.01 mm and less than 100 mm). Other ranges are also possible.

In embodiments in which a support layer comprises chopped strand fibers, the chopped strand fibers may have an average diameter in one or more of the above-referenced ranges for glass fibers (e.g., greater than or equal to 5 microns and less than or equal to 15 microns). In general, chopped strand glass fibers (if present) may have an average fiber diameter that is greater than the diameter of the microglass fibers. In some embodiments, the average length of chopped strand glass fibers (if present) may be less than or equal to 18 mm, less than or equal to 15 mm, less than or equal to 10 mm, less than or equal to 8 mm, less than or equal to 6 mm, less than or equal to 5 mm, less than or equal to 4 mm, or less than or equal to 3 mm. In certain embodiments, the average length of chopped strand glass fibers may be greater than or equal to 3 mm, greater than or equal to 4 mm, greater than or equal to 6 mm, greater than or equal to 7 mm, greater than equal to 8 mm, greater than or equal to 10 mm, or greater than or equal to 15 mm. Combinations of the above referenced ranges are also possible (e.g., greater than or equal to 3 mm and less than 18 mm). Other ranges are also possible. When a support layer comprises two or more types of glass fibers, each type of glass fiber may independently make up an amount of the support layer in one or more of the ranges described above and/or all of the glass fibers in a support layer may together make up an amount of the support layer in one or more of the ranges described above. Similarly, when a filter media comprises two or more support layers, each layer may independently comprise an amount of any particular type of glass fiber in one or more of the ranges described above and/or may comprise a total amount of glass fiber in one or more of the ranges described above. In embodiments in which a filter media comprises two or more support layers, the amounts of glass fibers in the two or more support layers may be the same or different.

In some embodiments, a support layer comprises cellulose fibers. In some embodiments, cellulose fibers make up greater than or equal to 0 wt. %, greater than or equal to 1 wt. %, greater than or equal to 5 wt. %, greater than or equal to 10 wt. %, greater than or equal to 15 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, or greater than or equal to 90 wt. % of a support layer. In some embodiments, cellulose fibers make up less than or equal to 100 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, less than or equal to 15 wt. %, less than or equal to 10 wt. %, less than or equal to 5 wt. %, or less than or equal to 1 wt. % of a support layer. Combinations of the above-referenced ranges are also possible (e.g., greater than or equal to 0 wt. % and less than or equal to 100 wt. %, greater than or equal to 0 wt. % and less than or equal to 80 wt. %, or greater than or equal to 0 wt. % and less than or equal to 50 wt. %). Other ranges are also possible.

When a support layer comprises two or more types of cellulose fibers, each type of cellulose fiber may independently make up an amount of the support layer in one or more of the ranges described above and/or all of the cellulose fibers in a support layer may together make up an amount of the support layer in one or more of the ranges described above. Similarly, when a filter media comprises two or more support layers, each layer may independently comprise an amount of any particular type of cellulose fiber in one or more of the ranges described above and/or may comprise a total amount of cellulose fiber in one or more of the ranges described above. In embodiments in which a filter media comprises two or more support layers, the amounts of cellulose fibers in the two or more support layers may be the same or different.

Non-limiting examples of cellulose fibers include softwood fibers, hardwood fibers, a mixture of hardwood and softwood fibers, regenerated cellulose fibers, and/or mechanical pulp fibers (e.g., groundwood, chemically treated mechanical pulps, and thermomechanical pulps).

The average diameter of the cellulose fibers (if present) in a prefilter layer may be, for example, greater than or equal to 1 micron, greater than or equal to 2 microns, greater than or equal to 3 microns, greater than or equal to 4 microns, greater than or equal to 5 microns, greater than or equal to 8 microns, greater than or equal to 10 microns, greater than or equal to 15 microns, greater than or equal to 20 microns, greater than or equal to 30 microns, or greater than or equal to 40 microns. In some instances, the cellulose fibers may have an average diameter of less than or equal to 50 microns, less than or equal to 40 microns, less than or equal to 30 microns, less than or equal to 20 microns, less than or equal to 15 microns, less than or equal to microns, less than or equal to 7 microns, less than or equal to 5 microns, less than or equal to 4 microns, or less than or equal to 2 microns. Combinations of the above-referenced ranges are also possible (e.g., greater than or equal to 1 micron and less than or equal to 5 microns). Other values of average fiber diameter are also possible.

The cellulose fibers (if present) in a prefilter layer may have any suitable average length. For instance, in some embodiments, cellulose fibers may have an average length of greater than or equal to 0.5 mm, greater than or equal to 1 mm, greater than or equal to 2 mm, greater than or equal to 3 mm, greater than or equal to 4 mm, greater than or equal to 5 mm, greater than or equal to 6 mm, or greater than or equal to 8 mm. In some instances, cellulose fibers may have an average length of less than or equal to 10 mm, less than or equal to 8 mm, less than or equal to 6 mm, less than or equal to 4 mm, less than or equal to 2 mm, or less than or equal to 1 mm. Combinations of the above-referenced ranges are also possible (e.g., greater than or equal to 1 mm and less than or equal to 3 mm). Other values of average fiber length are also possible.

The cellulose fibers, when present, may comprise fibrillated cellulose fibers, and/or may comprise unfibrillated cellulose fibers.

In some embodiments, a prefilter lay may include fibrillated fibers. As known to those of ordinary skill in the art, a fibrillated fiber includes a parent fiber that branches into smaller diameter fibrils, which can, in some instances, branch further out into even smaller diameter fibrils with further branching also being possible. The branched nature of the fibrils leads to a layer and/or fiber web having a high surface area and can increase the number of contact points between the fibrillated fibers and other fibers in the web. Such an increase in points of contact between the fibrillated fibers and other fibers and/or components of the web may contribute to enhancing mechanical properties (e.g., flexibility, strength) and/or filtration performance properties of the layer and/or fiber web.

In some embodiments the parent fibers (if present) may have an average diameter in the micron or sub-micron range. For example, the parent fibers may have an average diameter of greater than or equal to 0.5 microns, greater than or equal to 1 micron, greater than or equal to 5 microns, greater than or equal to 10 microns, greater than or equal to 20 microns, greater than or equal to 30 microns, greater than or equal to 40 microns, greater than or equal to 50 microns, greater than or equal to 60 microns, or greater than or equal to 70 microns. In some embodiments, the parent fibers may have an average diameter of less than or equal to 75 microns, less than or equal to 55 microns, less than or equal to 35 microns, less than or equal to microns, less than or equal to 15 microns, less than or equal to 10 microns, less than or equal to 5 microns, less than or equal to 2 microns, or less than or equal to 0.5 microns. Combinations of the above referenced ranges are also possible (e.g., parent fibers having an average diameter of greater than or equal to 1 micron and less than or equal to 25 microns). Other ranges are also possible.

The average diameter of the fibrils (if present) is generally less than the average diameter of the parent fibers. Depending on the average diameter of the parent fibers, in some embodiments, the fibrils may have an average diameter of less than or equal to 25 microns, less than or equal to 20 microns, less than or equal to 10 microns, less than or equal to 5 microns, less than or equal to 1 micron, less than or equal to 0.5 microns, less than or equal to 0.1 microns, less than or equal to 0.05 microns, or less than or equal to 0.01 microns. In some embodiments the fibrils may have an average diameter of greater than or equal to 0.003 microns, greater than or equal to 0.01 micron, greater than or equal to 0.05 microns, greater than or equal to 0.1 microns, greater than or equal to 0.5 microns, greater than or equal to 1 micron, greater than or equal to 5 microns, greater than or equal to 10 microns, or greater than or equal to 20 microns. Combinations of the above referenced ranges are also possible (e.g., fibrils having an average diameter of greater than or equal to 0.01 microns and less than or equal to 20 microns). Other ranges are also possible.

In some embodiments, the average length of the fibrillated fibers (if present) may be less than or equal to 10 mm, less than or equal to 8 mm, less than or equal to 6 mm, less than or equal to 5 mm, less than or equal to 4 mm, less than or equal to 3 mm, or less than or equal to 2 mm. In certain embodiments, the average length of the fibrillated fibers may be greater than or equal to 1 mm, greater than or equal to 2 mm, greater than or equal to 4 mm, greater than or equal to 5 mm, greater than equal to 6 mm, or greater than or equal to 8 mm. Combinations of the above referenced ranges are also possible (e.g., fibrillated fibers having an average length of greater than or equal to 4 mm and less than 6 mm). Other ranges are also possible.

The average length of the fibrillated fibers refers to the average length of parent fibers from one end to an opposite end of the parent fibers. In some embodiments, the maximum average length of the fibrillated fibers falls within the above-noted ranges. The maximum average length refers to the average of the maximum dimension along one axis of the fibrillated fibers (including parent fibers and fibrils). It should be understood that, in certain embodiments, the fibers and fibrils may have dimensions outside the above-noted ranges.

The level of fibrillation of the fibrillated fibers (if present) may be measured according to any number of suitable methods. For example, the level of fibrillation can be measured according to a Canadian Standard Freeness (CSF) test, specified by TAPPI test method T 227 om 09 Freeness of pulp. The test can provide an average CSF value. In some embodiments, the average CSF value of the fibrillated fibers may vary between 10 mL and 750 mL. In certain embodiments, the average CSF value of the fibrillated fibers used in the pre-filter layer or layers may be greater than or equal to 10 mL, greater than or equal to 50 mL, greater than or equal to 100 mL, greater than or equal to 200 mL, greater than or equal to 400 mL, greater than or equal to 600 mL, or greater than or equal to 700 mL. In some embodiments, the average CSF value of the fibrillated fibers may be less than or equal to 800 mL, less than or equal to 600 mL, less than or equal to 400 mL, less than or equal to 200 mL, less than or equal to 100 mL, or less than or equal to 50 mL. Combinations of the above-referenced ranges are also possible (e.g., an average CSF value of fibrillated fibers of greater than or equal to 10 mL and less than or equal to 300 mL). Other ranges are also possible. The average CSF value of the fibrillated fibers may be based on one type of fibrillated fiber or more than one type of fibrillated fiber.

The one or more support layers described herein may include components other than fibers. For instance, a support layer may comprise a binder resin. In general, binder resin may be used to join fibers within the layer. The binder resin may make up less than or equal to 60 wt. %, less than or equal to 50 wt. %, less than or equal to 40 wt. %, less than or equal to 30 wt. %, less than or equal to 25 wt. %, less than or equal to 20 wt. %, less than or equal to 15 wt. %, less than or equal to 10 wt. %, less than or equal to 7.5 wt. %, less than or equal to 5 wt. %, less than or equal to 4 wt. %, less than or equal to 3 wt. %, less than or equal to 2 wt. %, less than or equal to 1.5 wt. %, less than or equal to 1 wt. %, less than or equal to 0.75 wt. %, less than or equal to 0.5 wt. %, less than or equal to 0.4 wt. %, less than or equal to 0.2 wt. %, or less than or equal to 0.1 wt. % of a support layer. The binder resin may make up greater than or equal to 0 wt. %, greater than or equal to 0.1 wt. %, greater than or equal to 0.2 wt. %, greater than or equal to 0.4 wt. %, greater than or equal to 0.5 wt. %, greater than or equal to 0.75 wt. %, greater than or equal to 1 wt. %, greater than or equal to 1.5 wt. %, greater than or equal to 2 wt. %, greater than or equal to 3 wt. %, greater than or equal to 4 wt. %, greater than or equal to 5 wt. %, greater than or equal to 7.5 wt. %, greater than or equal to 10 wt. %, greater than or equal to 15 wt. %, greater than or equal to 20 wt. %, greater than or equal to 25 wt. %, greater than or equal to 30 wt. %, greater than or equal to 40 wt. %, or greater than or equal to 50 wt. % of a support layer. Combinations of the above-referenced ranges are also possible (e.g., greater than or equal to 0 wt. % and less than or equal to 50 wt. %, greater than or equal to 5 wt. % and less than or equal to 50 wt. %, or greater than or equal to 10 wt. % and less than or equal to 30 wt. %). Other ranges are also possible. In some embodiments, a support layer is binder resin-free (i.e., binder resin makes up 0 wt. % of the support layer).

When a support layer comprises two or more types of binder resins, each type of binder resin may independently make up an amount of the support layer in one or more of the ranges described above and/or all of the binder resins in a support layer may together make up an amount of the support layer in one or more of the ranges described above. Similarly, when a filter media comprises two or more support layers, each layer may independently comprise an amount of any particular type of binder resin in one or more of the ranges described above and/or may comprise a total amount of binder resin in one or more of the ranges described above. In embodiments in which a filter media comprises two or more support layers, the amounts of binder resin in the two or more support layers may be the same or different.

In some embodiments, a binder resin comprises a polymer. Non-limiting examples of suitable polymers for use with a binder resin include thermoplastic polymers (e.g., acrylics, poly(vinylacetate), poly(ester)s, poly(amide)s), thermosetting polymers (e.g., epoxy, phenolic resin, melamine), a vinyl acetate resin, an epoxy resin, a poly(ester) resin, a copoly(ester) resin, a poly(vinyl alcohol) resin, an acrylic resin (e.g., a styrene acrylic resin), styrene acrylate, styrene butyl acrylate, styrene butadiene, poly(methyl methacrylate), a copolymer of styrene and methyl methacrylate, a phenolic resin, acrylonitrile rubber, poly(ethylene), poly(urethane), and combinations thereof. Alternatively or additionally, the binder resin may include a fluorocarbon, a fluorine free chemical, and/or a chemical comprising minimal fluorine atoms. In some cases, the presence of an acrylic resin in a support layer may help improve the stiffness of the support layer. In some embodiments, a support layer comprises a flame retardant resin that comprises a halogen and/or phosphorous. It is also possible for a support layer to comprise a flame retardant resin that lacks halogens and/or phosphorus.

In some embodiments, a filter media comprises a water-repellant additive having minimal or no fluorine atoms. In some embodiments, the water-repellent additive comprises one or more water-repellent functional groups. Each water-repellent functional group may be independently an alkyl group comprising greater than or equal to 3 carbon atoms, an alkenyl group comprising greater than or equal to 3 carbon atoms, and/or an alkynyl group comprising greater than or equal to 3 carbon atoms. In some embodiments, each water-repellent functional group independently comprises less than or equal to 30 carbon atoms. The water-repellent functional groups may be substituted or unsubstituted. In some cases, one or more of the water-repellent functional groups are substituted with an aryl group. In some embodiments, one or more water-repellent functional groups are straight chain functional groups, branched functional groups, or hyperbranched functional groups.

In one set of embodiments, each water-repellent functional group may independently be a side chain of a repeat unit of a polymer and/or bonded to a silicon atom and/or a metal atom. Non-limiting examples of suitable metals include titanium, zirconium, and/or aluminum. Non-limiting examples of suitable polymers include poly(siloxane), poly(silazane), poly(acrylate), poly(urethane), poly(ether), poly(urea), poly(ester), poly(carbodiimide), etc. In some cases, a polymer of which a water-repellent functional group is a side chain and/or to which a water-repellent functional group is bonded is a hydrolysis product of a species comprising a metal atom, a hydrolysable functional group, and a water-repellent functional group. In some embodiments, the water-repellent additive comprises an oligomer.

In some embodiments, the water-repellent additive comprises two or more water-repellent functional groups bonded to a common atom. Non-limiting examples of a common atom include a carbon atom, a silicon atom, a titanium atom, a zirconium atom, and/or an aluminum atom. In some embodiments, a water-repellent additive is a reaction product of a silane, a titanate, a zirconate, and/or an aluminate. In some embodiments, the water-repellent additive comprises a silanol, a siloxide, a siloxane, and/or a silyl ether. In some embodiments, the two or more functional groups may comprise two or more functional groups that are the same or different.

Additionally, in some embodiments, a water-repellant additive comprises one or more polar, non-hydrolysable groups. In some such embodiments, the one or more polar, non-hydrolysable groups may each be independently bonded to a carbon atom, a metal atom, and/or a silicon atom. Non-limiting examples of suitable metal atoms include titanium atoms, zirconium atoms, and aluminum atoms. In some embodiments, the one or more polar, non-hydrolysable groups are each independently a side chain of a repeat unit of a polymer described above with respect to a water-repellant functional group. In some embodiment, the one or more polar, non-hydrolysable groups comprise amino groups, acetoxy groups, and/or acetamido groups. In some embodiments, a ratio of the number of water-repellent functional groups to the number of one or more polar, non-hydrolysable groups is greater than or equal to 0.1 and less than or equal to 10.

Additionally or alternatively, in some embodiments, a filter media comprises a fluorinated water-repellent additive that comprises a fluorinated polymer, a fluorinated oligomer, or a fluorinated monomer that may be capable of and/or configured to undergo a polymerization reaction to form a fluorinated polymer and/or oligomer. For example, non-limiting examples of fluorinated polymers include perfluoropoly(ether), a fluorinated poly(urethane), etc. In some embodiments, the fluorinated polymer comprises a plurality of fluorinated side chains. In some cases, the fluorinated side chains include the structure —CₙFₘR_{y}, where n is 3-4, m is ≥1, R is an atom or a group of atoms, and y≥0. Optionally, in some embodiments, m=2n+1. In some embodiments, the fluorinated side chains include the structure —(CF₂)ₙCF₃, where n is 2-3. In some embodiments, the fluorinated side chains include the structure —(CₙFₘO)ₓ—, where n and m are integers properly chosen to form a valid structure, and x is 1-10. Other ranges are also possible.

In some embodiments, a fluorinated polymer has a molecular weight of greater than or equal to 169 g/mol and less than or equal to 200 kg/mol. In some embodiments, the fluorinated polymer is a homopolymer, a copolymer, a random copolymer, a block copolymer, or a blocky copolymer. In some embodiments, all of the repeat units of a fluorinated polymer are fluorinated. In some embodiments, the fluorinated polymer comprises repeat units that are unfluorinated.

Non-limiting examples of fluorinated water-repellent additives include fluorinated poly(ethers) (e.g., perfluoropoly(ether)s), oligomeric fluorinated ethers, fluorinated poly(urethane)s, oligomeric fluorinated urethanes, and polymers and oligomers comprising a side chain comprising a structural motif having a structure described above.

In some embodiments, a filter media may comprise a water-repellent additive having minimal or no fluorine atoms as described above and a fluorinated water-repellent additive comprising a fluorinated polymer, a fluorinated oligomer, or a fluorinated monomer as described herein.

Additionally, further details regarding some types of additives are provided in U.S. application Ser. No. 17/101,707 (filed on Nov. 23, 2020, and entitled “Filter Media Comprising Non-Fluorinated Water Repellent Additives”), U.S. application Ser. No. 17/534,186 (filed on Nov. 23, 2021, and entitled “Filter Media Comprising Fluorinated and Non-Fluorinated Water Repellent Additives”), and International Application No. PCT/US21/60626 (filed on Nov. 23, 2021, and entitled “Filter Media Comprising Fluorinated and Non-Fluorinated Water Repellent Additives”), each of which are incorporated by reference herein in their entirety for all purposes.

In some embodiments, a support layer comprises an oleophobic additive described elsewhere herein with respect to the prefilter layer. For example, in some cases, a support layer comprises an additive that is a fluorocarbon additive (e.g., a fluorinated monomer such as hexafluorobutanoic acid, CF₄, CHF₃, C₂F₆, C₃F₈, C₄F₈, C₂F₄, C₃F₆, C₄F₁₀, C₅F₁₀, C₅F₁₂, C₆F₁₂, C₆F₁₄, perfluorohexyl ethyl acrylate (C₁₁H₇F₁₃O₂), perfluorohexyl ethyl methacrylate (C₁₂H₉F₁₃O₂), allylpentafluorobenzene (C₉H₅F₅), pentafluorostyrene (C₈H₃F₅), etc.; a reaction product of such a monomer) as described elsewhere herein. When present, such additives may be introduced into the support layer by one or more of the processes described with respect to the introduction of oleophobic additives to prefilter layers.

A support layer may include oleophobic additives in any suitable amount. In some embodiments, oleophobic additives may be present in a support layer in an amount of greater than or equal to 0 wt. %, greater than or equal to 1 wt. %, greater than or equal to 2 wt. %, greater than or equal to 3 wt. %, greater than or equal to 5 wt. %, greater than or equal to 7 wt. %, or greater than or equal to 9 wt. %. In some embodiments, oleophobic additives may be present in a support layer in an amount of less than or equal to 10 wt. %, less than or equal to 9 wt. %, less than or equal to 7 wt. %, less than or equal to 5 wt. %, less than or equal to 3 wt. %, less than or equal to 2 wt. %, or less than or equal to 1 wt. %. Combinations of the above-referenced ranges are also possible (e.g., greater than or equal to 0 wt. % and less than or equal to 10 wt. %). Other ranges are also possible.

When a support layer comprises two or more types of oleophobic additives, each type of oleophobic additive may independently make up an amount of the support layer in one or more of the ranges described above and/or all of the oleophobic additives in a support layer may together make up an amount of the support layer in one or more of the ranges described above. Similarly, when a filter media comprises two or more support layers, each layer may independently comprise an amount of any particular type of oleophobic additive in one or more of the ranges described above and/or may comprise a total amount of oleophobic additives in one or more of the ranges described above. In embodiments in which a filter media comprises two or more support layers, the amounts of oleophobic additives in the two or more support layers may be the same or different.

In some embodiments, one or more support layers described herein may include one or more crosslinkers and/or reaction products of crosslinkers. The reaction products of crosslinkers may comprise portion(s) of crosslinkers that were chemically bonded to the portion(s) of the crosslinkers that underwent crosslinking reactions to form the reaction products (e.g., unreacted cores initially present in a crosslinker comprising two or more functional groups that underwent a crosslinking reaction). Such portion(s) may be referred to as “reacted crosslinkers.” Non-limiting examples of suitable crosslinkers include crosslinkers suitable for inclusion in acrylic resins and/or flame retardant resins.

A filter media described herein may include crosslinkers and/or reacted crosslinkers in any suitable amount. In some embodiments, crosslinkers and/or reacted crosslinkers may be present in a support layer in an amount of greater than or equal to 0 wt. %, greater than or equal to 0.5 wt. %, greater than or equal to 1 wt. %, greater than or equal to 2 wt. %, greater than or equal to 5 wt. %, greater than or equal to 10 wt. %, or greater than or equal to 15 wt. %. In some embodiments, crosslinkers and/or reacted crosslinkers may be present in a support layer in an amount of less than or equal to 20 wt. %, less than or equal to 15 wt. %, less than or equal to 10 wt. %, less than or equal to 5 wt. %, less than or equal to 2 wt. %, less than or equal to 1 wt. %, or less than or equal to 0.5 wt. %. Combinations of the above-referenced ranges are also possible (e.g., greater than or equal to 0 wt. % and less than or equal to 20 wt. %). Other ranges are also possible.

When a support layer comprises two or more types of crosslinkers and/or reacted crosslinkers, each type of crosslinker and/or reacted crosslinker may independently make up an amount of the support layer in one or more of the ranges described above and/or all of the crosslinker and/or reacted crosslinker in a support layer may together make up an amount of the support layer in one or more of the ranges described above. Similarly, when a filter media comprises two or more support layers, each layer may independently comprise an amount of any particular type of crosslinker and/or reacted crosslinker in one or more of the ranges described above and/or may comprise a total amount of crosslinkers and/or reacted crosslinkers in one or more of the ranges described above. In embodiments in which a filter media comprises two or more support layers, the amounts of crosslinkers and/or reacted crosslinkers in the two or more support layers may be the same or different.

A support layer described herein may comprise fibers having any of a variety of suitable average fiber diameters. In some embodiments, the average fiber diameter of the fibers in a support layer is greater than or equal to 1 micron, greater than or equal to 1.5 microns, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 12 microns, greater than or equal to 15 microns, greater than or equal to 16 microns, or greater than or equal to 18 microns. In some embodiments, the average fiber diameter of the fibers in a support layer is less than or equal to microns, less than or equal to 18 microns, less than or equal to 16 microns, less than or equal to 15 microns, less than or equal to 12 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, or less than or equal to 1.5 microns. Combinations of the above-referenced ranges are also possible (e.g., greater than or equal to 1 micron and less than or equal to 20 microns, greater than or equal to 5 microns and less than or equal to 16 microns, greater than or equal to 8 microns and less than or equal to 15 microns, greater than or equal to 2 microns and less than or equal to 8 microns, or greater than or equal to 2 microns and less than or equal to 5 microns). Other ranges are also possible.

When a support layer comprises two or more types of fibers, each type of fiber may independently have an average fiber diameter in one or more of the ranges described above and/or all of the fibers in a support layer may together have an average fiber diameter in one or more of the ranges described above. Similarly, when a filter media comprises two or more support layers, each support layer may independently comprise one or more types of fibers having an average fiber diameter in one or more of the ranges described above and/or may comprise fibers that overall have an average fiber diameter in one or more of the ranges described above. In embodiments in which a filter media comprises two or more support layers, the average fiber diameters of the fibers in the two or more support layers may be the same or different.

In embodiments in which a filter media comprises two or more support layers, the average fiber diameter of fibers in the two or more support layers may be the same or different. For example, a filter media may comprise a first support layer that has an average fiber diameter in one or more ranges described above (e.g., greater than or equal to 1 micron and less than or equal to 20 microns, greater than or equal to 5 microns and less than or equal to 16 microns, or greater than or equal to 8 microns and less than or equal to 15 microns) and a second support layer that has an average fiber diameter in one or more ranges described above (e.g., greater than or equal to 1 micron and less than or equal to 20 microns, greater than or equal to 2 microns and less than or equal to 8 microns, or greater than or equal to 2 microns and less than or equal to 5 microns). In some cases, a support layer that is positioned adjacent to a prefilter layer on a side opposite a main filter layer may comprise fibers having an average fiber diameter that is less than the average fiber diameter of the fibers in a support layer that is positioned adjacent to the main filter layer on a side opposite the prefilter layer. In other cases, the support layer that is positioned adjacent to a prefilter layer on a side opposite a main filter layer may comprise fibers having an average fiber diameter that is greater than the average fiber diameter of the fibers in a support layer that is positioned adjacent to the main filter layer on a side opposite the prefilter layer and/or these two support layers may both be present and comprise fibers having the same average fiber diameter.

A support layer described herein may comprise fibers having a variety of suitable average fiber lengths. In some embodiments, the average fiber length of the fibers in a support layer is greater than or equal to 1 mm, greater than or equal to 1.5 mm, greater than or equal to 2 mm, greater than or equal to 2.5 mm, greater than or equal to 3 mm, greater than or equal to 5 mm, greater than or equal to 7 mm, greater than or equal to 10 mm, greater than or equal to 12 mm, greater than or equal to 15 mm, greater than or equal to 18 mm, greater than or equal to 20 mm, greater than or equal to 30 mm, greater than or equal to 50 mm, greater than or equal to 75 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, or greater than or equal to 275 mm. In some embodiments, the average fiber length of the fibers in a support layer is less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 75 mm, less than or equal to 50 mm, less than or equal to 30 mm, less than or equal to 20 mm, less than or equal to 18 mm, less than or equal to 15 mm, less than or equal to 12 mm, less than or equal to 10 mm, less than or equal to 7 mm, less than or equal to 5 mm, less than or equal to 3 mm, less than or equal to 2.5 mm, less than or equal to 2 mm, or less than or equal to 1.5 mm. Combinations of the above-referenced ranges are also possible (e.g., greater than or equal to 1 mm and less than or equal to 300 mm, greater than or equal to 2 mm and less than or equal to 100 mm, greater than or equal to 3 mm and less than or equal to 18 mm, or greater than or equal to 2 mm and less than or equal to 12 mm). Other ranges are also possible.

When a support layer comprises two or more types of fibers, each type of fiber may independently have an average fiber length in one or more of the ranges described above and/or all of the fibers in a support layer may together have an average fiber length in one or more of the ranges described above. Similarly, when a filter media comprises two or more support layers, each support layer may independently comprise one or more types of fibers having an average fiber length in one or more of the ranges described above and/or may comprise fibers that overall have an average fiber length in one or more of the ranges described above. In embodiments in which a filter media comprises two or more support layers, the average fiber lengths of the fibers in the two or more support layers may be the same or different.

In embodiments in which a filter media comprises two or more support layers, the average fiber length of fibers in the two or more support layers may be the same or different. For example, a filter media may comprise a first support layer having an average fiber length in one or more ranges described above (e.g., greater than or equal to 1 mm and less than or equal to 300 mm, greater than or equal to 2 mm and less than or equal to 100 mm, or greater than or equal to 3 mm and less than or equal to 18 mm) and a second support layer having an average fiber diameter in one or more ranges described above (e.g., greater than or equal to 1 mm and less than or equal to 300 mm, greater than or equal to 2 mm and less than or equal to 100 mm, or greater than or equal to 2 mm and less than or equal to 12 mm). In some cases, a support layer that is positioned adjacent to a prefilter layer on a side opposite a main filter layer may comprise fibers having an average fiber length that is less than the average fiber length of the fibers in a support layer that is positioned adjacent to the main filter layer on a side opposite the prefilter layer. In other cases, a support layer that is positioned adjacent to a prefilter layer on a side opposite a main filter layer may comprise fibers having an average fiber length that is greater than the average fiber length of the fibers in a support layer that is positioned adjacent to the main filter layer on a side opposite the prefilter layer and/or these two support layers may both be present and comprise fibers having the same average fiber length.

A support layer may have any of a variety of suitable thicknesses. In some embodiments, a support layer has a thickness of greater than or equal to 0.05 mm, greater than or equal to 0.07 mm, greater than or equal to 0.1 mm, greater than or equal to 0.2 mm, greater than or equal to 0.4 mm, greater than or equal to 0.6 mm, greater than or equal to 0.8 mm, greater than or equal to 1 mm, greater than or equal to 1.2 mm, greater than or equal to 1.5 mm, greater than or equal to 2 mm, greater than or equal to 2.5 mm, greater than or equal to 3 mm, greater than or equal to 3.5 mm, greater than or equal to 4 mm, or greater than or equal to 4.5 mm. In some embodiments, a support layer has a thickness of less than or equal to 5 mm, less than or equal to 4.5 mm, less than or equal to 4 mm, less than or equal to 3.5 mm, less than or equal to 3 mm, less than or equal to 3.5 mm, less than or equal to 2.5 mm, less than or equal to 2 mm, less than or equal to 1.5 mm, less than or equal to 1.2 mm, less than or equal to 1 mm, less than or equal to 0.8 mm, less than or equal to 0.6 mm, less than or equal to 0.4 mm, less than or equal to 0.2 mm, less than or equal to 0.1 mm, or less than or equal to 0.07 mm. Combinations of the above-referenced ranges are also possible (e.g., greater than or equal to 0.05 mm and less than or equal to 5 mm, greater than or equal to 0.1 mm and less than or equal to 1 mm, or greater than or equal to 0.1 mm and less than or equal to 1 mm). Other ranges are also possible.

When a filter media comprises two or more support layers, each support layer may independently have a thickness in one or more of the above-referenced ranges. In embodiments in which a filter media comprises two or more support layers, the thicknesses of the two or more support layers may be the same or different.

The thickness of a support layer may be determined in accordance with ASTM D1777 (2015) under an applied pressure of 0.8 kPa.

A support layer may have any suitable normalized surface area. In some embodiments, a support layer has a normalized surface area of greater than or equal to 0.01 m²/m², greater than or equal to 0.05 m²/m², greater than or equal to 0.1 m²/m², greater than or equal to 0.5 m²/m², greater than or equal to 1 m²/m², greater than or equal to 3 m²/m², greater than or equal to 5 m²/m², greater than or equal to 10 m²/m², greater than or equal to 25 m²/m², greater than or equal to 50 m²/m², greater than or equal to 100 m²/m², greater than or equal to 150 m²/m², greater than or equal to 200 m²/m², greater than or equal to 250 m²/m², greater than or equal to 300 m²/m², or greater than or equal to 350 m²/m². In some embodiments, a support layer has a normalized surface area of less than or equal to 400 m²/m², less than or equal to 350 m²/m², less than or equal to 300 m²/m², less than or equal to 250 m²/m², less than or equal to 200 m²/m², less than or equal to 150 m²/m², less than or equal to 100 m²/m², less than or equal to 50 m²/m², less than or equal to 25 m²/m², less than or equal to 10 m²/m², less than or equal to 5 m²/m², less than or equal to 3 m²/m², less than or equal to 1 m²/m², less than or equal to 0.5 m²/m², less than or equal to 0.1 m²/m², or less than or equal to 0.05 m²/m². Combinations of the above-referenced ranges are also possible (e.g., greater than or equal to 0.01 m²/m² and less than or equal to 400 m²/m², or greater than or equal to 0.1 m²/m² and less than or equal to 3 m²/m²). Other ranges are also possible.

When a filter media comprises two or more support layers, each support layer may independently have a normalized surface area in one or more of the above-referenced ranges. In embodiments in which a filter media comprises two or more support layers, the normalized surface area of the two or more support layers may be the same or different.

The normalized surface area of a support layer may be determined as described elsewhere herein with respect to the determination of the normalized surface area of a prefilter layer.

A noted above, in some embodiments, a filter media may comprise exactly one support layer. In other embodiments, a filter media may comprise two or more support layers. Various support layer properties will be described below for each of these configurations.

In embodiments in which a filter media comprises a single support layer, the support layer may have a basis weight of greater than or equal to 25 gsm, greater than or equal to 30 gsm, greater than or equal to 35 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, greater than or equal to 150 gsm, greater than or equal to 175 gsm, greater than or equal to 200 gsm, greater than or equal to 225 gsm, greater than or equal to 250 gsm, or greater than or equal to 275 gsm. In embodiments in which a filter media comprises a single support layer, the support layer may have a basis weight of less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 35 gsm, less than or equal to 30 gsm, or less than or equal to 25 gsm. Combinations of the above-referenced ranges are also possible (e.g., greater than or equal to 25 gsm and less than or equal to 300 gsm, or greater than or equal to 25 gsm and less than or equal to 120 gsm). Other ranges are also possible.

Basis weight may be measured according to ASTM D3776M-20 (2020).

In embodiments in which a filter media comprises a single support layer, the support layer may have an average pore size of greater than or equal to 0.1 microns, greater than or equal to 0.2 microns, greater than or equal to 0.4 microns, greater than or equal to 0.6 microns, greater than or equal to 0.8 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to microns, greater than or equal to 45 microns, greater than or equal to 50 microns, greater than or equal to 60 microns, greater than or equal to 80 microns, greater than or equal to 100 microns, greater than or equal to 150 microns, greater than or equal to 200 microns, or greater than or equal to 250 microns. In some embodiments, a support layer that is the only support layer in a filter media has an average pore size of less than or equal to 300 microns, less than or equal to 250 microns, less than or equal to 200 microns, less than or equal to 150 microns, less than or equal to 100 microns, less than or equal to 80 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 15 microns, less than or equal to 10 microns, less than or equal to 5 microns, less than or equal to 2 microns, less than or equal to 1 micron, less than or equal to 0.6 microns, less than or equal to 0.4 microns, or less than or equal to 0.2 microns. Combinations of the above-referenced ranges are also possible (e.g., greater than or equal to 0.1 microns and less than or equal to 300 microns, greater than or equal to 1 micron and less than or equal to 100 microns). Other ranges are also possible.

The average pore size may be measured using ASTM F316 (2003).

In embodiments in which a filter media comprises a single support layer, the support layer may have an efficiency (e.g., prior to exposure to IPA vapor) of greater than or equal to 1%, greater than or equal to 2%, greater than or equal to 5%, greater than or equal to 7%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. In embodiments in which a filter media comprises a single support layer, the support layer may have an efficiency (e.g., prior to exposure to IPA vapor) of less than or equal to 50%, less than or equal to 45%, less than or equal to 40%, less than or equal to 5%, less than or equal to 35%, less than or equal to 30%, less than or equal to 25%, less than or equal to 10%, less than or equal to 5%, less than or equal to 3%, or less than or equal to 2%. Combinations of the above-referenced ranges are also possible (e.g., greater than or equal to 1% and less than or equal to 50%, or greater than or equal to 1% and less than 35%). Other ranges are also possible. In some embodiments, the efficiencies described in the preceding paragraph are efficiencies at the MPPS. In some embodiments, the efficiencies described in the preceding paragraph are efficiencies at 0.09 microns. In some embodiments, the efficiencies described in the preceding paragraph are efficiencies at 0.3 microns. The efficiencies of the support layers at the MPPS, 0.09 microns, and 0.3 microns may be determined as described elsewhere herein with respect to the determination of the efficiency of the prefilter layer.

In embodiments in which a filter media comprises a single support layer, the support layer may have an air permeability of greater than or equal to 0.5 CFM, greater than or equal to 1 CFM, greater than or equal to 5 CFM, greater than or equal to 10 CFM, greater than or equal to 25 CFM, greater than or equal to 50 CFM, greater than or equal to 75 CFM, greater than or equal to 100 CFM, greater than or equal to 200 CFM, greater than or equal to 300 CFM, greater than or equal to 400 CFM, greater than or equal to 500 CFM, greater than or equal to 600 CFM, or greater than or equal to 700 CFM. In embodiments in which a filter media comprises a single support layer, the support layer may have an air permeability of less than or equal to 800 CFM, less than or equal to 700 CFM, less than or equal to 600 CFM, less than or equal to 500 CFM, less than or equal to 400 CFM, less than or equal to 300 CFM, less than or equal to 200 CFM, less than or equal to 100 CFM, less than or equal to 75 CFM, less than or equal to 50 CFM, less than or equal to 25 CFM, less than or equal to 10 CFM, less than or equal to 5 CFM, or less than or equal to 1 CFM. Combinations of these ranges are also possible (e.g., greater than or equal to 0.5 CFM and less than or equal to 800 CFM, or greater than or equal to 1 CFM and less than or equal to 500 CFM). Other ranges are also possible.

Air permeability may be measured according to ASTM D737-04 (2016) at a pressure of 125 Pa.

In embodiments in which a filter media comprises two or more support layers, the basis weight of each of the support layers may independently be greater than or equal to 10 gsm, greater than or equal to 12.5 gsm, greater than or equal to 15 gsm, greater than or equal to 20 gsm, greater than or equal to 25 gsm, greater than or equal to 30 gsm, greater than or equal to 35 gsm, greater than or equal to 40 gsm, or greater than or equal to 45 gsm. In some embodiments, the basis weight of each of the support layers may independently be less than or equal to 50 gsm, less than or equal to 45 gsm, less than or equal to 40 gsm, less than or equal to 35 gsm, less than or equal to 30 gsm, less than or equal to 25 gsm, less than or equal to 20 gsm, less than or equal to 15 gsm, or less than or equal to 12.5 gsm. Combinations of the above-referenced ranges are also possible (e.g., greater than or equal to 10 gsm and less than or equal to 50 gsm, or greater than or equal to 15 gsm and less than or equal to 15 gsm). Other ranges are also possible. The basis weights of the two or more support layers may be the same or different.

Basis weight may be measured according to ASTM D3776M-20 (2020).

In embodiments in which a filter media comprises two or more support layers, the air permeabilities of the two or more support layers may be the same or different.

In embodiments in which a filter media comprises two or more support layers, a support layer adjacent to a main filter layer on a side opposite a prefilter layer may have an air permeability of greater than or equal to 1 CFM, greater than or equal to 5 CFM, greater than or equal to 10 CFM, greater than or equal to 25 CFM, greater than or equal to 50 CFM, greater than or equal to 75 CFM, greater than or equal to 100 CFM, greater than or equal to 200 CFM, greater than or equal to 300 CFM, greater than or equal to 400 CFM, greater than or equal to 500 CFM, greater than or equal to 600 CFM, or greater than or equal to 700 CFM. In embodiments in which a filter media comprises two or more support layers, a support layer adjacent to a main filter layer on a side opposite a prefilter layer have an air permeability of less than or equal to 800 CFM, less than or equal to 700 CFM, less than or equal to 600 CFM, less than or equal to 500 CFM, less than or equal to 400 CFM, less than or equal to 300 CFM, less than or equal to 200 CFM, less than or equal to 100 CFM, less than or equal to 75 CFM, less than or equal to 50 CFM, less than or equal to 25 CFM, less than or equal to 10 CFM, or less than or equal to 5 CFM. Combinations of the above-referenced ranges are also possible (e.g., greater than or equal to 1 CFM and less than or equal to 800 CFM, greater than or equal to 1 CFM and less than or equal to 500 CFM). Other ranges are also possible.

In embodiments in which a filter media comprises two or more support layers, a support layer adjacent to a prefilter layer on a side opposite a main filter layer may have an air permeability of greater than or equal to 1 CFM, greater than or equal to 5 CFM, greater than or equal to 10 CFM, greater than or equal to 25 CFM, greater than or equal to 50 CFM, greater than or equal to 75 CFM, greater than or equal to 100 CFM, greater than or equal to 200 CFM, greater than or equal to 300 CFM, greater than or equal to 400 CFM, or greater than or equal to 450 CFM. In embodiments in which a filter media (e.g., a filter media like the filter media shown in FIG. 5) comprises two or more support layers (e.g., a third layer, a fourth layer), a support layer adjacent to a prefilter layer on a side opposite a main filter layer may have an air permeability of less than or equal to 500 CFM, less than or equal to 500 CFM, less than or equal to 450 CFM, less than or equal to 300 CFM, less than or equal to 200 CFM, less than or equal to 100 CFM, less than or equal to 75 CFM, less than or equal to 50 CFM, less than or equal to 25 CFM, less than or equal to 10 CFM, or less than or equal to 5 CFM. Combinations of the above-referenced ranges are also possible (e.g., greater than or equal to 1 CFM and less than or equal to 500 CFM). Other ranges are also possible.

Air permeability may be measured according to ASTM D737-04 (2016) at a pressure of 125 Pa.

In embodiments in which a filter media comprises two or more support layers, a support layer adjacent to a main filter layer on a side opposite a prefilter layer may have an efficiency (e.g., efficiency prior to IPA vapor exposure) of greater than or equal to 1%, greater than or equal to 2%, greater than or equal to 5%, greater than or equal to 7%, greater than or equal to 10%, greater than or equal to 15%, greater than or equal to 20%, greater than or equal to 25%, greater than or equal to 30%, greater than or equal to 35%, greater than or equal to 40%, or greater than or equal to 45%. In embodiments in which a filter media comprises two or more support layers, a support layer adjacent to a main filter layer on a side opposite a prefilter layer may have an efficiency (e.g., efficiency prior to IPA vapor exposure) of less than or equal to 50%, less than or equal to 45%, less than or equal to 40%, less than or equal to 35%, less than or equal to 30%, less than or equal to 25%, less than or equal to 10%, less than or equal to 5%, less than or equal to 3%, or less than or equal to 2%. Combinations of the above-referenced ranges are also possible (e.g., greater than or equal to 1% and less than or equal to 50%). Other ranges are also possible.

In some embodiments, the efficiencies described in the preceding paragraph are efficiencies at the MPPS. In some embodiments, the efficiencies described in the preceding paragraph are efficiencies at 0.09 microns. In some embodiments, the efficiencies described in the preceding paragraph are efficiencies at 0.3 microns. The efficiencies of the one or more support layers at the MPPS, at 0.09 microns, and at 0.3 microns may be determined as described elsewhere herein with respect to the determination of the efficiency of the prefilter layer.

In embodiments in which a filter media comprises two or more support layers, a support layer adjacent to a prefilter layer on a side opposite a main filter layer may have an efficiency (e.g., efficiency prior to IPA vapor exposure) of greater than or equal to 5%, greater than or equal to 7%, greater than or equal to 10%, greater than or equal to 15%, greater than or equal to 20%, greater than or equal to 30%, greater than or equal to 40%, greater than or equal to 50%, greater than or equal to 60%, greater than or equal to 70%, greater than or equal to 80%, greater than or equal to 85%, greater than or equal to 90%, greater than or equal to 95%, greater than or equal to 97%, greater than or equal to 98%, or greater than or equal to 98.5%. In embodiments in which a filter media comprises two or more support layers, a support layer adjacent to a prefilter layer on a side opposite a main filter layer may have an efficiency (e.g., efficiency prior to IPA vapor exposure) of less than or equal to 99%, less than or equal to 98.5%, less than or equal to 98%, less than or equal to 97%, less than or equal to 95%, less than or equal to 90%, less than or equal to 85%, less than or equal to 80%, less than or equal to 70%, less than or equal to 60%, less than or equal to 50%, less than or equal to 40%, less than or equal to 30%, less than or equal to 20%, less than or equal to 15%, less than or equal to 10%, or less than or equal to 7%. Combinations of the above-referenced ranges are also possible (e.g., greater than or equal to 5% and less than or equal to 99%). Other ranges are also possible.

In some embodiments, the efficiencies described in the preceding paragraph are efficiencies at the MPPS. In some embodiments, the efficiencies described in the preceding paragraph are efficiencies at 0.09 microns. In some embodiments, the efficiencies described in the preceding paragraph are efficiencies at 0.3 microns. The efficiencies of the one or more support layers at the MPPS, at 0.09 microns, and at 0.3 microns may be determined as described elsewhere herein with respect to the determination of the efficiency of the prefilter layer.

In embodiments in which a filter media comprises two or more support layers, a ratio of the efficiency (e.g., efficiency prior to exposure to IPA vapor) of a first support layer (e.g., a support layer adjacent to a main filter layer on a side opposite a prefilter layer) to the efficiency (e.g., efficiency prior to exposure to IPA vapor) of a second support layer (e.g., a support layer adjacent to a prefilter layer on a side opposite a main filter layer) may be less than or equal to 1:1.1, less than or equal to 1:1.3, less than or equal to 1:1.5, less than or equal to 1:2, less than or equal to 1:3, less than or equal to 1:4, less than or equal to 1:5, less than or equal to 1:10, less than or equal to 1:20, less than or equal to 1:30, less than or equal to 1:40, less than or equal to 1:50, less than or equal to 1:60, less than or equal to 1:70, less than or equal to 1:80, less than or equal to 1:90, less than or equal to 1:95, or less than or equal to 1:98. In embodiments in which a filter media comprises two or more support layers, a ratio of the efficiency (e.g., efficiency prior to exposure to IPA vapor) of a first support layer to the efficiency (e.g., efficiency prior to exposure to IPA vapor) of a second support layer may be greater than or equal to 1:99, greater than or equal to 1:98, greater than or equal to 1:95, greater than or equal to 1:90, greater than or equal to 1:80, greater than or equal to 1:70, greater than or equal to 1:60, greater than or equal to 1:50, greater than or equal to 1:40, greater than or equal to 1:30, greater than or equal to 1:20, greater than or equal to 1:10, greater than or equal to 1:5, greater than or equal to 1:4, greater than or equal to 1:3, greater than or equal to 1:2, greater than or equal to 1:1.5, or greater than or equal to 1:1.3. Combinations of these ranges are also possible (e.g., less than or equal to 1:1.1 and greater than or equal to 1:99, less than or equal to 1:1.1 and greater than or equal to 1:50). Other ranges are also possible.

In some embodiments, the ratios described the preceding paragraph are the ratios of the efficiencies at the MPPS. In some embodiments, the ratios described in the preceding paragraph are the ratios of the efficiencies at 0.09 microns. In some embodiments, the ratios described in the preceding paragraph are the ratios of the efficiencies at 0.3 microns. The efficiencies of the one or more support layers at the MPPS. at 0.09 microns, and at 0.3 microns may be determined as described elsewhere herein with respect to the determination of the efficiency of the prefilter layer.

In embodiments in which a filter media comprises two or more support layers, a support layer adjacent to a main filter layer on a side opposite a prefilter layer may have an average pore size of greater than or equal to 0.1 microns, greater than or equal to 0.2 microns, greater than or equal to 0.4 microns, greater than or equal to 0.6 microns, greater than or equal to 0.8 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, greater than or equal to microns, greater than or equal to 50 microns, greater than or equal to 60 microns, greater than or equal to 80 microns, greater than or equal to 100 microns, greater than or equal to 150 microns, greater than or equal to 200 microns, or greater than or equal to 250 microns. In some embodiments, a support layer adjacent to a main filter layer on a side opposite a prefilter layer has an average pore size of less than or equal to 300 microns, less than or equal to 250 microns, less than or equal to 200 microns, less than or equal to 150 microns, less than or equal to 100 microns, less than or equal to 80 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 15 microns, less than or equal to 10 microns, less than or equal to 5 microns, less than or equal to 2 microns, less than or equal to 1 micron, less than or equal to 0.6 microns, less than or equal to 0.4 microns, or less than or equal to 0.2 microns. Combinations of the above-referenced ranges are also possible (e.g., greater than or equal to 0.1 microns and less than or equal to 300 microns, greater than or equal to 1 micron and less than or equal to 100 microns, or greater than or equal to 1 micron and less than or equal to 50 microns). Other ranges are also possible.

In embodiments in which a filter media comprises two or more support layers, a support layer adjacent to a prefilter layer on a side opposite a main filter layer may have an average pore size of greater than or equal to 0.1 microns, greater than or equal to 0.2 microns, greater than or equal to 0.4 microns, greater than or equal to 0.6 microns, greater than or equal to 0.8 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, greater than or equal to microns, greater than or equal to 50 microns, greater than or equal to 60 microns, greater than or equal to 80 microns, greater than or equal to 100 microns, greater than or equal to 150 microns, greater than or equal to 200 microns, or greater than or equal to 250 microns. In embodiments in which a filter media comprises two or more support layers, a support layer adjacent to a prefilter layer on a side opposite a main filter layer may have an average pore size of less than or equal to 300 microns, less than or equal to 250 microns, less than or equal to 200 microns, less than or equal to 150 microns, less than or equal to 100 microns, less than or equal to 80 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 15 microns, less than or equal to 10 microns, less than or equal to 5 microns, less than or equal to 2 microns, less than or equal to 1 micron, less than or equal to 0.6 microns, less than or equal to 0.4 microns, or less than or equal to 0.2 microns. Combinations of the above-referenced ranges are also possible (e.g., greater than or equal to 0.1 microns and less than or equal to 300 microns, greater than or equal to 1 micron and less than or equal to 100 microns, or greater than or equal to 1 micron and less than or equal to 30 microns). Other ranges are also possible.

The average pore size may be measured using ASTM F316 (2003).

In embodiments in which a filter media comprises two or more support layers, a ratio of the average pore size of a first support layer (e.g., a support layer adjacent to a main filter layer on a side opposite a prefilter layer) to the average pore size of a second support layer (e.g., a support layer adjacent to a prefilter layer on a side opposite a main filter layer) may be less than or equal to 1:1.1, less than or equal to 1:1.3, less than or equal to 1:1.5, less than or equal to 1:2, less than or equal to 1:3, less than or equal to 1:4, less than or equal to 1:5, less than or equal to 1:7, less than or equal to 1:10, less than or equal to 1:15, less than or equal to 1:20, less than or equal to 1:25, less than or equal to 1:30, less than or equal to 1:35, less than or equal to 1:40, or less than or equal to 1:45. In embodiments in which a filter media comprises two or more support layers, a ratio of the average pores size of a first support layer to the average pore size a second support layer may be greater than or equal to 1:50, greater than or equal to 1:45, greater than or equal to 1:40, greater than or equal to 1:30, greater than or equal to 1:25, greater than or equal to 1:20, greater than or equal to 1:15, greater than or equal to 1:10, greater than or equal to 1:7, greater than or equal to 1:5, greater than or equal to 1:3, greater than or equal to 1:2, greater than or equal to 1:1.5, or greater than or equal to 1:1.3. Combinations of the above-referenced ranges are also possible (e.g., less than or equal to 1:1.1 and greater than or equal to 1:50). Other ranges are also possible.

In embodiments in which a filter media comprises two or more support layers, a ratio of the normalized surface area of a first support layer (e.g., a support layer adjacent to a main filter layer on a side opposite a prefilter layer) to the normalized surface area of a second support layer (e.g., a support layer adjacent to a prefilter layer on a side opposite a main filter layer) may be less than or equal to 15:1, less than or equal to 14:1, less than or equal to 13:1, less than or equal to 12:1, less than or equal to 11:1, less than or equal to 10:1, less than or equal to 9:1, less than or equal to 8:1, less than or equal to 7:1, less than or equal to 6:1, or less than or equal to 5.5:1. In embodiments in which a filter media comprises two or more support layers, a ratio of the normalized surface area of a first support layer to the normalized surface area of a second support layer may be greater than or equal to 5:1, greater than or equal to 5.5:1, greater than or equal to 6:1, greater than or equal to 7:1, greater than or equal to 8:1, greater than or equal to 9:1, greater than or equal to 10:1, greater than or equal to 11:1, greater than or equal to 12:1, greater than or equal to 13:1, or greater than or equal to 14:1. Combinations of the above-referenced ranges are also possible (e.g., less than or equal to 15:1 and greater than or equal to 5:1). Other ranges are also possible.

In embodiments in which a filter media comprises two or more support layers, a ratio of the average pore size of a prefilter layer to the average pore size of a support layer adjacent to a prefilter layer on a side opposite a main filter layer may be less than or equal to 1:1.3, less than or equal to 1:1.5, less than or equal to 1:2, less than or equal to 1:3, less than or equal to 1:4, less than or equal to 1:5, less than or equal to 1:7, less than or equal to 1:10, less than or equal to 1:15, less than or equal to 1:20, less than or equal to 1:25, less than or equal to 1:30, less than or equal to 1:35, less than or equal to 1:40, or less than or equal to 1:45. In embodiments in which a filter media comprises two or more support layers, a ratio of the average pore size of a prefilter layer to the average pore size of a support layer adjacent to a prefilter layer on a side opposite a main filter layer may be greater than or equal to 1:50, greater than or equal to 1:45, greater than or equal to 1:40, greater than or equal to 1:30, greater than or equal to 1:25, greater than or equal to 1:20, greater than or equal to 1:15, greater than or equal to 1:10, greater than or equal to 1:7, greater than or equal to 1:5, greater than or equal to 1:3, greater than or equal to 1:2, greater than or equal to 1:1.5. Combinations of the above-referenced ranges are also possible (e.g., less than or equal to 1:1.3 and greater than or equal to 1:50). Other ranges are also possible.

As noted above, the filter media described herein may include one or more supplemental layers, e.g., as shown in FIGS. 6-7. For example, a filter media may comprise a supplemental layer that is an oleophobic spacer layer, and/or a supplemental layer that is a coarse meltblown layer. In some cases, a filter media comprises an oleophobic layer that is a non-woven fiber web (e.g., a meltblown layer), a membrane layer, and/or a scrim layer. In some embodiments, one or more supplemental layers present in a filter media (e.g., an oleophobic spacer layer, a coarse meltblown layer) may be charged via a charge process described elsewhere herein, e.g., an electrostatic charging process, a triboelectric charging process, and/or a hydrocharging process.

When present, a supplemental layer (e.g., an oleophobic spacer layer, a coarse meltblown layer) may comprise fibers having any of a variety of suitable average fiber diameters. In some embodiments, the average fiber diameter of the fibers in a supplemental layer is greater than or equal to 0.4 microns, greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 4.5 microns, greater than or equal to 5 microns, greater than or equal to 6 microns, or greater than or equal to 8 microns. In some embodiments, the average fiber diameter of the fibers in a supplemental layer is less than or equal to 10 microns, less than or equal to 8 microns, less than or equal to 6 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, or less than or equal to 0.5 microns. Combinations of the above-referenced ranges are also possible (e.g., greater than or equal to 0.4 microns and less than or equal to 10 microns, greater than or equal to 0.5 microns and less than or equal to 5 microns, greater than or equal to 1 micron and less than or equal to 3 microns). Other ranges are also possible.

When a supplemental layer comprises two or more types of fibers, each type of fiber may independently have an average fiber diameter in one or more of the ranges described above and/or all of the fibers in a supplemental layer may together have an average fiber diameter in one or more of the ranges described above. Similarly, when a filter media comprises two or more supplemental layers, each supplemental layer may independently comprise one or more types of fibers having an average fiber diameter in one or more of the ranges described above and/or may comprise fibers that overall have an average fiber diameter in one or more of the ranges described above. In embodiments in which a filter media comprises two or more supplemental layers, the average fiber diameters of the two or more supplemental layers may be the same or different.

In some embodiments, the fibers in a supplemental layer are continuous fibers, such as the continuous fibers described elsewhere herein as being suitable for inclusion in fine fiber layers. In one set of embodiments, the one or more supplemental layers comprises meltblown fibers.

When present, a supplemental layer (e.g., an oleophobic spacer layer, a coarse meltblown layer) may comprise synthetic fibers. The synthetic fibers may include any suitable type of synthetic polymer. Examples of suitable synthetic fibers include polyesters (e.g., polyethylene terephthalate, polybutylene terephthalate), polycarbonate, polyamides (e.g., various nylon polymers), polyaramid, polyimide, polyethylene, polypropylene, polyether ether ketone, polyolefin, acrylics, polyvinyl alcohol, regenerated cellulose (e.g., synthetic cellulose such lyocell, rayon), polyacrylonitriles, polyvinylidene fluoride (PVDF), copolymers of polyethylene and PVDF, polyether sulfones, and combinations thereof. In some embodiments, the synthetic fibers are organic polymer fibers. Synthetic fibers may also include multi-component fibers (i.e., fibers having multiple compositions such as bicomponent fibers). In some cases, synthetic fibers may include meltblown, meltspun, electrospun (e.g., melt, solvent), or centrifugal spun fibers, which may be formed of polymers described herein (e.g., polyester, polypropylene). In some embodiments, synthetic fibers may be electrospun fibers. The supplemental layer, when present, may also include combinations of more than one type of synthetic fiber. It should be understood that other types of synthetic fiber types may also be used.

In some embodiments, synthetic fibers make up greater than or equal to 80 wt. %, greater than or equal to 82.5 wt. %, greater than or equal to 85 wt. %, greater than or equal to 87.5 wt. %, greater than or equal to 90 wt. %, greater than or equal to 92 wt. %, greater than or equal to 94 wt. %, greater than or equal to 95 wt. %, greater than or equal to 96 wt. %, greater than or equal to 97 wt. %, greater than or equal to 98 wt. %, or greater than or equal to 99 wt. % of a supplemental layer. In some embodiments, synthetic fibers make up less than or equal to 100 wt. %, less than or equal to 99 wt. %, less than or equal to 98 wt. %, less than or equal to 97 wt. %, less than or equal to 96 wt. %, less than or equal to 95 wt. %, less than or equal to 94 wt. %, less than or equal to 92 wt. %, less than or equal to 90 wt. %, less than or equal to 87.5 wt. %, or less than or equal to 85 wt. % of a supplemental layer. Combinations of the above-referenced ranges are also possible (e.g., greater than or equal to 80 wt. % and less than or equal to 100 wt. %, greater than or equal to 80 wt. % and less than or equal to 99 wt. %, greater than or equal to 85 wt. % and less than or equal to 96 wt. %, or greater than or equal to 90 wt. % and less than or equal to 95 wt. %). Other ranges are also possible. In some embodiments, synthetic fibers make up exactly 100 wt. % of a supplemental layer.

When a supplemental layer comprises two or more types of synthetic fibers, each type of synthetic fiber may independently make up an amount of the supplemental layer in one or more of the ranges described above and/or all of the synthetic fibers in a supplemental layer may together make up an amount of the supplemental layer in one or more of the ranges described above. Similarly, when a filter media comprises two or more supplemental layers, each supplemental layer may independently comprise one or more types of synthetic fibers in one or more of the ranges described above and/or may comprise synthetic fibers that overall make up an amount of the supplemental layer in one or more of the ranges described above. In embodiments in which a filter media comprises two or more supplemental layers, the amounts of synthetic fibers in the two or more supplemental layers may be the same or different.

When present, a supplemental layer (e.g., an oleophobic spacer layer, a coarse meltblown layer) may comprise one or more additives. In some embodiments, such as embodiments in which the supplemental layer is a meltblown layer, the supplemental layer may comprise wax. For example, wax may make up greater than or equal to 1 wt. %, greater than or equal to 1.5 wt. %, greater than or equal to 2 wt. %, greater than or equal to 2.5 wt. %, greater than or equal to 3 wt. %, or greater than or equal to 3.5 wt. % of the supplemental layer. For example, wax may make up less than or equal to 4 wt. %, less than or equal to 3.5 wt. %, less than or equal to 3 wt. %, less than or equal to 2.5 wt. %, less than or equal to 2 wt. %, or less than or equal to 1.5 wt. % of the supplemental layer. Combination of the above-referenced ranges are also possible (e.g., greater than or equal to 1 wt. % and less than or equal to 4 wt. %). Other ranges are also possible.

When a filter media comprises two or more supplemental layers, each supplemental layer may independently comprise wax in one or more of the above-referenced ranges. In embodiments in which a filter media comprises two or more supplemental layers, the amounts of wax in the two or more supplemental layers may be the same or different.

In some embodiments, a supplemental layer may comprise a charge additive and/or an oleophobic additive (e.g., a fluorocarbon additive), such as those described elsewhere herein with respect to the prefilter layer.

A supplemental layer (e.g., an oleophobic spacer layer, a coarse meltblown layer) described herein may have any of a variety of suitable porosities (i.e., void volumes). In some embodiments, each of the one or more supplemental layers may independently have a porosity in one or more of the ranges described elsewhere herein with respect to a prefilter layer (e.g., greater than or equal to 80% and less than or equal to 99%, greater than or equal to 85% and less than or equal to 96%, or greater than or equal to 90% and less than or equal to 95%).

When a filter media comprises two or more supplemental layers, each supplemental layer may independently have a porosity in one or more of the above-referenced ranges. In embodiments in which a filter media comprises two or more supplemental layers, the porosities of the two or more supplemental layers may be the same or different.

The porosity of a supplemental layer may be determined as described elsewhere herein with respect to a prefilter layer.

A supplemental layer (e.g., an oleophobic spacer layer, a coarse meltblown layer) described herein may have any suitable normalized surface area. In some embodiments, a supplemental layer has a normalized surface area of greater than or equal to 1 m²/m², greater than or equal to 2 m²/m², greater than or equal to 3 m²/m², greater than or equal to 5 m²/m², greater than or equal to 10 m²/m², greater than or equal to 15 m²/m², greater than or equal to 20 m²/m², greater than or equal to 25 m²/m², greater than or equal to 30 m²/m², greater than or equal to 35 m²/m², greater than or equal to 40 m²/m², or greater than or equal to 45 m²/m². In some embodiments, a supplemental layer has a normalized surface area of less than or equal to 50 m²/m², less than or equal to 45 m²/m², less than or equal to 40 m²/m², less than or equal to 35 m²/m², less than or equal to 30 m²/m², less than or equal to 25 m²/m², less than or equal to 20 m²/m², less than or equal to 15 m²/m², less than or equal to 10 m²/m², less than or equal to 5 m²/m², less than or equal to 3 m²/m², or less than or equal to 2 m²/m². Combinations of the above-referenced ranges are also possible (e.g., greater than or equal to 1 m²/m² and less than or equal to 50 m²/m², greater than or equal to 1 m²/m² and less than or equal to 40 m²/m², or greater than or equal to 1 m²/m² and less than or equal to 30 m²/m²). Other ranges are also possible.

When a filter media comprises two or more supplemental layers, each supplemental layer may independently have a normalized surface area in one or more of the above-referenced ranges. In embodiments in which a filter media comprises two or more supplemental layers, the normalized surface areas of the two or more supplemental layers may be the same or different.

The normalized surface area of a supplemental layer may be determined as described elsewhere herein with respect to a prefilter layer.

A supplemental layer (e.g., an oleophobic spacer layer, a coarse meltblown layer) described herein may have any of a variety of suitable thicknesses. In some embodiments, a supplemental layer has a thickness that is smaller than the thickness of a prefilter layer also present in the filter media. In some embodiments, a supplemental layer has a thickness of greater than or equal to 0.05 mm, greater than or equal to 0.06 mm, greater than or equal to 0.07 mm, greater than or equal to 0.08 mm, greater than or equal to 0.1 mm, greater than or equal to 0.13 mm, greater than or equal to 0.15 mm, greater than or equal to 0.2 mm, greater than or equal to 0.25 mm, greater than or equal to 0.3 mm, greater than or equal to 0.35 mm, greater than or equal to 0.38 mm, greater than or equal to 0.4 mm, greater than or equal to 0.5 mm, greater than or equal to 0.6 mm, or greater than or equal to 0.8 mm. In some embodiments, a supplemental layer has a thickness of less than or equal to 1 mm, less than or equal to 0.8 mm, less than or equal to 0.6 mm, less than or equal to 0.4 mm, less than or equal to 0.38 mm, less than or equal to 0.35 mm, less than or equal to 0.3 mm, less than or equal to 0.25 mm, less than or equal to 0.2 mm, less than or equal to 0.15 mm, less than or equal to 0.13 mm, less than or equal to 0.1 mm, less than or equal to 0.08 mm, less than or equal to 0.07 mm, or less than or equal to 0.06 mm. Combinations of the above-referenced ranges are also possible (e.g., greater than or equal to 0.05 mm and less than or equal to 1 mm, greater than or equal to 0.07 mm and less than or equal to 0.6 mm, or greater than or equal to 0.13 mm and less than or equal to 0.38 mm). Other ranges are also possible.

When a filter media comprises two or more supplemental layers, each supplemental layer may independently have a thickness in one or more of the above-referenced ranges. In embodiments in which a filter media comprises two or more supplemental layers, the thicknesses of the two or more supplemental layers may be the same or different.

The thickness of a supplemental layer may be determined in accordance with ASTM D1777 (2015) under an applied pressure of 0.8 kPa.

A supplemental layer (e.g., an oleophobic spacer layer, a coarse meltblown layer) described herein may have any of a variety of suitable basis weights. In some embodiments, a supplemental layer has a basis weight that is smaller than the basis weight of a prefilter layer also present in the filter media. In some embodiments, a supplemental layer has a basis weight of greater than or equal to 0.5 gsm, greater than or equal to 1 gsm, greater than or equal to 3 gsm, greater than or equal to 5 gsm, greater than or equal to 7 gsm, greater than or equal to 10 gsm, greater than or equal to 15 gsm, greater than or equal to 20 gsm, greater than or equal to 25 gsm, greater than or equal to 30 gsm, greater than or equal to 35 gsm, greater than or equal to 40 gsm, or greater than or equal to 45 gsm. In some embodiments, a supplemental layer has a basis weight of less than or equal to 50 gsm, less than or equal to 45 gsm, less than or equal to 40 gsm, less than or equal to 35 gsm, less than or equal to 30 gsm, less than or equal to 25 gsm, less than or equal to 20 gsm, less than or equal to 15 gsm, less than or equal to 10 gsm, less than or equal to 7 gsm, less than or equal to 5 gsm, less than or equal to 3 gsm, or less than or equal to 1 gsm. Combinations of the above-referenced ranges are also possible (e.g., greater than or equal to 0.5 gsm and less than or equal to 50 gsm, greater than or equal to 5 gsm and less than or equal to 35 gsm, or greater than or equal to 10 gsm and less than or equal to 25 gsm). Other ranges are also possible.

When a filter media comprises two or more supplemental layers, each supplemental layer may independently have a basis weight in one or more of the above-referenced ranges. In embodiments in which a filter media comprises two or more supplemental layers, the basis weights of the two or more supplemental layers may be the same or different.

Basis weight may be measured according to ASTM D3776M-20.

A supplemental layer (e.g., an oleophobic spacer layer, a coarse meltblown layer) described herein may have any of a variety of suitable air permeabilities. In some embodiments, a supplemental layer has an air permeability of greater than or equal to 1 CFM, greater than or equal to 2.5 CFM, greater than or equal to 5 CFM, greater than or equal to 7.5 CFM, greater than or equal to 10 CFM, greater than or equal to 25 CFM, greater than or equal to 50 CFM, greater than or equal to 100 CFM, greater than or equal to 150 CFM, greater than or equal to 200 CFM, greater than or equal to 300 CFM, greater than or equal to 400 CFM, greater than or equal to 500 CFM, greater than or equal to 600 CFM, greater than or equal to 700 CFM, greater than or equal to 800 CFM, greater than or equal to 900 CFM, greater than or equal to 1000 CFM, greater than or equal to 1100 CFM, greater than or equal to 1200 CFM, greater than or equal to 1300 CFM, or greater than or equal to 1400 CFM. In some embodiments, a supplemental layer has an air permeability of less than or equal to 1500 CFM, less than or equal to 1400 CFM, less than or equal to 1300 CFM, less than or equal to 1200 CFM, less than or equal to 1100 CFM, less than or equal to 1000 CFM, less than or equal to 900 CFM, less than or equal to 800 CFM, less than or equal to 700 CFM, less than or equal to 600 CFM, less than or equal to 500 CFM, less than or equal to 400 CFM, less than or equal to 300 CFM, less than or equal to 200 CFM, less than or equal to 150 CFM, less than or equal to 100 CFM, less than or equal to 50 CFM, less than or equal to 25 CFM, less than or equal to 10 CFM, less than or equal to 7.5 CFM, less than or equal to 5 CFM, or less than or equal to 2.5 CFM. Combinations of the above-referenced ranges are also possible (e.g., greater than or equal to 1 CFM and less than or equal to 1500 CFM, greater than or equal to 5 CFM and less than or equal to 1000 CFM, or greater than or equal to 10 CFM and less than or equal to 600 CFM). Other ranges are also possible.

When a filter media comprises two or more supplemental layers, each supplemental layer may independently have an air permeability in one or more of the above-referenced ranges. In embodiments in which a filter media comprises two or more supplemental layers, the air permeabilities of the two or more supplemental layers may be the same or different.

Air permeability may be measured according to ASTM D737-04 (2016) at a pressure of 125 Pa.

A supplemental layer (e.g., an oleophobic spacer layer, a coarse meltblown layer) described herein may have any of a variety of suitable average pore sizes. In some embodiments, a supplemental layer has an average pore size of greater than or equal to 1 micron, greater than or equal to 2 microns, greater than or equal to 3 microns, greater than or equal to 5 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to microns, greater than or equal to 35 microns, greater than or equal to 40 microns, or greater than or equal to 45 microns. In some embodiments, a supplemental layer has an average pore size of less than or equal to 50 microns, less than or equal to 45 microns, less than or equal to 40 microns, less than or equal to 35 microns, less than or equal to 30 microns, less than or equal to microns, less than or equal to 20 microns, less than or equal to 17.5 microns, less than or equal to 15 microns, less than or equal to 12.5 microns, less than or equal to 10 microns, less than or equal to 8 microns, less than or equal to 5 microns, less than or equal to 3 microns, or less than or equal to 2 microns. Combinations of the above-referenced ranges are also possible (e.g., greater than or equal to 1 micron and less than or equal to 50 microns, greater than or equal to 2 microns and less than or equal to 30 microns, greater than or equal to 5 microns and less than or equal to 20 microns, greater than or equal to 4 microns and less than or equal to 25 microns, or greater than or equal to 8 microns and less than or equal to 15 microns). Other ranges are also possible.

When a filter media comprises two or more supplemental layers, each supplemental layer may independently have an average pore size in one or more of the above-referenced ranges. In embodiments in which a filter media comprises two or more supplemental layers, the average pore sizes of the two or more supplemental layers may be the same or different.

The average pore size may be measured using ASTM F₃₁₆ (2003).

In embodiments in which a filter media comprises a supplemental layer that is an oleophobic spacer layer, the oleophobic spacer layer may have an average pore size in one or more of the above-referenced ranges (e.g., greater than or equal to 1 micron and less than or equal to 50 microns, greater than or equal to 4 microns and less than or equal to 25 microns, or greater than or equal to 8 microns and less than or equal to 15 microns). In embodiments in which a filter media comprises a supplemental layer that is a coarse meltblown layer, the coarse meltblown layer may have an average pore size in one or more of the above-referenced ranges (e.g., greater than or equal to 1 micron and less than or equal to 50 microns, greater than or equal to 2 microns and less than or equal to 30 microns, or greater than or equal to 5 microns and less than or equal to 20 microns).

A supplemental layer (e.g., an oleophobic spacer layer, a coarse meltblown layer) described herein may have any suitable efficiency (e.g., efficiency prior to exposure to IPA vapor). In some embodiments, a supplemental layer has an efficiency (e.g., efficiency prior to exposure to IPA vapor) of greater than or equal to 1%, greater than or equal to 3%, greater than or equal to 5%, greater than or equal to 7%, greater than or equal to 10%, greater than or equal to 25%, greater than or equal to 50%, greater than or equal to 75%, greater than or equal to 80%, greater than or equal to 85%, greater than or equal to 90%, greater than or equal to 95%, greater than or equal to 99%, greater than or equal to 99.9%, greater than or equal to 99.95%, greater than or equal to 99.99%, greater than or equal to 99.995%, or greater than or equal to 99.999%. In some embodiments, a supplemental layer has an efficiency (e.g., efficiency prior to exposure to IPA vapor) of less than or equal to 99.9995%, less than or equal to 99.999%, less than or equal to 99.995%, less than or equal to 99.99%, less than or equal to 99.95%, less than or equal to 99.9%, less than or equal to 99%, less than or equal to 95%, less than or equal to 90%, less than or equal to 85%, less than or equal to 80%, less than or equal to 75%, less than or equal to 50%, less than or equal to 25%, less than or equal to 10%, less than or equal to 7%, less than or equal to 5%, or less than or equal to 3%. Combinations of the above-referenced ranges are also possible (e.g., greater than or equal to 1% and less than or equal to 99.9995%, greater than or equal to 5% and less than or equal to 99.995%, or greater than or equal to 5% and less than or equal to 99.95%). Other ranges are also possible.

In some embodiments, the efficiencies described in the preceding paragraph are efficiencies at the MPPS. In some embodiments, the efficiencies described in the preceding paragraph are efficiencies at 0.09 microns. In some embodiments, the efficiencies described in the preceding paragraph are efficiencies at 0.3 microns.

When a filter media comprises two or more supplemental layers, each supplemental layer may independently have an efficiency in one or more of the above-referenced ranges. In embodiments in which a filter media comprises two or more supplemental layers, the efficiencies of the two or more supplemental layers may be the same or different.

The efficiencies at the MPPS, at 0.09 microns, and at 0.3 microns of the one or more supplemental layers may be determined as described elsewhere herein with respect to the determination of the efficiency of the prefilter layer.

A supplemental layer (e.g., an oleophobic spacer layer, a coarse meltblown layer) described herein may have any suitable efficiency metric (e.g., efficiency metric prior to exposure to IPA vapor). In some embodiments, a supplemental layer has an efficiency metric (e.g., efficiency metric prior to exposure to IPA vapor) of greater than or equal to 0.1, greater than or equal to 0.3, greater than or equal to 0.5, greater than or equal to 0.7, greater than or equal to 1, greater than or equal to 2, greater than or equal to 3, greater than or equal to 4, greater than or equal to 5, or greater than or equal to 6. In some embodiments, a supplemental layer has an efficiency metric (e.g., efficiency metric prior to exposure to IPA vapor) of less than or equal to 7, less than or equal to 6, less than or equal to 5, less than or equal to 4, less than or equal to 3, less than or equal to 2, less than or equal to 1, less than or equal to 0.7, less than or equal to 0.5, or less than or equal to 0.3. Combinations of the above-referenced ranges are also possible (e.g., greater than or equal to 0.1 and less than or equal to 7, greater than or equal to 0.5 and less than or equal to 5, or greater than or equal to 1 and less than or equal to 5). Other ranges are also possible.

When a filter media comprises two or more supplemental layers, each supplemental layer may independently have an efficiency metric in one or more of the above-referenced ranges. In embodiments in which a filter media comprises two or more supplemental layers, the efficiency metrics of the two or more supplemental layers may be the same or different.

The efficiency metric of the one or more supplemental layers may be determined as described elsewhere herein with respect to the determination of the efficiency metric of the prefilter layer. This involves employing the same equation described elsewhere herein for determining the efficiency metric of a prefilter layer (i.e., −log (% penetration(DOP)/100), where the penetration is determined as described elsewhere herein with respect to the determination of efficiency of the prefilter layer using DOP particles having an average diameter of 0.09 microns).

A supplemental layer (e.g., an oleophobic spacer layer, a coarse meltblown layer) described herein any suitable pressure drop (e.g., average pressure drop). In some embodiments, a supplemental layer has a pressure drop of greater than or equal to 0.0001 kPa, greater than or equal to 0.0005 kPa, greater than or equal to 0.001 kPa, greater than or equal to 0.005 kPa, greater than or equal to 0.01 kPa, greater than or equal to 0.02 kPa, greater than or equal to 0.025 kPa, greater than or equal to 0.03 kPa, or greater than or equal to 0.035 kPa. In some embodiments, a supplemental layer has a pressure drop of less than or equal to 0.04 kPa, less than or equal to 0.035 kPa, less than or equal to 0.03 kPa, less than or equal to 0.025 kPa, less than or equal to 0.02 kPa, less than or equal to 0.01 kPa, less than or equal to 0.005 kPa, less than or equal to 0.001 kPa, or less than or equal to 0.0005 kPa. Combinations of the above-referenced ranges are also possible (e.g., greater than or equal to 0.0001 kPa and less than or equal to 0.04 kPa, greater than or equal to 0.001 kPa and less than or equal to 0.03 kPa, or greater than or equal to 0.001 kPa and less than or equal to 0.025 kPa). Other ranges are also possible.

When a filter media comprises two or more supplemental layers, each supplemental layer may independently have a pressure drop in one or more of the above-referenced ranges. In embodiments in which a filter media comprises two or more supplemental layers, the pressure drops of the two or more supplemental layers may be the same or different.

The pressure drop of a supplemental layer may be determined as described elsewhere herein with respect to the determination of the pressure drop of the prefilter layer.

A supplemental layer (e.g., an oleophobic spacer layer, a coarse meltblown layer) described herein may have any suitable ratio of initial efficiency metric to mechanical (discharged) efficiency metric. In some embodiments, a supplemental layer has a ratio of initial efficiency metric to mechanical (discharged) efficiency metric of greater than or equal to 0.1, greater than or equal to 0.5, greater than or equal to 1, greater than or equal to 1.5, greater than or equal to 2, or greater than or equal to 2.5. In some embodiments, a supplemental layer has a ratio of initial efficiency metric to mechanical (discharged) efficiency metric of less than or equal to 3, less than or equal to 2.5, less than or equal to 2, less than or equal to 1.5, less than or equal to 1, or less than or equal to 0.5. Combinations of the above-referenced ranges are also possible (e.g., greater than or equal to 0.1 and less than or equal to 3). Other ranges are also possible.

When a filter media comprises two or more supplemental layers, each supplemental layer may independently have a ratio of initial efficiency metric to mechanical (discharged) efficiency metric in one or more of the above-referenced ranges. In embodiments in which a filter media comprises two or more supplemental layers, this ratio may be the same for the two or more supplemental layers or the two or more supplemental layers may have different values thereof.

The ratio of initial efficiency metric to mechanical (discharged) efficiency metric of a supplemental layer may be determined as described elsewhere herein with respect to the determination of the ratio of initial efficiency metric to mechanical (discharged) efficiency metric of the prefilter layer.

As noted above, a filter media may comprise a supplemental layer that is a coarse meltblown layer. Coarse meltblown layers may be positioned at a variety of suitable locations, such as downstream from a prefilter layer (e.g., a meltblown prefilter layer). Additionally, coarse meltblown layer may have one or more properties (e.g., average fiber diameter, porosity, average pore size, etc.) that differ from one or more other meltblown layers also positioned in the filter media (e.g., a prefilter layer). In some embodiments, a coarse meltblown layer comprises fibers having a larger average diameter than the fibers in a prefilter layer (e.g., a meltblown prefilter layer). For instance, a coarse meltblown layer may comprise fibers having any suitable average fiber average diameter described elsewhere herein with respect to supplemental layers (e.g., greater than or equal to 0.4 microns and less than or equal to 10 microns, greater than or equal to 0.5 microns and less than or equal to 5 microns, greater than or equal to 1 micron and less than or equal to 3 microns).

In embodiments in which a filter media comprises a coarse meltblown layer and a prefilter layer (e.g., a meltblown prefilter layer), the coarse meltblown layer may be formed from a first type of polymeric resin and the prefilter layer may be formed from a second type of polymeric resin. In some cases, the first type of polymeric resin may have a lower melt flow index (MFI) than the second of type of polymer resin. Such a difference in the melt flow index between the two types of polymeric resins may, for example, lead to a difference in the fiber structure and/or porosity of the resulting meltblown layers. For example, compared to a meltblown prefilter layer, a coarse meltblown layer may have a higher porosity, a higher mechanical strength, and/or better fiber tie down. In some cases, a layer with better fiber tie down may have a lower amount of loose fibers present on its surface and/or a smoother surface compared to a layer with poorer fiber tie down. In some embodiments, the first type of polymeric resin may have a relatively low melt flow index (MFI) (e.g., between 1 MFI and 500 MFI). In some embodiments, the second type of polymeric resin may have a relatively high melt flow index (MFI) (e.g., greater than 1000 MFI).

The filter media described herein may have any of a variety of suitable thicknesses. In some embodiments, a filter media has a thickness of greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.8 mm, greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, greater than or equal to 7.5 mm, greater than or equal to 10 mm, greater than or equal to 15 mm, greater than or equal to 20 mm, or greater than or equal to 25 mm. In some embodiments, a filter media has a thickness of less than or equal to 30 mm, less than or equal to 25 mm, less than or equal to 20 mm, less than or equal to 15 mm, less than or equal to 10 mm, less than or equal to 7.5 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, less than or equal to 1.5 mm, less than or equal to 1 mm, less than or equal to 0.8 mm, less than or equal to 0.6 mm, greater than or equal to 0.5 mm, less than or equal to 0.4 mm, less than or equal to 0.3 mm, or less than or equal to 0.2 mm. Combinations of the above-referenced ranges are also possible (e.g., greater than or equal to 0.1 mm and less than or equal to 30 mm, greater than or equal to 0.1 mm and less than or equal to 5 mm, greater than or equal to 0.2 mm and less than or equal to 3 mm, or greater than or equal to 0.3 mm and less than or equal to 1 mm). Other ranges are also possible.

The thickness of a filter media may be determined in accordance with ASTM D1777 (2015) under an applied pressure of 0.8 kPa.

The filter media described herein may have any of a variety of suitable basis weights. For example, in some embodiments, a filter media has a basis weight of greater than or equal to gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 200 gsm, greater than or equal to 250 gsm, greater than or equal to 300 gsm, greater than or equal to 350 gsm, greater than or equal to 400 gsm, or greater than or equal to 450 gsm. In some embodiments, a filter media has a basis weight of less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 125 gsm, less than or equal to 100 gsm, less than or equal to 75 gsm, less than or equal to 50 gsm, less than or equal to 40 gsm, or less than or equal to 30 gsm. Combinations of the above-referenced ranges are also possible (e.g., greater than or equal to 20 gsm and less than or equal to 500 gsm, greater than or equal to 20 gsm and less than or equal to 300 gsm, greater than or equal to 30 gsm and less than or equal to 250 gsm, or greater than or equal to 40 gsm and less than or equal to 150 gsm). Other ranges are also possible.

The basis weight of the filter media may be measured according to ISO 536 (2012).

The filter media described herein may have any of a variety of suitable air permeabilities. In some embodiments, a filter media has an air permeability of greater than or equal to 1 CFM, greater than or equal to 1.5 CFM, greater than or equal to 1.75 CFM, greater than or equal to 2 CFM, greater than or equal to 5 CFM, greater than or equal to 10 CFM, greater than or equal to CFM, greater than or equal to 40 CFM, greater than or equal to 60 CFM, greater than or equal to 80 CFM, greater than or equal to 100 CFM, greater than or equal to 250 CFM, greater than or equal to 500 CFM, or greater than or equal to 750 CFM. In some embodiments, a filter media has an air permeability of less than or equal to 1000 CFM, less than or equal to 750 CFM, less than or equal to 500 CFM, less than or equal to 250 CFM, less than or equal to 100 CFM, less than or equal to 80 CFM, less than or equal to 60 CFM, less than or equal to 40 CFM, less than or equal to 20 CFM, less than or equal to 10 CFM, less than or equal to 5 CFM, less than or equal to 2 CFM, or less than or equal to 1.5 CFM. Combinations of the above-referenced ranges are also possible (e.g., greater than or equal to 1 CFM and less than or equal to 1000 CFM, greater than or equal to 1.5 CFM and less than or equal to 500 CFM, or greater than or equal to 2 CFM and less than or equal to 100 CFM). Other ranges are also possible.

Air permeability may be measured according to ASTM D737-04 (2016) at a pressure of 125 Pa.

The filter media described herein may have any suitable pressure drop (e.g., average pressure drop). In some cases, the filter media described herein may have a relatively low pressure drop. In some embodiments, a filter media has a pressure drop of greater than or equal to 0.02 kPa, greater than or equal to 0.03 kPa, greater than or equal to 0.04 kPa, greater than or equal to 0.05 kPa, greater than or equal to 0.06 kPa, greater than or equal to 0.08 kPa, greater than or equal to 0.1 kPa, greater than or equal to 0.11 kPa, greater than or equal to 0.13 kPa, greater than or equal to 0.15 kPa, greater than or equal to 0.17 kPa, greater than or equal to 0.2 kPa, greater than or equal to 0.25 kPa, greater than or equal to 0.3 kPa, or greater than or equal to 0.35 kPa. In some embodiments, a filter media has a pressure drop of less than or equal to 0.4 kPa, less than or equal to 0.35 kPa, less than or equal to 0.3 kPa, less than or equal to 0.25 kPa, less than or equal to 0.2 kPa, less than or equal to 0.15 kPa, less than or equal to 0.13 kPa, less than or equal to 0.11 kPa, less than or equal to 0.1 kPa, less than or equal to 0.08 kPa, less than or equal to 0.06 kPa, less than or equal to 0.05 kPa, less than or equal to 0.04 kPa, or less than or equal to 0.03 kPa. Combinations of the above-referenced ranges are also possible (e.g., greater than or equal to 0.02 kPa and less than or equal to 0.4 kPa, greater than or equal to 0.04 kPa and less than or equal to 0.15 kPa, or greater than or equal to 0.06 kPa and less than or equal to 0.11 kPa). Other ranges are also possible.

The pressure drop of a filter media layer may be determined as described elsewhere herein with respect to the pressure drop of a prefilter layer.

The filter media described herein may have any suitable efficiency (e.g., efficiency prior to exposure to IPA vapor). In some embodiments, a filter media has an efficiency (e.g., efficiency prior to exposure to IPA vapor) of greater than or equal to 85%, greater than or equal to 90%, greater than or equal to 95%, greater than or equal to 97%, greater than or equal to 98%, greater than or equal to 99%, greater than or equal to 99.5%, greater than or equal to 99.9%, greater than or equal to 99.95%, greater than or equal to 99.99%, greater than or equal to 99.995%, greater than or equal to 99.999%, greater than or equal to 99.9995%, greater than or equal to 99.9999%, or greater than or equal to 99.99995%. In some embodiments, a filter media has an efficiency (e.g., efficiency prior to exposure to IPA vapor) of less than 100%, less than or equal to 99.99995%, less than or equal to 99.9999%, less than or equal to 99.9995%, less than or equal to 99.999%, less than or equal to 99.995%, less than or equal to 99.99%, less than or equal to 99.95%, less than or equal to 99.9%, less than or equal to 99.5%, less than or equal to 99%, less than or equal to 98%, less than or equal to 97%, less than or equal to 95%, or less than or equal to 90%. Combinations of the above-referenced ranges are also possible (e.g., greater than or equal to 85% and less than 99.99995%, greater than or equal to 95% and less than 99.99995%, or greater than or equal to 99.5% and less than or equal to 99.99995%). Other ranges are also possible.

In some embodiments, the efficiencies described in the preceding paragraph are efficiencies at the MPPS. In some embodiments, the efficiencies described in the preceding paragraph are efficiencies at 0.09 microns. In some embodiments, the efficiencies described in the preceding paragraph are efficiencies at 0.3 microns. The efficiencies (e.g., efficiency prior to exposure to IPA vapor) of a filter media at the MPPS, at 0.09 microns, and at 0.3 microns may be determined as described elsewhere herein with respect to the efficiency of a prefilter layer. In some embodiments, the filter media is a HEPA filter. The filter media described herein may have any suitable mechanical (discharged) HEPA efficiency. In some embodiments, a filter media has a mechanical (discharged) efficiency of greater than or equal to 99.95%, greater than or equal to 99.99%, greater than or equal to 99.995%, greater than or equal to 99.999%, greater than or equal to 99.9995%, greater than or equal to 99.9999%, greater than or equal to 99.99995%. In some embodiments, a filter media has a mechanical (discharged) HEPA efficiency of less than 100%, less than or equal to 99.99995%, less than or equal to 99.9999%, less than or equal to 99.9995%, less than or equal to 99.999%, less than or equal to 99.995%, or less than or equal to 99.99%. Combinations of these ranges are also possible (e.g., greater than or equal to 99.95% and less than 99.99995%, greater than or equal to 99.95% and less than 99.995%, or greater than or equal to 99.9995% and less than or equal to 99.99995%). Other ranges are also possible.

In some embodiments, the mechanical (discharged) efficiencies described in the preceding paragraph are mechanical (discharged) efficiencies at the MPPS. In some embodiments, the mechanical (discharged) efficiencies described in the preceding paragraph are efficiencies at 0.09 microns. In some embodiments, the mechanical (discharged) efficiencies described in the preceding paragraph are efficiencies at 0.3 microns.

The mechanical (discharged) efficiency a filter media may be determined as described elsewhere herein with respect to the mechanical (discharged) efficiency of a prefilter layer.

The filter media layer described herein may have any suitable ratio of efficiency metric (e.g., efficiency metric prior to IPA vapor exposure) to mechanical (discharged) efficiency metric. In some embodiments, a filter media has a ratio of efficiency metric (e.g., initial efficiency metric) to mechanical (discharged) efficiency metric of greater than or equal to 1, greater than or equal to 1.1, greater than or equal to 1.25, greater than or equal to 1.5, greater than or equal to 2, greater than or equal to 2.5, greater than or equal to 3, greater than or equal to 3.5, greater than or equal to 4, greater than or equal to 4.5, greater than or equal to 5, greater than or equal to 5.5, greater than or equal to 6, or greater than or equal to 6.5. In some embodiments, a filter media has a ratio of efficiency metric (e.g., efficiency metric prior to IPA vapor exposure) to mechanical (discharged) efficiency metric of less than or equal to 7, less than or equal to 6.5, less than or equal to 6, less than or equal to 5.5, less than or equal to 5, less than or equal to 4.5, less than or equal to 4, less than or equal to 3.5, less than or equal to 3, less than or equal to 2.5, less than or equal to 2, less than or equal to 1.5, less than or equal to 1.25, or less than or equal to 1.1. Combinations of the above-referenced ranges are also possible (e.g., greater than or equal to 1 and less than or equal to 7, greater than or equal to 2 and less than or equal to 6, or greater than or equal to 3 and less than or equal to 5). Other ranges are also possible.

In some embodiments, the ratios described the preceding paragraph are the ratios of the efficiencies at the MPPS. In some embodiments, the ratios described in the preceding paragraph are the ratios of the efficiencies at 0.09 microns. In some embodiments, the ratios described in the preceding paragraph are the ratios of the efficiencies at 0.3 microns. The efficiencies of the filter media at the MPPS, at 0.09 microns, and at 0.3 microns may be determined as described elsewhere herein with respect to the determination of the efficiency of the prefilter layer.

The filter media layer described herein may have any suitable thermal PAO loading capacity. In some embodiments, a filter media has a thermal PAO loading capacity of greater than or equal to 10 g/m², greater than or equal to 11 g/m², greater than or equal to 12 g/m², greater than or equal to 13 g/m², greater than or equal to 15 g/m², greater than or equal to 17 g/m², greater than or equal to 20 g/m², greater than or equal to 25 g/m², greater than or equal to 30 g/m², greater than or equal to 35 g/m², greater than or equal to 40 g/m², greater than or equal to 45 g/m², greater than or equal to 50 g/m², greater than or equal to 55 g/m², greater than or equal to 60 g/m², greater than or equal to 65 g/m², greater than or equal to 70 g/m², greater than or equal to 75 g/m², greater than or equal to 80 g/m², greater than or equal to 85 g/m², greater than or equal to 90 g/m², or greater than or equal to 95 g/m². In some embodiments, a filter media has a thermal PAO loading capacity of less than or equal to 100 g/m², less than or equal to 95 g/m², less than or equal to 90 g/m², less than or equal to 85 g/m², less than or equal to 80 g/m², less than or equal to 75 g/m², less than or equal to 70 g/m², less than or equal to 65 g/m², less than or equal to 60 g/m², less than or equal to 55 g/m², less than or equal to 50 g/m², less than or equal to 45 g/m², less than or equal to 40 g/m², less than or equal to 35 g/m², less than or equal to 30 g/m², less than or equal to 25 g/m², less than or equal to 20 g/m², less than or equal to 17 g/m², less than or equal to 15 g/m², less than or equal to 13 g/m², less than or equal to 12 g/m², or less than or equal to 11 g/m². Combination of the above-referenced ranges are also possible (e.g., greater than or equal to 10 g/m² and less than or equal to 100 g/m², greater than or equal to 20 g/m² and less than or equal to 100 g/m², greater than or equal to 12 g/m² and less than or equal to 70 g/m², greater than or equal to 15 g/m² and less than or equal to 40 g/m²). Other ranges are also possible.

The thermal PAO loading capacity of a filter media may be determined as described in the publication IEST RP CC001.6 (2016) HEPA and ULPA Filters-Modified for Interval Loading, which comprises using a thermal oil photometer. The test may be performed using either a continuous loading procedure or an interval loading procedure. In other words, a filter media may have a PAO loading capacity determined by a continuous loading procedure in one or more of the ranges provided above and/or a PAO loading capacity determined by an interval loading procedure in one or more of the ranges described above. During a continuous loading procedure, a filter media having a nominal exposed area of 45 cm² is continuously loaded with thermal PAO aerosol (i.e., thermally generated polyalphaolefin (PAO) oil particles) having a concentration of 100 mg/cm³ and at a media face velocity of 1.75 cm/second (a flow rate of 11 L/minute) until the pressure drop across the filter media doubles. The PAO aerosol may be generated thermally and may have a mass mean diameter of 0.3 microns. The PAO loading capacity may be determined by weighing the filter media both prior to and after the test and dividing the measured increase in mass by the area of the filter media to obtain the PAO loading capacity per unit area of the filter media.

Additionally or alternatively, various PAO interval loading procedures may also be employed for thermal PAO loading. In other words, a filter media may have a PAO loading capacity as determined by one of the PAO interval loading procedures provided below in one or more of the ranges provided above.

In a first type of interval PAO loading test, a filter media having a nominal exposed area of 45 cm² is loaded with PAO aerosol for 10 minutes at a media face velocity of 1.75 cm/second (a flow rate of 11 liters per minute), after which the loading is paused for 24 hours. The test is stopped after the interval loading is repeated 10 times or until the air resistance across the filter media tripled, whichever happens earlier. The PAO aerosol used in the first type of interval loading procedure has a mass mean diameter of 0.3 microns and a concentration of 100 mg/m³. The air resistance across the filter media may be determined concurrently with the thermal PAO loading capacity of the filter media by the method for determining the thermal PAO loading capacity of a filter media described above.

In a second type of interval PAO loading test, a protocol similar the first type of interval loading test may be employed, except a PAO aerosol having a concentration of 30 mg/m³ is used.

In a third type of interval PAO loading test, a filter media having a nominal exposed area of 45 cm² is pre-loaded with thermal PAO aerosol for 30 minutes at a media face velocity of 1.75 cm/second (a flow rate of 11 liters per minute) and subsequently set aside at room temperature and sealed within a resealable container. After 10 days, the filter media is tested again by loading with PAO aerosol at a media face velocity of 1.75 cm/second (a flow rate of 11 liters per minute) for 30 minutes. The PAO aerosol used in the third interval loading procedure has a mass mean diameter of 0.3 microns and a concentration of 30 mg/m³. The PAO loading capacity may then be calculated as described above.

In some embodiments, the filter media described herein may exhibit a relatively small increase in air resistance after being subjected to one or more of the interval oil loading tests described herein (e.g., a PAO interval loading test as described above). In some embodiments, the filter media described herein may have a final air resistance (after the interval oil loading test) that is less than or equal to 2 times, less than or equal to 1.99 times, less than or equal to 1.9 times, less than or equal to 1.8 times, less than or equal to 1.7 times, less than or equal to 1.6 times, less than or equal to 1.5 times, less than or equal to 1.4 times, less than or equal to 1.3 times, less than or equal to 1.2 times, less than or equal to 1.1 times, or less than or equal to 1.05 times the initial air resistance (prior to the interval oil loading test). In some embodiments, the filter media described herein may have a final air resistance (after the interval oil loading test) that is greater than or equal to 1 time, greater than or equal to 1.05 times, greater than or equal to 1.1 times, greater than or equal to 1.2 times, greater than or equal to 1.3 times, greater than or equal to 1.4 times, greater than or equal to 1.5 times, greater than or equal to 1.6 times, greater than or equal to 1.7 times, greater than or equal to 1.8 times, greater than or equal to 1.9 times, or greater than or equal to 1.99 times the initial air resistance (prior to the oil loading test). Combinations of the above-referenced ranges are also possible (e.g., greater than or equal to 1 time and less than 2 times, or greater than or equal to 1 time and less than or equal to 1.99 times). Other ranges are also possible.

In some embodiments, the filter media described herein may exhibit an efficiency in one or more of the HEPA efficiency ranges described above both prior to and after being subjected to one or more of the interval oil loading tests (e.g., a PAO interval loading test) described elsewhere herein.

The filter media described herein may have any suitable continuous thermal PAO loading time. In some embodiments, a filter media has a continuous thermal PAO loading time of greater than or equal to 20 minutes, greater than or equal to 25 minutes, greater than or equal to 30 minutes, greater than or equal to 35 minutes, greater than or equal to 40 minutes, greater than or equal to 60 minutes, greater than or equal to 80 minutes, greater than or equal to 100 minutes, greater than or equal to 125 minutes, greater than or equal to 150 minutes, greater than or equal to 175 minutes, greater than or equal to 200 minutes, greater than or equal to 250 minutes, greater than or equal to 300 minutes, greater than or equal to 350 minutes, greater than or equal to 400 minutes, or greater than or equal to 450 minutes. In some embodiments, a filter media has a continuous thermal PAO loading time of less than or equal to 500 minutes, less than or equal to 450 minutes, less than or equal to 400 minutes, less than or equal to 350 minutes, less than or equal to 300 minutes, less than or equal to 250 minutes, less than or equal to 225 minutes, less than or equal to 200 minutes, less than or equal to 175 minutes, less than or equal to 150 minutes, less than or equal to 125 minutes, less than or equal to 100 minutes, less than or equal to 80 minutes, less than or equal to 60 minutes, less than or equal to 40 minutes, less than or equal to 35 minutes, less than or equal to 30 minutes, or less than or equal to 25 minutes. Combinations of the above-referenced ranges are also possible (e.g., greater than or equal to 20 minutes and less than or equal to 500 minutes, greater than or equal to 25 minutes and less than or equal to 300 minutes, or greater than or equal to 30 minutes and less than or equal to 200 minutes). Other ranges are also possible.

The continuous thermal PAO loading time of a filter media may be determined as described in the publication IEST RP CC001.6 (2016) HEPA and ULPA Filters-Modified for Continuous Loading, by using a thermal oil photometer and employing a continuous oil loading procedure as described above with respect to the measurement of the thermal PAO loading capacity. Specifically, the continuous thermal PAO loading time of the filter media may be determined to be the time it takes for the pressure drop across the filter media to double. The filter media described herein may have any suitable continuous DOP loading time.

In some embodiments, a filter media has a continuous DOP loading time of greater than or equal to 20 minutes, greater than or equal to 25 minutes, greater than or equal to 30 minutes, greater than or equal to 35 minutes, greater than or equal to 40 minutes, greater than or equal to 60 minutes, greater than or equal to 80 minutes, greater than or equal to 100 minutes, greater than or equal to 125 minutes, greater than or equal to 150 minutes, greater than or equal to 175 minutes, greater than or equal to 200 minutes, greater than or equal to 250 minutes, greater than or equal to 300 minutes, greater than or equal to 350 minutes, greater than or equal to 400 minutes, or greater than or equal to 450 minutes. In some embodiments, a filter media has a continuous DOP loading time of less than or equal to 500 minutes, less than or equal to 450 minutes, less than or equal to 400 minutes, less than or equal to 350 minutes, less than or equal to 300 minutes, less than or equal to 250 minutes, less than or equal to 225 minutes, less than or equal to 200 minutes, less than or equal to 175 minutes, less than or equal to 150 minutes, less than or equal to 125 minutes, less than or equal to 100 minutes, less than or equal to 80 minutes, less than or equal to 60 minutes, less than or equal to 40 minutes, less than or equal to 35 minutes, less than or equal to 30 minutes, or less than or equal to 25 minutes. Combinations of the above-referenced ranges are also possible (e.g., greater than or equal to 20 minutes and less than or equal to 500 minutes, greater than or equal to 75 minutes and less than or equal to 500 minutes, greater than or equal to 25 minutes and less than or equal to 300 minutes, or greater than or equal to 30 minutes and less than or equal to 200 minutes). Other ranges are also possible. The continuous DOP loading time of a filter media may be determined with the assistance of a TSI 8130 instrument. Using a continuous loading procedure, a 100 cm² surface area of the filter media may be continuously loaded with DOP aerosol at a face velocity of 5.3 cm/s (32 liters per minute) until the pressure drop across the filter media doubles. The DOP aerosol may have a mass-weighted mean diameter of 0.3 microns and a concentration of 100 mg/m³. The continuous DOP loading time of the filter media is determined to be the time it takes for the pressure drop to double its initial value.

In some embodiments, a pre-screening DOP interval loading test may be performed to determine whether a filter media has sufficient oil loading capabilities. The test may be conducted with the assistance of a TSI 8130 instrument. In a pre-screening DOP interval loading test, a filter media having a nominal exposed area of 100 cm² may first be preloaded with a dioctyl phthalate (DOP) aerosol at a media face velocity of 5.3 cm/second (a flow rate of 32 L/minute) for 30 minutes and subsequently set aside at room temperature and sealed within a resealable container. After 10 days, the filter media may be retested by loading with DOP aerosol at a media face velocity of 2.0 cm/second (a flow rate of 12 L/minute) for 1 hour. The DOP aerosol used in the interval loading test may have a mass mean diameter of 0.3 microns and a concentration of 100 mg/m³. The air resistance of the filter media may be monitored at various stages of the pre-screening DOP interval loading test, including prior to the preload (ARₜ₌₀), after the 30 minute preload, after the 10 day pause, and after the final load (AR_{t=10d}). This may be performed using the same instrument employed to load the DOP aerosol. In some cases, the air resistance is an average value of air resistances measured over a period of time of between 1 minute to 1.4 minutes. For example, the air resistance prior to the preload (ARₜ₌₀) and after the final load (AR_{t=10d}) may be determined as an average of air resistances measured over that period of time. A ratio of ARₜ₌₀/AR_{t=10d} may be then determined for each filter media.

In some embodiments, a filter media described herein may have an ARₜ₌₀/AR_{t=10d} ratio of greater than or equal to 1, greater than or equal to 1.01, greater than or equal to 1.05, greater than or equal to 1.1, greater than or equal to 1.15, greater than or equal to 1.2, greater than or equal to 1.25, greater than or equal to 1.29, greater than or equal to 1.3, greater than or equal to 1.4, greater than or equal to 1.5, greater than or equal to 1.6, greater than or equal to 1.7, greater than or equal to 1.8, or greater than or equal to 1.9. In some embodiments, a filter media described herein may have an ARₜ₌₀/AR_{t=10d} ratio of less than or equal to 2, less than or equal to 1.9, less than or equal to 1.8, less than or equal to 1.7, less than or equal to 1.6, less than or equal to 1.5, less than or equal to 1.4, less than or equal to 1.3, less than or equal to 1.29, less than or equal to 1.25, less than or equal to 1.2, less than or equal to 1.15, less than or equal to 1.1, less than or equal to 1.05, or less than or equal to 1.01. Combinations of the above-referenced ranges are also possible (e.g., greater than or equal to 1 and less than or equal to 2, greater than or equal to 1 and less than or equal to 1.3, or greater than or equal to 1 and less than or equal to 1.29). Other ranges are also possible. In some embodiments, a filter media having an ARₜ₌₀/AR_{t=10d} of less than 1.3 may be associated with a particularly advantageous set of oil loading capabilities.

In some embodiments, the filter media described herein may exhibit an efficiency in one or more of the HEPA efficiency ranges described above both prior to and after being subjected to the DOP interval loading test described above.

In some embodiments, the Gurley stiffness of the filter media as a whole in the machine direction may be greater than or equal to 100 mg, greater than or equal to 125 mg, greater than or equal to 150 mg, greater than or equal to 200 mg, greater than or equal to 250 mg, greater than or equal to 300 mg, greater than or equal to 400 mg, greater than or equal to 500 mg, greater than or equal to 600 mg, greater than or equal to 700 mg, greater than or equal to 800 mg, greater than or equal to 900 mg, greater than or equal to 1000 mg, greater than or equal to 1200 mg, greater than or equal to 1400 mg, greater than or equal to 1600 mg, or greater than or equal to 1800 mg. In some embodiments, the Gurley stiffness of the filter media in the machine direction may be less than or equal to 2000 mg, less than or equal to 1800 mg, less than or equal to 1600 mg, less than or equal to 1400 mg, less than or equal to 1200 mg, less than or equal to 1000 mg, less than or equal to 900 mg, less than or equal to 800 mg, less than or equal to 700 mg, less than or equal to 600 mg, less than or equal to 500 mg, less than or equal to 400 mg, less than or equal to 300 mg, less than or equal to 250 mg, less than or equal to 200 mg, less than or equal to 150 mg, or less than or equal to 125 mg. Combinations of the above-referenced ranges are also possible (e.g., greater than or equal to 100 mg and less than or equal to 2000 mg, greater than or equal to 200 mg and less than or equal to 1800 mg, greater than or equal to 300 mg and less than or equal to 1600 mg, greater than or equal to 100 mg and less than or equal to 1000 mg, greater than or equal to 200 mg and less than or equal to 800 mg, or greater than or equal to 300 mg and less than or equal to 700 mg). Other ranges are also possible.

The stiffness may be determined in accordance with TAPPI T543 om-94.

In embodiments in which a filter media comprises a single support layer, the filter media may have a Gurley stiffness in one or more ranges described above (e.g., greater than or equal to 100 mg and less than or equal to 1000 mg, greater than or equal to 200 mg and less than or equal to 800 mg, or greater than or equal to 300 mg and less than or equal to 700 mg). In embodiments in which a filter media comprises two or more support layers, the filter media may have a Gurley stiffness in one or more ranges described above (e.g., greater than or equal to 100 mg and less than or equal to 2000 mg, greater than or equal to 200 mg and less than or equal to 1800 mg, or greater than or equal to 300 mg and less than or equal to 1600 mg).

In some embodiments, the relative Gurley stiffness of a filter media as a whole in the machine direction is greater than or equal to 600 mg/mm, greater than or equal to 650 mg/mm, greater than or equal to 700 mg/mm, greater than or equal to 750 mg/mm, greater than or equal to 800 mg/mm, greater than or equal to 850 mg/mm, greater than or equal to 900 mg/mm, greater than or equal to 950 mg/mm, greater than or equal to 1000 mg/mm, greater than or equal to 1050 mg/mm, greater than or equal to 1100 mg/mm, greater than or equal to 1150 mg/mm, greater than or equal to 1200 mg/mm, greater than or equal to 1250 mg/mm, greater than or equal to 1300 mg/mm, greater than or equal to 1500 mg/mm, greater than or equal to 2000 mg/mm, greater than or equal to 2500 mg/mm, greater than or equal to 3000 mg/mm, greater than or equal to 3500 mg/mm, greater than or equal to 4000 mg/mm, or greater than or equal to 4500 mg/mm. In some embodiments, the relative Gurley stiffness of a filter media in the machine direction is less than or equal to 5000 mg/mm, less than or equal to 4500 mg/mm, less than or equal to 4000 mg/mm, less than or equal to 3500 mg/mm, less than or equal to 3000 mg/mm, less than or equal to 2500 mg/mm, less than or equal to 2000 mg/mm, less than or equal to 1500 mg/mm, less than or equal to 1300 mg/mm, less than or equal to 1250 mg/mm, less than or equal to 1200 mg/mm, less than or equal to 1150 mg/mm, less than or equal to 1100 mg/mm, less than or equal to 1050 mg/mm, less than or equal to 1000 mg/mm, less than or equal to 950 mg/mm, less than or equal to 900 mg/mm, less than or equal to 850 mg/mm, less than or equal to 800 mg/mm, less than or equal to 7500 mg/mm, less than or equal to 700 mg/mm, or less than or equal to 6500 mg/mm. Combinations of the above-referenced ranges are also possible (e.g., greater than or equal to 600 mg/mm and less than or equal to 1200 mg/mm, greater than or equal to 700 mg/mm and less than or equal to 1100 mg/mm, greater than or equal to 750 mg/mm and less than or equal to 1000 mg/mm, greater than or equal to 1000 mg/mm and less than or equal to 5000 mg/mm, greater than or equal to 1500 mg/mm and less than or equal to 3000 mg/mm, or greater than or equal to 1250 mg/mm and less than or equal to 2500 mg/mm). Other ranges are also possible.

The relative Gurley stiffness in the machine direction may be determined by dividing the Gurley stiffness (bending resistance) in the machine direction by the thickness of the filter media.

In embodiments in which a filter media comprises a single support layer, the filter media may have any of a variety of relative Gurley stiffness described above (e.g., greater than or equal to 600 mg/mm and less than or equal to 1200 mg/mm, greater than or equal to 700 mg/mm and less than or equal to 1100 mg/mm, or greater than or equal to 750 mg/mm and less than or equal to 1000 mg/mm). In embodiments in which a filter media comprises two or more support layers, the filter media may have any of a variety of relative Gurley stiffness described above (e.g., greater than or equal to 1000 mg/mm and less than or equal to 5000 mg/mm, greater than or equal to 1500 mg/mm and less than or equal to 3000 mg/mm, or greater than or equal to 1250 mg/mm and less than or equal to 2500 mg/mm).

In some embodiments, a ratio of the Gurley stiffness of the filter media as a whole in the machine direction to the thickness of the filter media may be greater than or equal to 100 mg/mm, greater than or equal to 125 mg/mm, greater than or equal to 150 mg/mm, greater than or equal to 200 mg/mm, greater than or equal to 250 mg/mm, greater than or equal to 300 mg/mm, greater than or equal to 400 mg/mm, greater than or equal to 500 mg/mm, greater than or equal to 600 mg/mm, greater than or equal to 700 mg/mm, greater than or equal to 800 mg/mm, greater than or equal to 900 mg/mm, greater than or equal to 1000 mg/mm, greater than or equal to 1200 mg/mm, greater than or equal to 1400 mg/mm, greater than or equal to 1500 mg/mm, greater than or equal to 1600 mg/mm, or greater than or equal to 1800 mg/mm. In some embodiments, a ratio of the Gurley stiffness of the filter media in the machine direction to the thickness of the filter media may be less than or equal to 2000 mg/mm, less than or equal to 1800 mg/mm, less than or equal to 1600 mg/mm, less than or equal to 1500 mg/mm, less than or equal to 1400 mg/mm, less than or equal to 1200 mg/mm, less than or equal to 1000 mg/mm, less than or equal to 900 mg/mm, less than or equal to 800 mg/mm, less than or equal to 700 mg/mm, less than or equal to 600 mg/mm, less than or equal to 500 mg/mm, less than or equal to 400 mg/mm, less than or equal to 300 mg/mm, less than or equal to 250 mg/mm, less than or equal to 200 mg/mm, less than or equal to 150 mg/mm, or less than or equal to 125 mg/mm. Combinations of the above-referenced ranges are also possible (e.g., greater than or equal to 100 mg/mm and less than or equal to 2000 mg/mm, greater than or equal to 200 mg/mm and less than or equal to 1800 mg/mm, or greater than or equal to 500 mg/mm and less than or equal to 1500 mg/mm). Other ranges are also possible.

In some embodiments two or more layers of the filter media (e.g., a main filter layer, a prefilter layer, and/or a supplemental layer) may be formed separately from each other and combined together by any suitable method, non-limiting examples of which include lamination, collation, and by use of adhesives. The two or more layers combined together may be formed using different processes, or the same process.

Different layers may be adhered together by any suitable method. For instance, layers may be adhered by an adhesive and/or melt-bonded to one another. Lamination and calendering processes may also be used.

In some embodiments, a filter media comprises an adhesive positioned between two or more layers and/or two or more pairs of layers. It should be understood that an adhesive positioned between any specific pair of layers may have some or all of the properties described below with respect to adhesives. It should also be understood that a filter media may comprise two locations at which adhesive is positioned for which the adhesive has identical properties and/or may comprise two or more locations at which adhesive is positioned for which the adhesive differs in one or more ways.

In some embodiments, a filter media comprises an adhesive that is a solvent-based adhesive resin and/or an adhesive formed from a solvent-based adhesive resin. As used herein, a solvent-based adhesive resin is an adhesive that is capable of undergoing a liquid to solid transition upon the evaporation of a solvent from the resin. Solvent-based adhesive resins may be applied while in the liquid state. Subsequently, the solvent that is present may evaporate to yield a solid adhesive. Solvent-based adhesive resins may thus be considered to be distinct from hot melt adhesives, which typically do not comprise volatile solvents (e.g., solvents that evaporate under normal operating conditions) and which typically undergo a liquid to solid transition as the adhesive cools. In embodiments in which adhesive is present at more than one location, each location at which adhesive is present may independently comprise an adhesive that is a solvent-based adhesive resin.

Desirable properties for adhesives may include sufficient tackiness and open time (i.e., the amount of time that the adhesive remains tacky after being exposed to the ambient atmosphere). Without wishing to be bound by theory, the tackiness of an adhesive may depend on both the glass transition temperature of the adhesive and the molecular weight of any polymeric components of the adhesive. Higher values of glass transition and lower values of molecular weight may promote enhanced tackiness, and higher values of molecular weight may result in higher cohesion in the adhesive and higher bond strength. In some embodiments, adhesives having a glass transition temperature and/or molecular weight in one or more ranges described herein may provide appropriate values of both tackiness and open time. For example, the adhesive may be configured to remain tacky for a relatively long time (e.g., the adhesive may remain tacky after full evaporation of any solvents initially present, and/or may be tacky indefinitely when held at room temperature). In some embodiments, the open time of the adhesive is less than or equal to 24 hours, less than or equal to 12 hours, less than or equal to 6 hours, less than or equal to 1 hour, less than or equal to 30 minutes, less than or equal to 15 minutes, less than or equal to 10 minutes, less than or equal to 5 minutes, less than or equal to 3 minutes, less than or equal to 1 minute, less than or equal to 30 seconds, or less than or equal to seconds. In some embodiments, the open time of the adhesive is at least 1 second, at least 10 seconds, at least 15 seconds, at least 30 seconds, at least 1 minute, at least 3 minutes, at least 5 minutes, at least 10 minutes, at least 15 minutes, at least 30 minutes, at least 1 hour, at least 6 hours, or at least 12 hours. Combinations of the above-referenced ranges are also possible (e.g., at least 1 second and less than or equal to 24 hours). Other values are also possible.

In embodiments in which adhesive is present at more than one location, each location at which adhesive is present may independently comprise an adhesive having an open time in one or more of the ranges described above. In embodiments in which a filter media comprises adhesive present in two or more locations, the open time of such adhesives may be the same or different.

Non-limiting examples of suitable adhesives include adhesives comprising acrylates, acrylate copolymers, poly(urethane)s, poly(ester)s, poly(vinyl alcohol), ethylene-vinyl acetate copolymers, silicone solvents, poly(olefin)s, synthetic and/or natural rubber, synthetic elastomers, ethylene-acrylic acid copolymers, ethylene-methacrylate copolymers, ethylene-methyl methacrylate copolymers, poly(vinylidene chloride), poly(amide)s, epoxies, melamine resins, poly(isobutylene), styrenic block copolymers, styrene-butadiene rubber, aliphatic urethane acrylates, and/or phenolics.

In embodiments in which adhesive is present at more than one location, each location at which adhesive is present may independently comprise an adhesive comprising one or more of the materials described above. In embodiments in which a filter media comprises adhesive present in two or more locations, such adhesives may have the same or different compositions.

When present, an adhesive may comprise a crosslinker and/or may be crosslinked. In certain embodiments, a crosslinker has a molecular weight of less than or equal to 3000 g/mol. In some embodiments, the crosslinker is a small molecule and/or the crosslink is a reaction product of a small molecule crosslinker. In some embodiments, an adhesive comprises a small molecule crosslinker (and/or a reaction product thereof) that is one or more of a carbodiimide, an isocyanate, an aziridine, a zirconium compound such as zirconium carbonate, a metal acid ester, a metal chelate, a multifunctional propylene imine, and an amino resin. It is also possible for an adhesive to comprise a reacted small molecule crosslinker.

In some embodiments, an adhesive comprises at least one polymer and/or prepolymer with one or more reactive functional groups that are capable of reacting with a crosslinker and/or comprises a reaction product of one or more reactive functional groups on a polymer and/or prepolymer with the crosslinker. Non-limiting examples of suitable reactive functional groups include alcohol groups, carboxylic acid groups, epoxy groups, amine groups, and amino groups. In some embodiments, a filter media comprises an adhesive that comprises one or more polymers and/or prepolymers that may undergo self-crosslinking via functional groups attached thereto. In some embodiments, a filter media comprises an adhesive that comprises a self-crosslinked reaction product of one or more polymers and/or prepolymers.

In embodiments in which adhesive is present at more than one location, each location at which adhesive is present may independently comprise an adhesive comprising one or more of the materials described above. In embodiments in which a filter media comprises adhesive present in two or more locations, such adhesives may have the same or different compositions.

The filter media described herein may be a HEPA filter, an ULPA filter, and/or a HVAC filter. Other types of filter media are also possible.

In some embodiments, a filter media can be incorporated into a variety of filter elements for use in various filtering applications. The filter media may be suitable for filtering gases, such as air. The filter media described herein may be used for the removal of microorganisms, virus particles, and/or other contaminants.

During use, the filter media may mechanically trap contaminant particles on the filter media as fluid (e.g., air) flows through the filter media.

In some embodiments, the filter media described herein is a component of a filter element. That is, the filter media may be incorporated into an article suitable for use by an end user.

Non-limiting examples of suitable filter elements include flat panel filters, cartridge filters, cylindrical filters, and conical filters. Filter elements may have any suitable height (e.g., between 2 in and 124 in for flat panel filters, between 1 in and 124 in for cartridge and cylindrical filter media). Filter elements may also have any suitable width (between 2 in and 124 in for flat panel filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein is a component of a filter element and is pleated. The pleat height and pleat density (number of pleats per unit length of the filter media) may be selected as desired. In some embodiments, the pleat height is greater than or equal to 3 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 15 mm, less than or equal to 10 mm, or less than or equal to 5 mm. Combinations of the above-referenced ranges are also possible (e.g., greater than or equal to 3 mm and less than or equal to 510 mm, greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

The following examples are intended to illustrate certain embodiments of the present disclosure, but do not exemplify the full scope of the disclosure.

### Example 1

This Example describes continuous PAO oil loading performance of various filter media.

Five filter media (Sample A1, Sample A2, Sample A3, Sample B, Sample C) were assembled from the various layers described below. The filter media in Samples A1-B had the following symmetrical design: 1^{st} wetlaid support layer/main filter layer comprising nanofibers/meltblown prefilter layer/2^{nd} wetlaid support layer. The filter media in Sample C had the following non-symmetrical design: 1^{st} wetlaid support layer/main filter layer comprising nanofibers/meltblown prefilter layer/scrim layer. The filter media in Sample C did not contain a 2^{nd} wetlaid support layer, but instead contained a scrim layer.

For all filter media, the main filter layer was electrospun from a solution comprising Nylon (a matrix polymer) and an impact modifier.

The meltblown prefilter layers in Samples B-C comprised fibers having a smaller average diameter than the meltblown prefilter layers in Samples A1-A3. Samples A1-A3 comprised coarse fibers having an average diameter of between 2.2 and 2.3 microns. Samples B-C comprised fine fibers having an average diameter of between 1.8 and 1.9 microns. The meltblown prefilter layers in all samples were hydrocharged.

For Samples A1-B, initial efficiency for each of the 2nd wetlaid support layers was measured according to the procedure described elsewhere herein with respect to the measurement of the efficiency of a prefilter layer. The 2nd wetlaid support layers in Samples A1, A2, A3, and B had the following efficiencies: 15%, 15%, 25%, and less than or equal to 1%, respectively.

Table 5, below, shows various properties of the different filter media.

TABLE 5

| | | | | 2^{nd} Wetlaid |
|---|---|---|---|---|
| | | Meltblown prefilter layer | | support layer |
| | Design | Hydrocharged? | Fiber Type | efficiency |
| Sample A1 | Symmetrical | Yes | Coarse | 15% |
| Sample A2 | Symmetrical | Yes | Coarse | 15% |
| Sample A3 | Symmetrical | Yes | Coarse | 25% |
| Sample B | Symmetrical | Yes | Fine | <1% |
| Sample C | Non- | Yes | Fine | N/A |
| | symmetrical | | | |

Table 6, below, shows the basis weights of various layers in the different filter media.

TABLE 6

| | | | | 2^{nd} Wetlaid |
|---|---|---|---|---|
| | | | | support layer |
| | 1^{st} Wetlaid | Main | Meltblown | basis weight |
| | support | filter | prefilter | (gsm) (Samples |
| | layer | layer | layer | A1-B) or |
| | basis | basis | basis | scrim layer |
| | weight | weight | weight | basis weight |
| | (gsm) | (gsm) | (gsm) | (Sample C) |
| Sample | 60 | 1 | 40 | 40 |
| A1 | | | | |
| Sample | 60 | 1 | 40 | 40 |
| A2 | | | | |
| Sample | 60 | 1 | 40 | 40 |
| A3 | | | | |
| Sample | 60 | 1 | 35 | 35 |
| B | | | | |
| Sample | 60 | 1 | 35 | 15 |
| C | | | | |

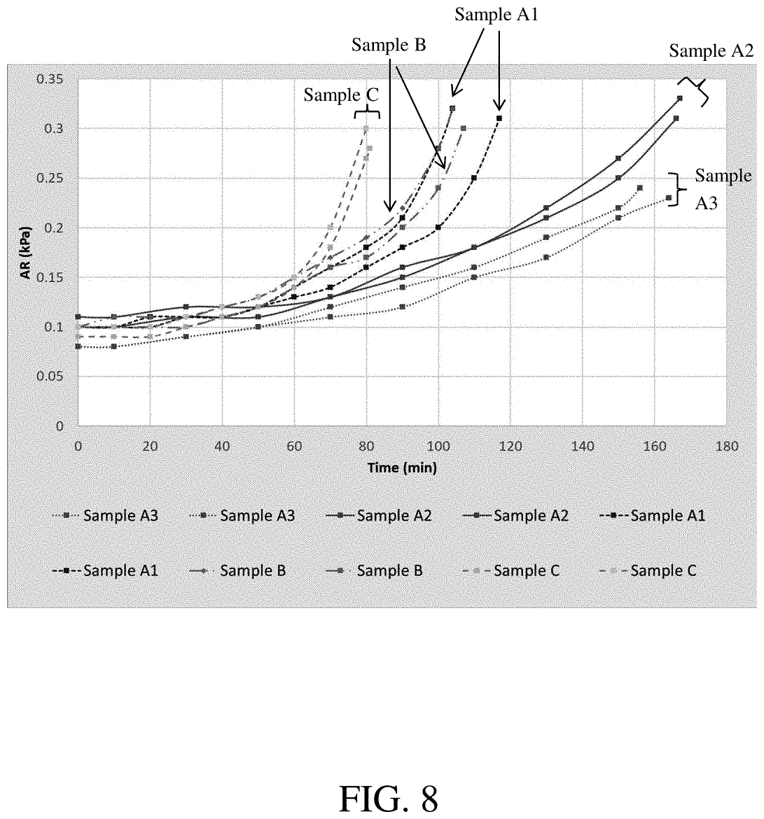

The thermal PAO loading capacity was measured for each of Samples A1-C using a continuous oil loading process as described above with respect to determining the thermal PAO loading capacity of a filter media. FIG. 8 shows air resistance (i.e., pressure drop) as a function of time for each filter media.

As shown in FIG. 8, two identical filter media (n=2) were made for each of Samples A1-C, and thermal PAO loading capacity was measured for each filter media. As shown in FIG. 8, the filter media in Samples A1-B comprising a 2^{nd} wetlaid support layer had longer thermal PAO loading time compared to the filter media in Sample C that lacked a 2^{nd} wetlaid support layer. For filter media comprising a 2^{nd} wetlaid support layer (Samples A1-A3), the filter media with a more efficient 2^{nd} wetlaid support layer had longer thermal PAO loading time.

### Example 2

This Example describes interval PAO oil loading performance of various filter media.

Seven filter media (Sample A, Sample B, Sample C, Sample D, Sample E, Sample F, Sample G) were assembled from the various layers described below. The filter media in Sample A had the following symmetrical design: 1^{st} wetlaid support layer/main filter layer comprising nanofibers/meltblown prefilter layer/2^{nd} wetlaid support layer. The filter media in Samples B, C, and E had the following non-symmetrical design: 1^{st} wetlaid layer/main filter layer comprising nanofibers/meltblown prefilter layer/scrim layer. The filter media in Samples D, F, and G had the same design as that for Samples B, C, and E, but lacked the scrim layer.

In all filter media, the main filter layer was electro spun from a solution comprising Nylon (a matrix polymer) and an impact modifier.

The meltblown prefilter layers in Samples A, C, D, F-G were not surface treated. The meltblown prefilter layer in Sample E was surface treated with gaseous C3 perfluoropropane (C₃F₈). The meltblown prefilter layer in Sample B was surface treated with liquid perfluorohexyl ethyl acrylate (C₁₁H₇F₁₃O₂). Surface treatment was performed using a chemical vapor deposition method described elsewhere herein.

The meltblown prefilter layers in Samples A-G comprised coarse fibers, fine fibers, finest fibers, or a combination thereof. The coarse fibers had an average diameter of between 2.2 and 2.3 microns. The fine fibers had an average diameter of between 1.8 and 1.9 microns. The finest fibers had an average diameter of between 1.7 and 1.8 microns.

The meltblown prefilter layers in Samples A, C, D, E, F, and G were hydrocharged. The meltblown prefilter layers in Sample B was not hydrocharged, but was instead corona charged.

The above-described properties of the meltblown prefilter layers present in Samples A-G are summarized below in Table 7.

TABLE 7

| | | | Prefilter | | |
|---|---|---|---|---|---|
| | | Prefilter | layer | Prefilter | |
| | | layer | fluoro- | layer | Prefilter |
| | Overall | surface | carbon- | hydro- | layer |
| | design | treated? | treated? | charged? | fiber type(s) |
| Sample | Symmetrical | N | N | Y | Fine |
| A | | | | | |
| Sample | Non- | Y | Y, with | N (corona | Coarse/ |
| B | symmetrical | | C₁₁H₇F₁₃O₂ | charged) | Fine |
| Sample | Non- | N | N | Y | Fine |
| C | symmetrical | | | | |
| Sample | Non- | N | N | Y | Fine |
| D | symmetrical | | | | |
| Sample | Non- | Y | Y, with C₃F₈ | Y | Coarse |
| E | symmetrical | | | | |
| Sample | Non- | N | N | Y | Finest |
| F | symmetrical | | | | |
| Sample | Non- | N | N | Y | Finest |
| G | symmetrical | | | | |

For Sample A, the 2^{nd} wetlaid support layer had an initial efficiency of 20%. The filter media in Samples B, C, and E did not contain a 2^{nd} wetlaid support layer, but instead included a scrim layer. The filter media in Samples D, F, and G did not contain 2^{nd} wetlaid support layer or a scrim layer of any kind. Table 8 shows the basis weight for the various layers described herein.

TABLE 8

| | 1^{st} Wetlaid | | Meltblown | 2^{nd} Wetlaid support |
|---|---|---|---|---|
| | support layer | Main filter | prefilter layer | layer basis weight/ |
| | basis weight | layer basis | basis weight | scrim basis |
| | (gsm) | weight (gsm) | (gsm) | weight (gsm) |
| Sample | 60 | 1 | 35 | 40 |
| A | | | | |
| Sample | 60 | 1 | 15 | 15 |
| B | | | | |
| Sample | 60 | 1 | 35 | 15 |
| C | | | | |
| Sample | 60 | 1 | 47 | None |
| D | | | | |
| Sample | 60 | 1 | 30 | 15 |
| E | | | | |
| Sample | 50 | 1 | 43 | None |
| F | | | | |
| Sample | 50 | 1 | 51 | None |
| G | | | | |

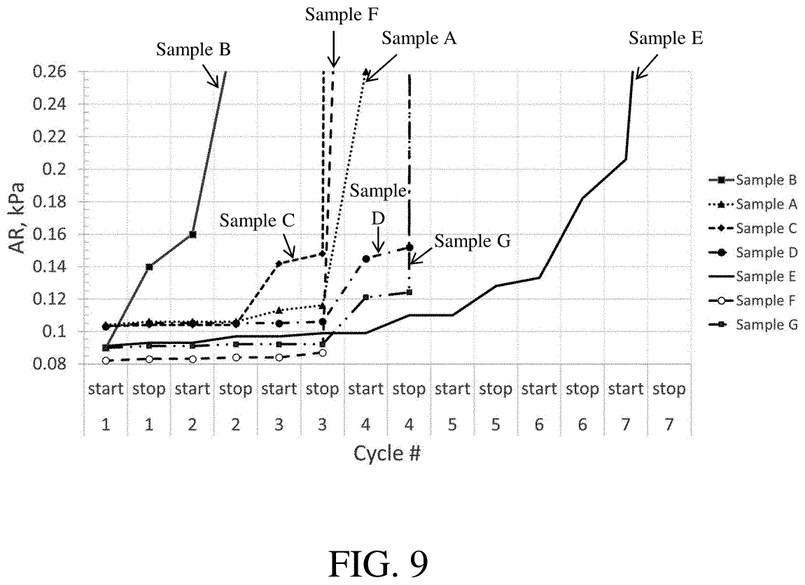

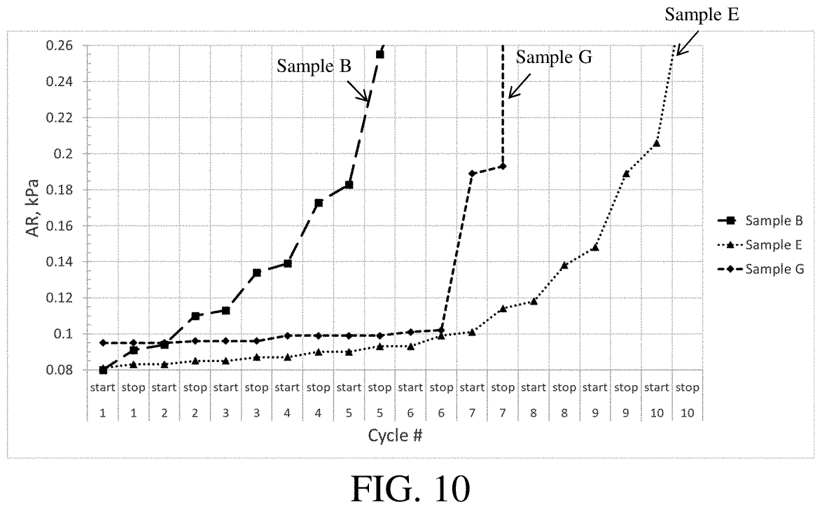

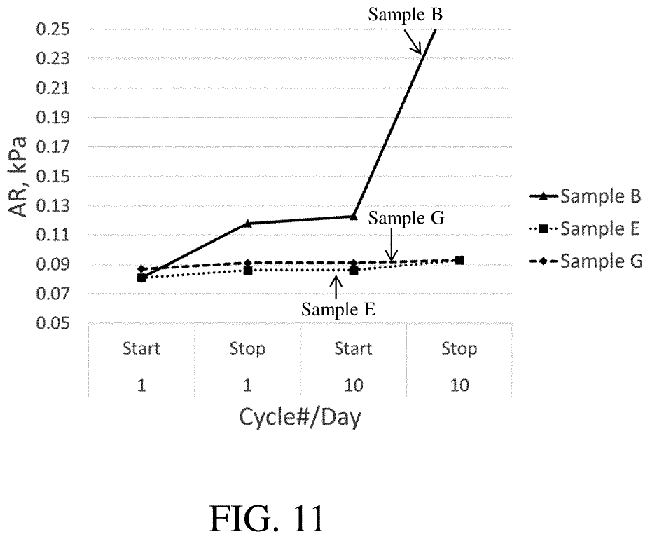

Various interval PAO loading tests were performed for Samples A-G. FIGS. 9-11 show air resistance as a function of cycle number during a first type of interval PAO loading test (FIG. 9), a second type of interval PAO loading test (FIG. 10), and a type of third PAO loading interval test (FIG. 11), respectively. These tests are described above with respect to the determination of thermal PAO loading time for a filter media.

FIGS. 9-11 shows air resistance (i.e., pressure drop) as a function of time for each filter media. As shown therein, the filter media that was both surface treated and hydrocharged (Sample E) exhibited the largest thermal PAO interval loading for each type of test. In addition, for filter media containing a hydrocharged meltblown prefilter layer, enhanced thermal PAO interval loading was also observed for the filter media containing the meltblown prefilter layer having the highest basis weight and comprising the finest fibers (Sample G). A meltblown prefilter layer having a high basis weight and finer fibers would have a high normalized surface area, which is believed to explain this observation. Furthermore, it was observed that when air resistance doubled as a result of oil loading, the oil loaded filter media in Samples A-G still had an efficiency in the HEPA range.

### Example 3

This Example describes DOP oil loading performance of various filter media.

Seven filter media were assembled from the various layers described below. The filter media in Samples 3-5 had the following non-symmetrical design: 1^{st} wetlaid support layer/main filter layer comprising nanofibers/meltblown prefilter layer/scrim layer. The filter media in Samples 1-2 and 6-7 had the same design as that for Samples 3-5, but lacked the scrim layer.

In all filter media, the main filter layer was electro spun from a solution comprising Nylon (a matrix polymer) and an impact modifier.

The meltblown prefilter layers in Samples 1-7 comprised coarse fibers, fine fibers, finest fibers, or a combination thereof. The coarse fibers had an average diameter of between 2.2 and 2.3 microns. The fine fibers had an average diameter of between 1.8 and 1.9 microns. The finest fibers had an average diameter of between 1.7 and 1.8 microns.

The meltblown prefilter layers in Samples 1-3 and 6-7 were not surface treated. The meltblown prefilter layer in Samples 4 and 5 were surface treated with C₁₁H₇F₁₃O₂ and C₃F₈, respectively. Surface treatment was performed using a chemical vapor deposition method described elsewhere herein. In Samples 1-3 and 5-7, the meltblown prefilter layer was hydrocharged. In Sample 4, the meltblown prefilter layer in the filter media was corona charged.

The above-described properties of the meltblown prefilter layers present in Samples 1-7 are summarized below in Table 9. Table 10 shows the basis weight for the various layers described herein.

TABLE 9

| | | | Prefilter | | |
|---|---|---|---|---|---|
| | | Prefilter | layer | Prefilter | Prefilter |
| | | layer | fluoro- | layer | layer |
| | Overall | surface | carbon- | hydro- | fiber |
| | design | treated? | treated? | charged? | type(s) |
| Sample | Non- | N | N | Y | Fine |
| 1 | symmetrical | | | | |
| Sample | Non- | N | N | Y | Fine |
| 2 | symmetrical | | | | |
| Sample | Non- | N | N | Y | Fine |
| 3 | symmetrical | | | | |
| Sample | Non- | Y | Y, with | N (corona | Coarse/ |
| 4 | symmetrical | | C₁₁H₇F₁₃O₂ | charged) | Fine |
| Sample | Non- | Y | Y, with C₃F₈ | Y | Coarse |
| 5 | symmetrical | | | | |
| Sample | Non- | N | N | Y | Finest |
| 6 | symmetrical | | | | |
| Sample | Non- | N | N | Y | Finest |
| 7 | symmetrical | | | | |

TABLE 10

| | 1^{st} Wetlaid | Main | Meltblown | |
|---|---|---|---|---|
| | support | filter | prefilter | |
| | layer | layer | layer | Scrim |
| | basis | basis | basis | basis |
| | weight | weight | weight | weight |
| | (gsm) | (gsm) | (gsm) | (gsm) |
| Sample | 60 | 1 | 35 | None |
| 1 | | | | |
| Sample | 60 | 1 | 47 | None |
| 2 | | | | |
| Sample | 60 | 1 | 47 | 15 |
| 3 | | | | |
| Sample | 60 | 1 | 15 | 15 |
| 4 | | | | |
| Sample | 50 | 1 | 30 | 15 |
| 5 | | | | |
| Sample | 50 | 1 | 43 | None |
| 6 | | | | |
| Sample | 50 | 1 | 51 | None |
| 7 | | | | |

A DOP interval loading was performed as a pre-screening test to determine whether the filter media in Samples 1-7 had sufficient oil loading capabilities. For filter media that passed the pre-screening DOP interval loading test, additional testing (e.g., multiple DOP oil loading interval tests) was performed to determine the number of DOP loading cycles each filter media could sustain. For filter media that failed the pre-screening DOP interval loading test, the filter media was excluded from further testing.

The pre-screening DOP interval loading test was performed with the assistance of a TSI 8130 instrument as described elsewhere herein.

The air resistance of the filter media was monitored at various stages of the pre-screening DOP interval loading test, including prior to the preload (ARₜ₌₀), after the 30 minute preload, after the 10 day pause, and after the final load (AR_{t=10d}). A ratio of ARₜ₌₀/AR_{t=10d} was determined for each filter media. A filter media having an ARₜ₌₀/AR_{t=10d} ratio of greater than or equal to 1 and less than 1.3 is believed to be indicative of a good oil loading capability and would pass the DOP interval loading test. Conversely, a filter media having an ARₜ₌₀/AR_{t=10d} ratio of greater than or equal to 1.3 and less than 2 is believed to be indicative of poor DOP oil loading capability and would fail the DOP interval loading test.

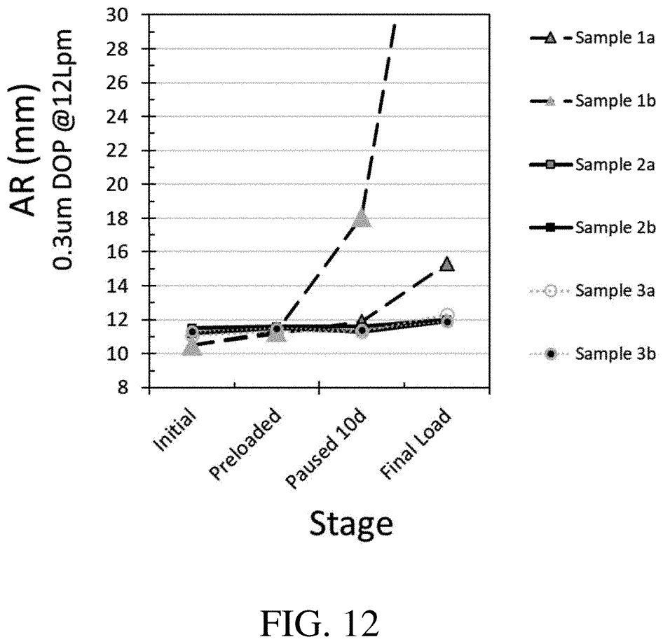

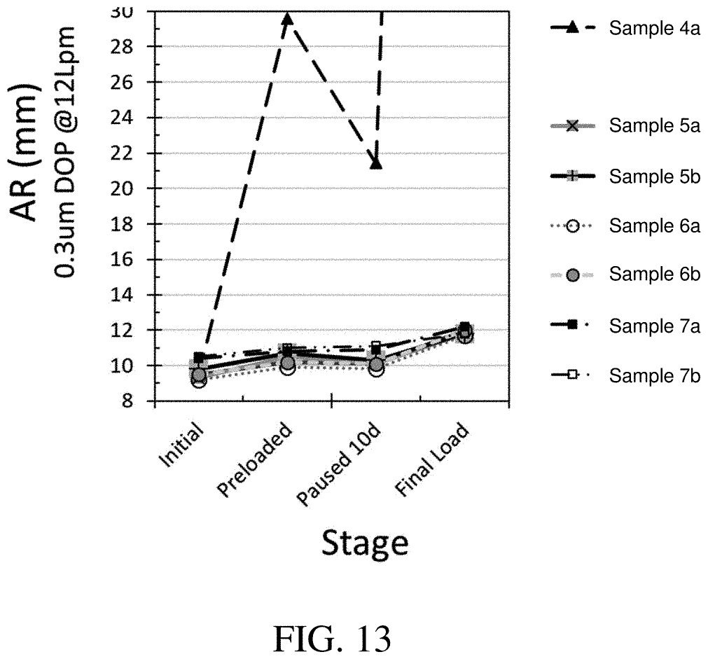

FIGS. 12-13 are plots of air resistance (i.e., pressure drop) at various stages of the DOP interval loading test for each filter media. Two identical filter media (n=2) were made for each of Samples 1-7 (labeled a and b). As shown in FIGS. 12-13, the filter media in Sample 1 and Sample 4 had ARₜ₌₀/AR_{t=10d} ratios of greater than 1.3 and failed the DOP interval load test. On the contrary, the filter media in Samples 2-3 and Samples 5-7 had ARₜ₌₀/AR_{t=10d} ratios of less than 1.3 and passed the oil loading test. Accordingly, the filter media in Samples 2-3 and Samples 5-7 had good oil loading performance.

These results suggest that for filter media comprising hydrocharged meltblown prefilters that are not surface treated with a fluorocarbon additive (Samples 1-3 and 6-7), filter media performance is enhanced upon the inclusion of a meltblown prefilter comprising finer fibers having a relatively small average diameter. Additionally, for filter media comprising hydrocharged meltblown prefilters that were not surface treated with a fluorocarbon additive, a filter media comprising a meltblown layer having a low basis weight (e.g., 30 gsm) did not achieve significantly improved oil loading performance. A meltblown prefilter layer having a relatively high basis weight and/or relatively finer fibers would have a relatively high normalized surface area, which is believed to contribute to better oil loading performance.

### Example 4

This Example describes continuous DOP oil loading performance of various meltblown prefilter layers.

Two meltblown prefilter layers (Sample 8 and Sample 9) were fabricated. The meltblown prefilter layers in Samples 8 and 9 comprised coarse polypropylene fibers having an average diameter of between 2.2 and 2.3 microns. The meltblown prefilter layer in Sample 8 was hydrocharged and not surface treated. The meltblown prefilter layer in Sample 9 was hydrocharged after being surface treated with C₃F₈. Each meltblown prefilter layer in Samples 8-9 had a basis weight of 30 gsm.

The above-described properties of the meltblown prefilter layers present in Samples 8-9 are summarized below in Table 11.

TABLE 11

| | | Prefilter | | |
|---|---|---|---|---|
| | Prefilter | layer | Prefilter | Prefilter |
| | layer | fluoro- | layer | layer |
| | surface | carbon- | hydro- | fiber |
| | treated? | treated? | charged? | type(s) |
| Sample | N | N | Y | Coarse |
| 8 | | | | |
| Sample | Y | Y, | Y | Coarse |
| 9 | | with C₃F₈ | | |

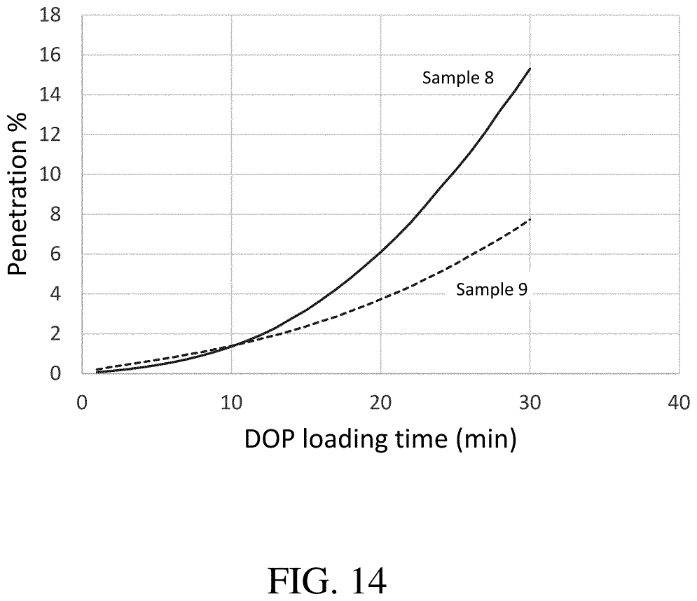

FIG. 14 is a plot of penetration at 0.3 microns as a function of loading time (in minutes). The penetration was measured according to the procedure described elsewhere herein for measurement of penetration at 0.3 microns.

As shown in FIG. 14, a hydrocharged meltblown prefilter layer surface treated with a fluorocarbon additive (Sample 9) exhibited slower increase in penetration compared to a hydrocharged and non-surface treated meltblown prefilter layer (Sample 8). This observation suggests that a hydrocharged, surface treated meltblown prefilter layer could slow down oil penetration through a filter media.

Furthermore, additional tests were conducted to compare various meltblown prefilter layers that were surface treated with different types of fluorocarbon additives. It was observed that shorter chained fluorocarbons (e.g., C₃F₈) exhibited better charge retaining properties compared to longer chained fluorocarbons (e.g., C₁₁H₇F₁₃O₂) and thus imparted the meltblown prefilter layer with better oil loading property.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a first layer comprising a plurality of fine fibers having an average diameter of less than 1 micron; and
a second layer disposed on the first layer, wherein:
the first layer has a porosity of greater than 80%;
the second layer has a normalized surface area of greater than 15 m²/m²; and
the second layer has an efficiency metric of greater than 2.5.

2. A filter media as in claim 1, wherein the first layer has a porosity of less than or equal to 99%.

3. A filter media as in claim 1, wherein the plurality of fine fibers has an average diameter of greater than or equal to 0.01 microns.

4. A filter media as in claim 1, wherein the fine fibers comprise greater than or equal to 1 wt. % and less than or equal to 25 wt. % of an impact modifier and wherein the impact modifier is dispersed in a matrix polymer.

5. A filter media as in claim 1, wherein the impact modifier comprises a copolymer comprising at least two different monomers, wherein at least one monomer has an affinity to the matrix polymer and wherein at least one monomer does not have affinity to the matrix polymer.

6. A filter media as in claim 1, wherein the matrix polymer comprises greater than or equal to 50 wt. % and less than or equal to 100 wt. % of a thermoplastic polymer.

7. A filter media as in claim 1, wherein the second layer has an efficiency metric of less than or equal to 6.

8. A filter media as in claim 1, wherein the second layer has a normalized surface area of less than or equal to 100 m²/m².

9. A filter media as in claim 1, wherein the second layer is a meltblown layer.

10. (canceled)

11. A filter media as in claim 1, wherein the second layer has an average fiber diameter of greater than or equal to 0.5 microns less than 4 microns.

12. A filter media as in claim 1, wherein the second layer has an oil rank of greater than 1 and less than or equal to 8.

13. A filter media as in claim 1, wherein the second layer has an initial efficiency of greater than 95% and less than or equal to 99.99995%.

14. A filter media as in claim 1, wherein the second layer is hydrocharged.

15. A filter media as in claim 1, wherein the second layer comprises a fluorocarbon coating.

16. A filter media as in claim 1, wherein the second layer comprises a plurality of synthetic fibers.

17. A filter media as in claim 1, wherein the second layer has a pressure drop of greater than or equal to 0.001 kPa and less than or equal to 0.08 kPa.

18. A filter media as in claim 1, further comprising a first wetlaid non-woven fiber web positioned adjacent the first layer at a side opposite the second layer.

19. A filter media as in claim 1, further comprising a second wetlaid non-woven fiber web positioned adjacent the second layer at a side opposite the first layer.

20-21. (canceled)

22. A filter media as in claim 1, wherein a ratio of an efficiency of the first wetlaid non-woven fiber web to an efficiency of the second wet-laid non-woven fiber web is less than or equal to 1:1.1 and greater than or equal to 1:99.

23. (canceled)

24. A filter media as in claim 1, wherein the filter media has a thermal PAO loading capacity of greater than or equal to 10 g/m² and less than or equal to 100 g/m².

25-33. (canceled)
